(19) United States
(12) Patent Application Publication
(10) Pub. No.: US 2004/0235992 A1
(43) Pub. Date: Nov. 25, 2004

(54) Photosensitive resin composition and photosensitive dry film resist and photosensitive coverlay film produced therefrom

(76) Inventors: Koji Okada, Osaka (JP); Kaoru Takagahara, Osaka (JP)

Correspondence Address: Brinks Hofer, Gilson & Lione, PO Box 10395, Chicago, IL, 60610, US

(21) Appl. No.: 10/478,886

(22) PCT Filed: May 29, 2002
(86) PCT No.: PCT/JP02/05249

(30) Foreign Application Priority Data
May 30, 2001 (JP) 2001-163469
May 31, 2001 (JP) 2001-165933
Jun. 22, 2001 (JP) 2001-190269
Jul. 13, 2001 (JP) 2001-214456
Sep. 18, 2001 (JP) 2001-282645

(51) Int. Cl. C08K 5/10; C08K 5/49

(52) U.S. Cl. 524/115; 524/315

(57) ABSTRACT

The present invention provides a photosensitive resin composition and a photosensitive dry film resist produced therefrom, and further provides a photosensitive dry film resist having excellent flame-retardant properties. More specifically, the present invention provides a photosensitive dry film resist and photosensitive coverlay film produced from a photosensitive resin composition consisting mainly of soluble polyimide, a compound having a carbon-carbon double bond, and a photoreactive initiator and/or sensitizer that have excellent workability, can be developed in an alkaline solution, and meet the standard for tests for flammability of plastic materials known as UL94V-0. The photosensitive coverlay film of the present invention can be attached without any adhesives and has an excellent heat resistance, so that it is suitably used for a printed wiring board to be used in the electronic material field, for hard disc suspension, and for a hard disc head for a personal computer.

### FIELD OF THE INVENTION

The present invention relates to a photosensitive resin composition, a photosensitive dry film resist produced therefrom, and further a photosensitive dry film resist that meets the standard for tests for flammability of plastic materials known as UL94V-0, and particularly to a photosensitive coverlay film for a flexible printed wiring board. The photosensitive coverlay film of the present invention can be laminated without any adhesives and has an excellent heat resistance, so that it is suitably used for a printed wiring board to be used in the electronic material

field, for a hard disc suspension, and for a hard disc head for a personal computer.

Photosensitive dry film resists can be broadly classified into the following two types. The one is a film-like photoresist that is used as an etching resist for forming a copper circuit pattern and that is finally peeled off, and the other is a photosensitive cover lay film that serves as an insulating protective film and as a film-like photoresist for circuits of a printed wiring board. Particularly, the latter is suitably used as a photosensitive cover lay film for a flexible printed wiring board or for a hard disc head of a personal computer.

### BACKGROUND OF THE INVENTION

Recently, electronic apparatuses have rapidly become multifunctional, highly efficient, and downsized, and therefore, electronic parts are required to be lighter and smaller. Because of this, as compared with an ordinary rigid printed wiring board, a flexible printed wiring board (hereinafter referred to as “FPC”) has drawn more attention than ever to mount electronic parts thereon and its demand has sharply been increased.

To protect a conductive surface of the FPC, a polymer film called “cover lay films is bonded to the FPC. The cover lay film for FPC is used for protecting a conductive circuit pattern produced using a copper-clad laminated board (hereinafter referred to as “CCL”) or for improving flexing properties of the FPC.

Generally, a cover lay film has so far been produced by making holes in predetermined portions of a cover lay film made of a polyimide film having an adhesive on one side thereof and subsequently heat-laminating or pressing the film on a CCL on which a circuit is formed. However, as wiring of a printed wiring board becomes finer line, technical difficulties put a limit on the method in which holes or windows are formed in joint parts of a cover lay film where terminals of a circuit or connecting parts of a component are joined and then the cover lay film is aligned with circuits of a CCL, and cause a low yield in terms of workability and positioning accuracy.

Also, there is another method in which a cover lay film made of polyimide film with an adhesive on one side thereof is thermally pressed on a CCL having a circuit thereon and subsequently holes are formed only in predetermined portions of the cover lay film by laser etching or plasma etching. Although this method realizes a high positioning accuracy, it needs long time for forming holes and a great deal of machine cost and operating cost.

As a method of bonding the cover lay film onto the surface of a conductor is generally used a method in which a predetermined shaped cover lay film having an adhesive on one side thereof is put on a FPC, aligned with the FPC, and then thermally pressed thereon by a press. However, since the adhesive used herein is usually an epoxy or acrylic adhesive, it has poor solder heat resistance, poor adhesive strength at high temperature, and poor flexibility. Thus the performance of the polyimide film cannot be sufficiently harnessed when it is used as a cover lay film.

Further, where a cover lay film is bonded to an FPC using a conventional epoxy or acryl adhesive, holes or windows must be formed in predetermined portions of the cover lay film that correspond to joint parts to terminals or components of a circuit before it is bonded to the FPC. However, it is difficult to form a hole or window in such a thin cover lay film. Furthermore, positioning of holes to the joints parts of the FPC is carried out almost by hand, so that it leads to poor workability, poor positioning accuracy, and high cost.

In order to improve the workability and the positioning accuracy, a method of forming a protection layer by applying a photosensitive composition to a conductive surface and a photosensitive coverlay film (also called “photosensitive dry film resist”) have been developed and thus the workability and the positioning accuracy have been improved.

However, the aforementioned photosensitive coverlay film contains acrylic resins, so that it dose not have sufficient heat resistance and is brittle as a film.

In order to solve the above problems, a photosensitive polyimide has, therefore, been required to be used. Accordingly, there have been developed photosensitive polimides into which methacryloyl group is introduced through an ester bond (Japanese Examined Patent Publication No.55-030207 and Japanese Examined Patent Publication No.55-041422) and photosensitive polyimides into which amine compounds or diisocyanate compounds having a methacryloyl group are introduced in the carboxy group part of the polyamide acid (Japanese Unexamined Patent Publication No.54-145794, Japanese Unexamined Patent Publication No.59-160140, Japanese Unexamined Patent Publication No.03-170547, Japanese Unexamined Patent Publication No.03-186847, and Japanese Unexamined Patent Publication No.61-118424).

However, such photosensitive polyimides do not function as a cover lay film until they are applied to an FPC in a polyamide acid state, exposed to light and developed, and then thermally imidized. Therefore, the FPC has to be heated to 250° C. or higher for the imidization reaction. Further, depending on photosensitive polyimides, it is necessary to thermally eliminate their acryloyl groups. However, during the thermal process, there occurs a problem that the film thickness is significantly lessened.

Accordingly, in order to solve the above problems, an object of the present invention is to provide a photosensitive dry film resist having a sufficient mechanical strength, excellent heat resistance, excellent workability, and excellent adhesive strength. Another object of the present invention is to provide a photosensitive cover lay film having excellent properties by bonding the dry film resist onto a flexible printed wiring board.

Conventionally, a photosensitive cover lay film is formed by the method in which holes are formed in predetermined positions of a cover lay film made of a polyimide film having an adhesive on one side thereof and then the film is heat-laminated or pressed on a CCL (copper-clad laminate) with a circuit formed thereon. However, as wiring of a printed wiring board becomes finer, such method is limited in terms of its workability and positioning accuracy and has a problem of poor yield.

Another conventional method is the one in which a cover film made of polyimide film having an adhesive on one side thereof is thermally pressed on a CCL and then holes are formed in predetermined positions by laser or plasma etching technique. Although such method can achieve good positioning accuracy, it takes long time to form holes and the machine cost and operating cost are high.

In order to solve the above problems, there is a method in which a photosensitive cover lay film that is obtained by applying or laminating a photosensitive resin composition onto a base material is used. In this method, (i) a photosensitive cover lay layer is formed by applying a photosensitive resin composition to a CCL with a circuit formed thereon or by thermally pressed on the CCL, (ii) it is exposed to light while photo mask pattern is placed thereon, (iii) a base material is peeled off, and then (iv) it is developed in an alkaline solution so as to accurately form holes in predetermined positions. In this case, the photosensitive cover lay film functions as a film-like photoresist and an insulating protective film.

Particularly, if a dry-film-type photosensitive cover lay film is used in this method, applying and drying steps are not necessary. Therefore, the method using such photosensitive cover lay film can save more time, and more holes can be formed at a time than the method in which photosensitive resin is applied. Thus, FPCs can be produced faster.

Recently, photosensitive cover lay films containing acrylic resin as a main component are commercially available (Japanese Unexamined Patent Publications No. 07-278492, No.07-253667, No.10-254132, and No.10-115919). However, such cover lay films are inferior to a cover lay film containing polyimide as a main component in solder heat resistance, folding endurance, and electrical insulating properties.

Accordingly, the inventors of the present invention tried to develop a photosensitive cover lay containing polyimide as a main component. In order to achieve sufficient flowability and easy circuit embedding when a coverlay film is thermally pressed, an acrylic compound as well as a polyimide resin was used as a main component of the coverlay film. However, since acrylic resin is highly combustible, it did not meet the flame-resistance standard (the standard for tests for flammability of plastic materials known as UL94V-0).

Accordingly, in order to solve the above problems, the inventors of the present invention have developed flame-retardant photosensitive cover lay film containing a soluble polyimide and acrylic compound.

An object of the present invention is to realize a practical use of a photosensitive polyimide film having excellent heat resistance, excellent electrical insulting properties, excellent alkali resistance, excellent flexing resistance, and excellent flame-retardant properties, and more specifically to provide a photosensitive resin composition and a photosensitive cover lay film that have an excellent flame-retardant properties and self-extinguishing ability as a coverlay for a flexible printed wiring board and that can be developed in an alkaline solution.

### SUMMARY OF THE INVENTION

An embodiment of a photosensitive resin composition according to the present invention comprises, as essential components, a soluble polyimide, a compound having a carbon-carbon double bond, and a photoreaction initiator and/or a sensitizer.

Another embodiment of a photosensitive resin composition of the present invention comprises, as essential components, a soluble polyimide, a compound having a carbon-carbon double bond, and a photoreaction initiator and/or a sensitizer, and may further comprise a phosphorous compound.

A still another embodiment a photosensitive resin composition of the present invention comprises, as essential components, a soluble polyimide, a compound having a carbon-carbon double bond, and a photoreaction initiator and/or a sensitizer, and may further comprise a halogen-containing compound.

A further embodiment a photosensitive resin composition of the present invention comprises, as essential components, a soluble polyimide, a compound having a carbon-carbon double bond, and a photoreaction initiator and/or a sensitizer, and may further comprise phenylsiloxane having a structural unit represented by:

R²²SiO_{3/2} and/or R²³ SiO_{2/2}

wherein R²² and R²³ are selected from a phenyl group, an alkyl group having a carbon number of 1 to 4, and an alkoxy group.

The soluble polyimide used herein may have 1 wt % or more of a structural unit represented by the general formula (1):

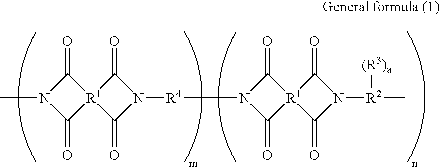

wherein R¹ is a tetravalent organic group, R² is (a+2) valence organic group, R³ is a monovalent organic group, R⁴ is a divalent organic group, a is an integer of 1 to 4, m is an integer of 0 or more, and n is an integer of 1 or more).

Alternatively, the soluble polyimide may be an epoxy-modified polyimide that is modified by a compound having an epoxy group.

Further, R¹ in the general formula (1) may be one or more kinds of tetravalent organic groups having 1 to 3 aromatic ring or one or more kinds of alicyclic tetravalent organic groups.

Furthermore, at least 10 mol % or more of acid dianhydride residue represented by R¹ in the general formula (1) may be selected from the general formula (2):

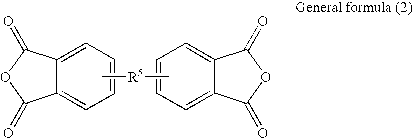

wherein R⁵ represents a single bond, —O—, —CH₂—, C₆H₄—, —C(═O)—, —C(CH₃)₂—, —C(CF₃)₂—, —O—R⁶—O—, and —(C═O)—O—R⁶—O(C═O)—.

Further, at least 10 mol % or more of acid dianhydride residue represented by R¹ in the general formula (1) may be selected from the Group (I):

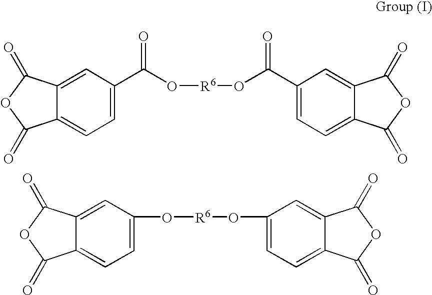

wherein R⁶ represents a divalent organic group selected from the Group (II):

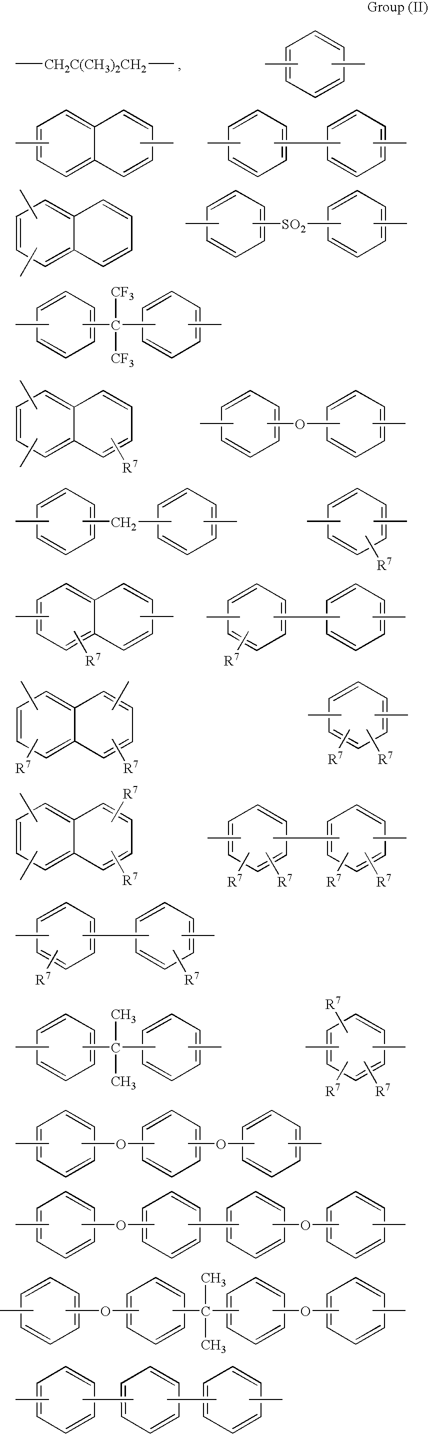

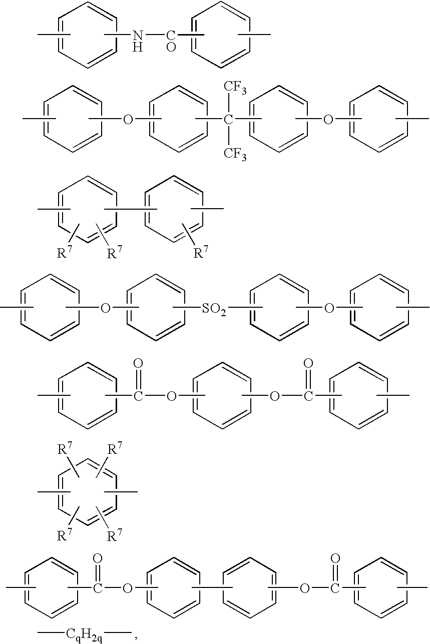

(wherein q is an integer of 1 to 20) and R⁷ represents hydrogen, halogen, methoxy, or C1 to C16 alkyl group, and p represents an integer of 1 to 20.

Furthermore, R² in the general formula (1) may comprise a diamine residue selected from the Group (III):

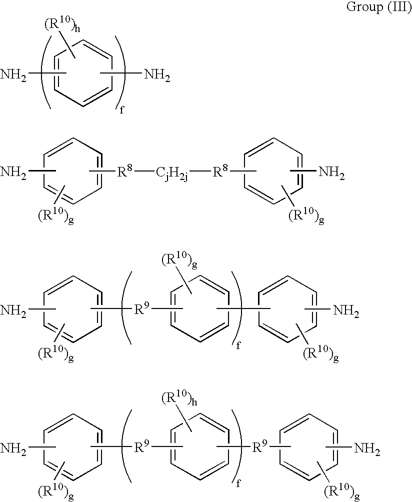

wherein R⁸s may be the same or different and represent a single bond, —O—, —C(═O)O—, —O(O═)C—, —SO₂—, —C(═O)—, —S—, or —C(CH₃)₂—, R⁹s may be the same or different and represent a single bond, —CO—, —O—, —S—, —(CH₂)ᵣ— (wherein r is an integer of 1 to 20), —NHCO—, —C(CH₃)₂—, —C(CF₃)₂—, —COO—, —SO₂—, or —O—CH₂—C(CH₃)₂—CH₂—O—, R¹⁰s may be the same or different and represent hydrogen, hydroxy group, carboxy group, halogen, methoxy group, or C1 to C5 alkyl group, f is an integer of 0, 1, 2, 3, and 4, g is an integer of 0, 1, 2, 3, and 4, and j is an integer of 1 to 20).

Further, the soluble polyimide can be obtained using 5 to 95 mol % of diamine represented by the Group (III) in all the diamine components.

Furthermore, R⁴ in the general formula (1) may contain a siloxane diamine residue represented by the general formula (3):

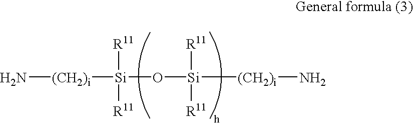

wherein R¹¹ represents a C1 to C12 alkyl group or phenyl group, i represents an integer of 1 to 20, and h represents an integer of 1 to 40).

Further, the soluble polyimide may contain 5 to 70 mol % of siloxane diamine residue represented by the general formula (3) in all the diamine residues.

Furthermore, R³ in the general formula (1) may contain a hydroxy group or a carboxy group.

R² in the general formula (1) may be a diamine residue selected from the Group (IV):

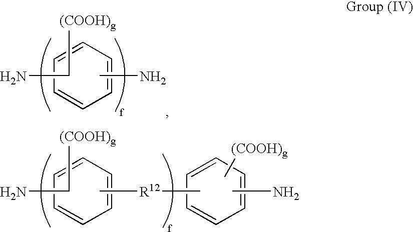

wherein f is an integer of 1 to 3, g is an integer of 1 to 4, and R¹² represents a divalent organic group selected from —O—, —S—, —CO—, —CH₂—, —SO₂—, —C(CH₃)₂—, —C(CF₃)₂—, and —O—CH₂—C(CH₃)₂—CH₂—O—

The soluble polyimide may have a COOH equivalent weight of 300 to 3000.

Further, R³ in the general formula (1) may be an epoxy compound residue having two or more epoxy groups.

Furthermore, R³ in the general formula (1) may be a residue of a compound having an epoxy group and a carbon-carbon double bond or a residue of a compound having an epoxy group and a carbon-carbon triple bond.

In the general formula (1), R³ may have 1 wt % or more soluble polyimide having a structural unit containing an organic group selected from the group consisting of the Group (V):

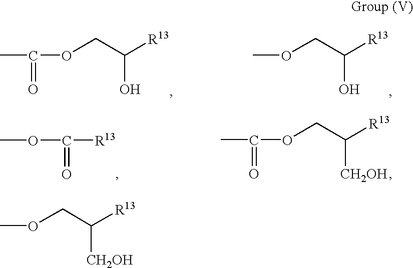

wherein R¹³ represents a monovalent organic group having at least one functional group selected from the group consisting of an epoxy group, carbon-carbon triple bond, or carbon-carbon double bond). The soluble polyimide used herein can be an epoxy modified soluble polyimide having a COOH equivalent weight of 300 to 3000.

Further, the aforementioned compound having a carbon-carbon double bond may be a compound having at least one aromatic ring and two or more carbon-carbon double bonds in one molecule.

Furthermore, the aforementioned compound having a carbon-carbon double bond may be an acrylic compound having at least one kind selected from the group consisting of an aromatic ring and heterocyclic ring in one molecule.

The aforementioned compound having at least one aromatic group and two or more carbon-carbon double bonds in one molecule may contain a compound having 6 or more and 40 or less of repeating units represented by:

—(CHR¹⁴—CH₂—O)—

wherein R¹⁴ represents hydrogen, methyl group, or ethyl group.

The aforementioned compound having at least one aromatic ring and two or more carbon-carbon double bonds in one molecule may contain at least one kind of compound selected from the group consisting of the group (VI):

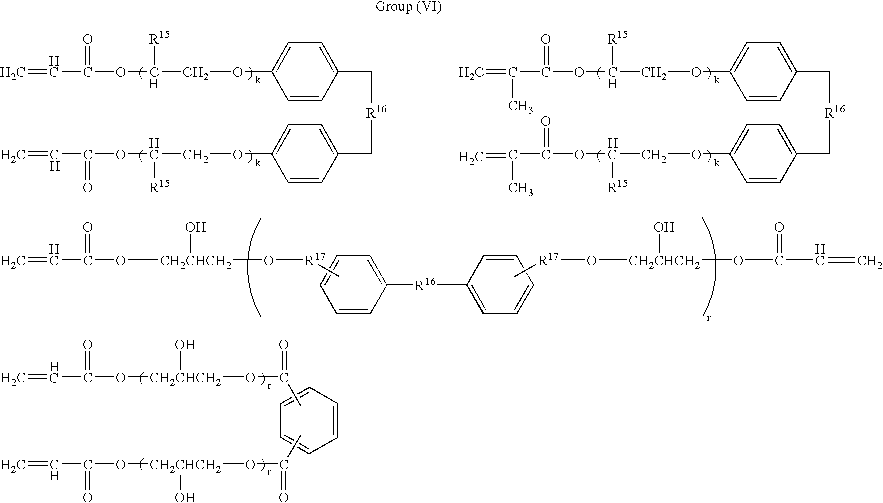

wherein R¹⁵ represents hydrogen, methyl group, or ethyl group, R¹⁶ represents a divalent organic group, R¹⁷ represents a single bond or a divalent organic group, k may be the same or different and represents an integer of 2 to 20, and r may be the same or different and represents an integer of 1 to 10.

In one embodiment of the present invention, the aforementioned phosphorous compound may be a compound having a phosphorous content of 5.0 wt % or more.

The aforementioned phosphorous compound may be phosphate, condensed phosphate, phosphate, phosphine oxide, or phosphine.

Further, the aforementioned phosphorous compound may be phosphate having two or more aromatic rings represented by the group (VII):

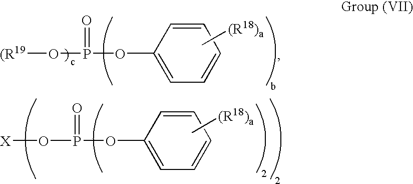

wherein R¹⁸ represents a methyl group, R¹⁹ represents an alkyl group, X represents a divalent organic group, a is an integer of 0 to 3, b plus c equals 3, and b is an integer of 2 or 3.

In one embodiment of the present invention, the aforementioned halogen-containing compound can be a compound having a halogen content of 15 wt % or more.

The aforementioned compound containing halogen may be at least one kind selected from the group consisting of halogen-containing (meta)acrylic compound, halogen-containing phosphate, and halogen-containing condensed phosphate.

Furthermore, the aforementioned compound containing halogen may be a (meta)acrylic compound represented by the group (VIII):

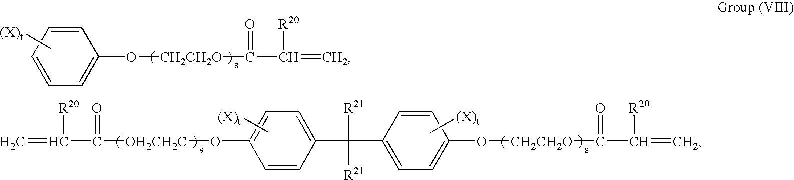

wherein X represents a halogen group, R²⁰ and R²¹ represent hydrogen or methyl group, s is an integer of 0 to 10, and t may be the same or different and represents an integer of 1 to 5.

Further, in the photosensitive resin composition of the present invention, the aforementioned photoreactive initiator may generate radical at g or i rays.

Furthermore, the photoreactive initiator can be developed in an alkaline solution after exposure.

In one embodiment of the photosensitive resin composition according to the present invention, the soluble polyimide, the compound having a carbon-carbon double bond, and the photoreactive initiator and/or sensitizer may constitute 5 to 90 wt %, 5 to 90 wt %, and 0.001 to 10 wt % of the total amount thereof, respectively.

In another embodiment of the photosensitive resin composition according to the present invention, the soluble polyimide, the phosphorous compound, the compound having a carbon-carbon double bond, and the photoreactive initiator and/or sensitizer may constitute 5 to 90 wt %, 5 to 90 wt %, 5 to 90 wt %, and 0.001 to 10 wt % of the total amount thereof, respectively.

In a further embodiment of the photosensitive resin composition according to the present invention, the soluble polyimide, the halogen-containing compound, the compound having a carbon-carbon double bond, and the photoreactive initiator and/or sensitizer may constitute 5 to 90 wt %, 5 to 90 wt %, 5 to 90 wt %, and 0.001 to 10 wt % of the total amount thereof, respectively. Further, 0.1 to 10 wt % of antimony trioxide and/or antimony pentoxide may also be contained.

In a still further embodiment of the photosensitive resin composition according to the present invention, the soluble polyimide, the compound having a carbon-carbon double bond, the photoreactive initiator and/or sensitizer, and the compound containing phenyl siloxane may constitute 5 to 90 wt %, 5 to 90 wt %, 0.001 to 10 wt %, and 5 to 90 wt % of the total amount thereof, respectively.

A photosensitive dry film resist of the present invention may be produced from the various aforementioned photosensitive resin compositions.

The photosensitive dry film resist may be pressed at a temperature of 20 to 150° C. under B stage.

Alternatively, a thermal decomposition starting temperature after curing may be 300° C. or more.

Further, an adhesive strength of the photosensitive resin composition contained in the photosensitive dry film resist to copper may be 5 Pa-m at 20° C. or more.

Alternatively, a cure temperature may be 200° C. or less.

Alternatively, the photosensitive dry film resist may be a laminate composed of the aforementioned photosensitive resin composition and polyimide film, and meet the standard for tests for flammability of plastic materials known as UL94V-0.

The photosensitive dry film of the present invention may comprise a photosensitive dry film resist composed of the aforementioned photosensitive resin composition and be developed in an alkaline solution.

The photosensitive dry film resist of the present invention may comprise a two-layer sheet composed of a base film and any one of the aforementioned photosensitive dry film resists.

Alternatively, the photosensitive dry film resist of the present invention may comprise a three-layer sheet composed of the aforementioned two-layer sheet and a protective film.

The photosensitive dry film resist of the present invention may be used as a photosensitive coverlay film for a flexible printed wiring board or for a hard disk head of a personal computer.

The inventors of the present invention disclose a photosensitive coverlay film for a flexible printed wiring board and a photosensitive coverlay film for a hard disk head of a personal computer.

Further, the inventors of the present invention discloses a printed wiring board on which the photosensitive dry film resist of the present invention is laminated without using adhesive.

### BRIEF DESCRIPTION OF THE DRAWINGS

FIG. 1 shows a comb pattern (line/space=100/100 μm).

### DESCRIPTION OF THE PREFERRED EMBODIMENTS

A soluble polyimide of the present invention is used as a photosensitive resin composition after it is imidized. If polyamide acid is us used for a flexible printed wiring board as conventional, it must be exposed to high temperature of 250° C. or more for a long time for imidization. This often causes the deterioration of other parts than copper foil and polyimide. However, the present invention does not cause such deterioration.

By using the photosensitive dry film resist of the present invention as a coverlay film for a flexible printed wiring board, heat resistance, excellent mechanical characteristics, good electrical insulation, and alkali resistance can be provided to the flexible printed wiring board. Further, there can be provided to the flexible printed wiring board a flame resistance and self-extinguishing properties that meet the standard for tests for flammability of plastic materials known as UL94V-0.

In the present invention, a “soluble polyimide” means a polyimide which is soluble in any one of the following solvents at 20° C. to 50° C. at a ratio of 1 or more to 100 by weight, preferably at a ratio of 5 or more to 100 by weight, and more preferably at a ratio of 10 or more to 100 by weight. Examples of the solvents include: formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-cresol, m-cresol, p-cresol, xylenol, phenol halide, and catechol; ether solvents such as tetrahydrofuran, dioxane, and dioxolane; alcohol solvents such as methanol, ethanol, and butanol; ketone solvents such as acetone and methyl ethyl ketone; cellosolve solvents such as butylcellosolve; hexamethylphosphoramide; and y-butyrolactone. Preferably, 5 g or more of a soluble polyimide is dissolved in 100 g of the above solvent at 20° C. to 50° C., and more preferably, 10 g or more is dissolved. If the solubility of a soluble polyimide is too low, it may be difficult to prepare a photosensitive film of a desired thickness.

In general, polyimide can be obtained by reacting diamine and acid dianhydride in an organic solvent to prepare polyamide acid and then dehydrating the polyamide acid for imidization or by reacting acid dianhydride and diisocyanate in a solvent.

A soluble polyimide is prepared by the following method, for example.

A soluble polyimide to be used in the present invention can be obtained from polyamide acid which is a precursor of polyimide, and the polyamide acid can be obtained by reacting diamine and acid dianhydride in an organic solvent. Diamine is dissolved in an organic solvent or diffused in slurry form in an inert atmosphere such as nitrogen. Acid dianhydride is dissolved in an organic solvent or diffused in a slurry or solid form, and then added to the diamine dissolved in the organic solvent.

In this case, if the diamine and the acid dianhydride are substantially equimolar, polyamide acid is obtained from one kind of diamine and one kind of acid dianhydride. However, acid dianhydride can be obtained from two or more kinds of diamine components and acid dianhydride components. In the latter case, various polyamide acid copolymer can be obtained by adjusting the total amount of diamine components and that of acid dianhydride components to substantially equimolar amounts.

For example, a diamine component (1) and a diamine component (2) are added in an organic solvent, and then an acid dianhydride component is added to prepare polyamide acid copolymer solution. Alternatively, a diamine component (1) is added in an organic solvent first, an acid dianhydride component is then added, and after stirring for a while, a diamine component (2) is added to prepare polyamide acid copolymer solution. Alternatively, an acid dianhydride component is added in an organic solvent first, a diamine component (1) is then added, a diamine component (2) is added after a while, and then a diamine component (3) is added after a further while to prepare polyamide acid copolymer solution.

In these cases, a reaction temperature is preferably in a range of −20° C. to 90° C. Reaction time is about 30 minutes to 24 hours.

Preferable average molecular weight of polyamide acid is 5,000 to 1,000,000. If average molecular weight is less than 5,000, a resulting polyimide composition has also low molecular weight, so that the polyimide composition tends to become brittle. On the contrary, if average molecular weight is more than 1,000,000, the viscosity of polyamide acid vanish becomes too high to handle.

To this polyimide composition can be added various organic additives, inorganic fillers, or various reinforcing agents.

Examples of organic polar solvent to be used for preparing polyamide acid include: sulfoxide solvents such as dimethyl sulfoxide and diethyl sulfoxide; formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-cresol, m-cresol, p-cresol, xylenol, phenol halide, and catechol; ether solvents such as tetrahydrofuran and dioxane; alcohol solvents such as methanol, ethanol, and butanol; cellosolve solvents such as butylcellosolve; hexamethylphosphoramide; and γ-butyrolactone. Preferably, these solvents can be used alone or in combination. Also, an aromatic hydrocarbon such as xylene and toluene can be used. Any solvent can be used, as far as it can dissolve polyamide acid. In order to synthesize polyamide acid, then to imidize it, and finally to remove a solvent, such solvent that dissolves polyamide acid and that has a low boiling point is industrially useful.

Next, a step of imidizing polyamide acid will be described.

When polyamide acid is imidized, water is generated. This water causes easy dehydration of polyamide acid and the reduction of molecular weight thereof.

The following methods are used for imidizing polyamide acid while removing the water:

(1) a method in which an azeotropic solvent such as toluene and xylene is added to remove the water by azeotropy;

(2) a chemically imidizing method in which aliphatic acid dianhydride such as acetic anhydride and a tertiary amine such as triethylamine, pyridine, picoline, and isoquinoline are added; or

(3) a method of thermally imidizing polyamide acid under a reduced pressure.

Although any of the above methods can be used, the method of the item (3) is preferable in order to prevent hydrolysis by heating the water generated during imidization under reduced pressure, to aggressively remove it out of a system, and to avoid the reduction of molecular weight. In the method (3), even if tetracarboxylic acid dianhydrides that are fully or partially ring-opened by hydrolysis blend into acid dianhydride as a material and only a low molecular weight of polyamide acid is obtained because of the stoppage of a copolymer reaction of the polyamide acid, it is expected that the ring-opened tetracarboxylic acid dianhydride is ring-closed again by heating it under reduced pressure and reacted with amine remaining in the system during the subsequent imidization step, and thereby the molecular weight of polyimide becomes higher than that of polyamide acid.

A method of directly imidizing polyamide acid under a reduced pressure by heating and drying it will be concretely described.

Although any method can be used as far as polyamide acid can be heated and dried, the imidization can be carried out using a vacuum laminater in a batch method or using extruder equipped with a decompressor in a continuous method. Preferable extruder is a biaxial extruder and a triaxial extruder. Such methods are selectively used depending on production volume. In this specification, “an extruder equipped with a decompressor” is, for example, a commonly-used biaxial or triaxial extruder for heating and hot-extruding thermoplastic resin that is equipped with a device for removing a solvent under reduced pressure. Such extruder can be annexed to a conventional extruder. Alternatively, a device with a decompressing feature incorporated thereon can be produced. In this device, polyamide acid is imidized while polyamide acid solution is kneaded with an extruder, water generated during the imidization is removed, and finally a soluble polyimide is produced.

It is preferable to introduce hydroxy group and/or carboxy group into the aforementioned soluble polyimide because they tend to improve solubility to alkali and an alkaline solution can be used as a developing solution.

Imidization is conducted at 80° C. to 400° C. In order to efficiently conduct imidization and to efficiently remove water, imidization is conducted preferably at 100° C. or more, and more preferably at 120° C. or more. The highest temperature is preferably set to lower temperature than thermal decomposition temperature of polyimide to be used and imidization is generally completed at 250° C. to 350° C., so that the highest temperature can be set to this temperature range.

The reduced pressure is preferably low. However, any pressure is employed as far as the water is efficiently removed under the aforementioned heating conditions. Specifically, the reduced pressure is 0.09 MPa to 0.0001 MPa, preferably 0.08 MPa to 0.0001 MPa, and more preferably 0.07 MPa to 0.0001 MPa.

Acid dianhydride to be used in polyimide is not particularly limited. However, it is preferable to use acid dianhydride having one to four aromatic rings or aliphatic acid dianhydride in terms of heat resistance. Such tetracarboxylic acid dianhydride can be used alone or in combination.

Examples of tetracarboxylic acid dianhydrides include: aliphatic or alicyclic tetracarboxylic dianhydrides such as 2,2′-hexafluoropropylidene diphthalic dianhydride, 2,2-bis(4-hydroxyphenyl)propane dibenzoate-3,3′,4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopetanetetracarboxylic dianhydride, 2,3,5-tricarboxy cyclopentyl acetic dianhydride, 3,5,6-tricarboxy norbonan-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, and bicyclo[2,2,2]-octo-7-ene-2,3,5,6-tetracarboxylic dianhydride; aromatic tetracarboxylic dianhydrides such as pyromelletic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furan tetracarboxylic dianhydride, 4,4′-bis(3,4-dicarboxyphenoxy) diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyl tetracarboxylic dianhydride, bis(phthalic acid) phenylphosphine oxide dianhydride, p-phenylene-bis(triphenyl phthalic acid)dianhydride, m-phenylene-bis(triphenyl phthalic acid)dianhydride, bis(triphenyl phthalic)-4,4′-diphenyl ether dianhydride, and bis(triphenyl phthalic acid)-4,4′-diphenylmethane dianhydride; and aliphatic tetracarboxylic dianhydrides such as 1,3,3a,4,5,9b-hexahydro-2,5-dioxo-3-furanyl)-naphtho[1,2-c]furan-1,3-dion, 1,3,3a,4,5,9b-hexahydro-5-methyl-5-(tetrahydro-2,5-dioxo-3-furanyl)-naphtho[1,2-c]furan-1,3-dion, 1,3,3a,4,5,9b-hexahydro-8-methyl-5-(tetrahydro-2,5-dioxo-3-furanyl)-naphtho[1,2-c]furan-1,3-dion, a compound represented by the following general formula:

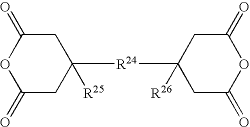

(wherein R²⁴ represents a divalent organic group having an aromatic ring, R²⁵ and R²⁶ each represent a hydrogen atom or an alkyl group), and a compound represented by the following general formula:

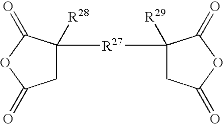

(wherein R²⁷ represents a divalent organic group having an aromatic group, R²⁸ and R²⁹ each represent a hydrogen atom or an alkyl group). Such tetracarboxylic dianhydrides can be used alone or in combination.

In order to develop heat resistance and mechanical characteristics of supermolecular structure of polyimide, it is preferable to use acid dianhydride represented by the general formula (2):

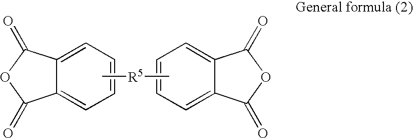

wherein R⁵ represents a single bond, —O—, —CH₂—, C₆H₄—, —C(═O)—, —C(CH₃)₂—, —C(CF₃)₂—, —O—R⁶—O—, or —(C═O)—O—R⁶—O(C═O)—.

Preferably, the acid dianhydride represented above contains at least 10 mol % or more of an acid dianhydride residue that is a material for the aforementioned soluble polyimide.

In order to achieve polyimide that has a high solubility in organic solvent, it is preferable to partially use 2,2′-hexafluoropropylidene diphthalic dianhydride, 2,3,3′,4′-biphenyltetracarboxylic dianhydride, or ester acid dianhydride represented by the following group (I):

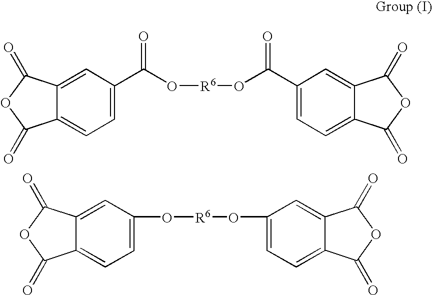

wherein R⁶ represents a divalent organic group, and is preferably selected from the group consisting of: —CH₂C(CH₃)₂CH₂—, —C_{qH}— (wherein q is an integer of 1 to 20), and the following groups (II):

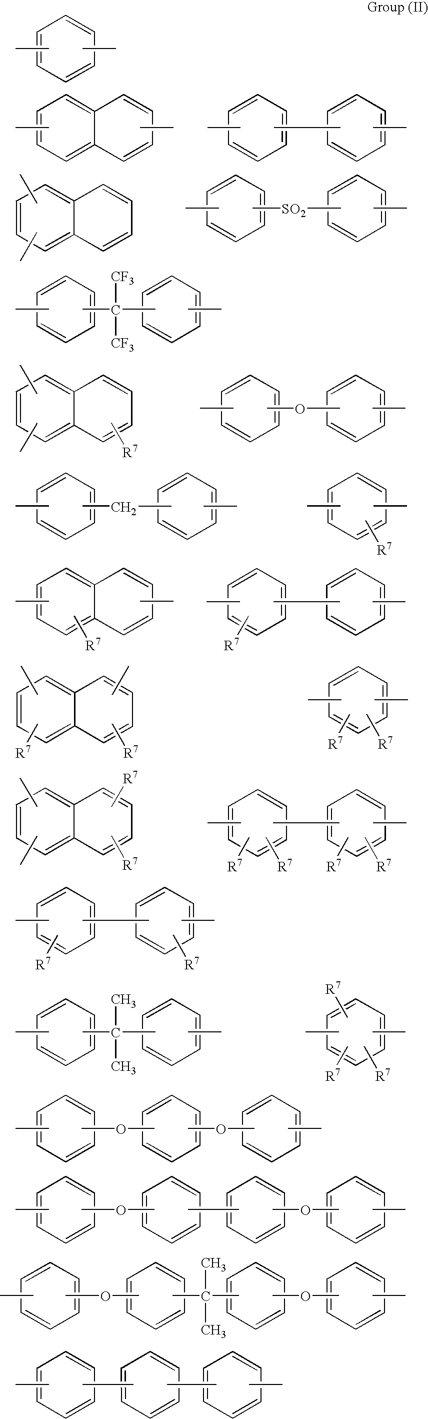

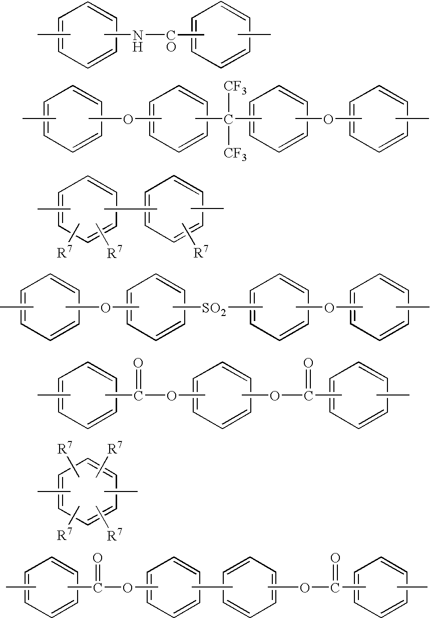

wherein R⁷ represents hydrogen, halogen, methoxy, C₁ to C₁₆ alkyl group.

Among the group (II), —C_{q}H_{2q}—or a bisphenol skeleton is preferable.

The diamine to be used in this polyimide is not particularly limited. However, in order to balance heat resistance and solubility, it is preferable to use diamine selected from the group (III):

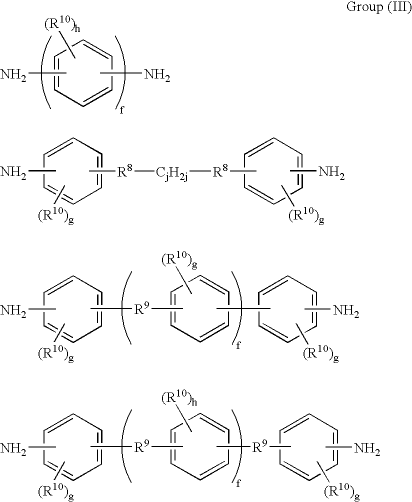

wherein R⁸s may be the same or different and represent a single bond, —O—, —C(═O)O—, —O(O═)C—, —SO₂—, —C(═O)—, —S—, or —C(CH₃)₂—; R⁹s may be the same or different and represent a single bond, —CO—, —O—, —S—, —C(CH₂)ᵣ— (wherein r is an integer of 1 to 20), —NHCO—, —C(CH₃)₂—, —C(CF₃)₂—, —COO—, —SO₂—, or —O—CH₂—C(CH₃)₂—CH₂—O—; R¹⁰s may be the same or different and represent hydrogen, hydroxy group, carboxy group, halogen, methoxy group, or C1 to C5 alkyl group, f represents 0, 1, 2, 3, or 4, g represents 0, 1, 2, 3, or 4, and j represents an integer of 1 to 20.

In order to increase the solubility of the resultant polyimide, the diamine represented by the group (III) preferably constitutes 5 to 95 mol % of the total diamine, and more preferably 10 to 70 mol %.

In order to improve flexibility of the film, the diamines selected from the group (III) wherein R¹⁰ is a hydroxy group or carboxy group are used as a part of diamine components and the solubility of imide to alkaline solution can be increased. These diamine compounds can be used alone or in combination.

In order to reduce elastic modulus of the film, the diamines represented by the general formula (2):

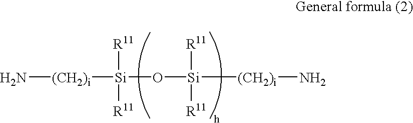

(wherein R¹¹ is C1 to C12 alkyl group or phenyl group, i is an integer of 1 to 20 and preferably an integer of 2 to 5, h is an integer of 1 to 40, preferably an integer of 4 to 30, more preferably 5 to 20, and particularly preferably 8 to 15) is used as a part of diamine components. In general formula (2), h exerts a great influence on physical properties. When the value of h is low, the resultant polyimide has poor flexibility. On the contrary, when the value of h is high, heat resistance of the polyimide tends to be spoiled.

In order to reduce elastic modulus of the film, siloxane diamine represented by the general formula (2) constitutes 5 to 70 mol % of all the diamine components. If siloxane diamine content is less than 5 mol %, insufficient adding effect is exhibited. On the contrary, if siloxane diamine content is more than 50 mol %, a film tends to be too brittle, the elastic modulus thereof tends to be too low, and the thermal expansion coefficient thereof tends to be too high.

If 2,2′- hexafluoro propylidene phthalic dianhydride, 2,3,3′4′- biphenyl tetracarboxylic dianhydride, and ester acid dianhydride represented by the group (I)

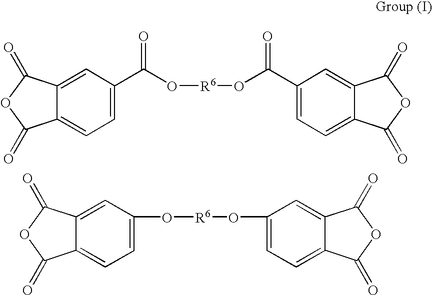

are used as main components of acid dianhydride and aromatic diamine having an amino group at a meta position, diamine having a sulfo group, and siloxane diamine represented by the general formula (2)

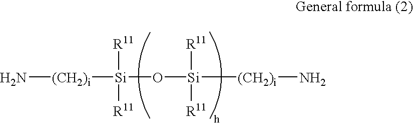

are used as a part of a diamine component, the solubility of the resultant soluble polyimide is dramatically increased, so that it can be dissolved in an ether solvent such as dioxane, dioxolane, and tetrahydrofuran or a halogen solvent such as chloroform and methylene chloride which is a low-boiling solvent having a boiling point of 120° C. or less. Particularly, if such low boiling solvent having a boiling point of 120° C. or less is used for applying and drying a photosensitive resin composition, thermalpolymerization of acryl and/or methacryl to be mixed can be prevented.

If a hydroxy group and/or carboxy group is/are introduced into the aforementioned soluble polyimide, the solubility of the polyimide to alkaline solution tends to be improved. Therefore, this is preferable because an alkaline solution is used as a developing solution.

Polyimide having a hydroxy group and/or carboxy group can be obtained by polymerizing a diamine component containing a diamine having a hydroxy group and/or carboxy group and an acid dianhydride component. Any diamine having a hydroxy group and/or carboxy group can be used.

For example, as a diamine component that is a base material of the soluble polyimide, a diamine having two COOH groups in a molecule is used. Thus, the soluble polyimide having carboxy group can be obtained.

Such diamine having two carboxy groups is not particularly limited, as far as it has two carboxy groups. Examples of such diamines are as follows.

Examples of diamines having two carboxy groups include: diaminophthalic acids such as 2,5-diaminoterephthalic acid; carboxybiphenyl compounds such as 3,3′-diamino-4,4′-dicarboxybiphenyl, 4,4′-diamino-3,3′-dicarboxybiphenyl, 4,4′-diamino-2,2′-dicarboxybiphenyl, and 4,4′-diamino-2,2′,5,5′-tetracarboxybiphenyl; carboxydiphenyl alkanes such as 3,3′-diamino-4,4′-dicarboxy diphenylmethane, 2,2-bis[3-amino-4-carboxyphenyl]propane, 2,2-bis[4-amino-3-carboxyphenyl]propane, 2,2-bis[3-amino-4-carboxyphenyl]hexafluoropropane, and 4,4′-diamino-2,2′,5,5′-tetracarboxydiphenylmethane; carboxydiphenylether compounds such as 3,3′-diamino-4,4′-dicarboxydiphenylether, 4,4′-diamino-3,3′-dicarboxydiphenylether, 4,4′-diamino-2,2′-dicarboxydiphenylether, and 4,4′-diamino-2,2′,5,5′-tetracarboxydiphenylether; diphenylsulfone compounds such as 3,3′-diamino-4,4′-dicarboxydiphenylsulfone, 4,4′-diamino-3,3′-dicarboxydiphenylsulfone, 4,4′-diamino-2,2′-dicarboxydiphenylsulfone, and 4,4′-diamino-2,2′,5,5′-tetracarboxyphenylsulfone; bis[(carboxyphenyl)phenyl] alkane compounds such as 2,2-bis[4-(4-amino-3-carboxyphenoxy)phenyl]propane; and bis[(carboxyphenoxy)phenyl]sulfone compounds such as 2,2-bis[4-(4-amino-3-carboxyphenoxy)phenyl]sulfone.

Particularly, a diamine having a carboxy group selected from the following group (IV) is preferably used because it is easily available.

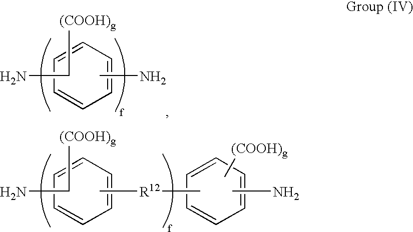

wherein f is an integer of 1 to 3, g is an integer of 1 to 4, R¹² represents a divalent organic group selected from the group consisting of —O—, —S—, —CO—, —CH₂—, —SO₂—, —C(CH₃)₂—, —C(CF₃)₂—, or —O—CH₂—C(CH₃)₂—CH₂—O—.

Also, a diamine having one carboxy group can be additionally used. Examples of such diamines include: diaminophenol compounds such as 2,4-diaminophenol, hydroxybiphenyl compounds such as 3,3′-diamino-4,4′-dihydroxybiphenyl, 4,4′-diamino-3,3′-dihydroxybiphenyl, 4,4′-diamino-2,2′-dihydroxybiphenyl, and 4,4′-diamino-2,2′,5,5′-tetrahydroxybiphenyl; hydroxydiphenyl alkanes such as 3,3′-diamino-4,4′-dihydroxydiphenyl methane, 4,4′-diamino-3,3′-dihydoroxydiphenyl methane, 4,4′-diamino-2,2′-dihydoroxydiphenyl methane, 2,2-bis[3-amino-4-hydroxyphenyl]propane, 2,2-bis[4-amino-3-hydroxyphenyl]propane, 2,2-bis[3-amino-4-hydroxyphenyl]hexafluoropropane, and 4,4′-diamino-2,2′,5,5′-tetrahydroxydiphenyl methane; hydroxydiphenyl ether compounds such as 3,3′-diamino-4,4′-dihydroxydiphenylether, 4,4′-diamino-3,3′-dihydroxydiphenyl ether, 4,4′-diamino-2,2′-dihydroxydiphenyl ether, and 4,4′-diamino-2,2′,5,5′-tetrahydroxydiphenyl ether; diphenylsulfone compounds such as 3,3′-diamino-4,4′-dihydroxydiphenyl sulfone, 4,4′-diamino-3,3′-dihydroxydiphenylsulfone, 4,4′-diamino-2,2′-dihydroxydiphenylsulfone, and 4,4-diamino-2,2′,5,5′-tetrahydroxydiphenyl sulfone; bis[(hydroxyphenyl)phenyl] alkane compounds such as 2,2-bis[4-(4-amino-3-hydroxyphenoxy)phenyl]propane; bis(hydroxyphenoxy)biphenyl compounds such as 4,4′-bis(4-amino-3-hydroxyphenoxy)biphenyl; bis[(hydroxyphenoxy)phenyl]sulfone compounds such as 2,2-bis[4-(4-amino-3-hydroxyphenoxy)phenyl]sulfone; diaminobenzoic acids such as 3,5-diaminobenzoic acid; and bis(hydroxyphenoxy)biphenyl compounds such as 4,4′-diamino-3,3′-hydroxydiphneyl methane, 4,4′-diamino-2,2′-dihydroxydiphenyl methane, 2,2-bis[3-amino-4-carboxyphenyl]propane, and 4,4′-bis(4-amino-3-hydroxyphenoxy)biphenyl.

The diamine to be used in this polyimide composition is not particularly limited. Examples of such diamine include: aromatic diamines such as p-phenylenediamine, m-phenylenediamine, 4,4′-diaminodiphenylmethane, 4,4′-diaminophenylethane, 4,4′-diaminophenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethyl benzanilide, 3,5-diamino-4′-trifluoromethyl benzanilide, 3,4′-diaminodiphenylether, 2,7-diaminofluorene, 2,2-bis(4-aminophenyl)hexafluoropropane, 4,4′-methylene-bis(2-chloroamiline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]octafluorobiphenyl; aromatic diamines having two amino groups bonded to an aromatic ring and a hetero atom other than nitrogen atom of the aforementioned two amino groups such as diamino tetraphenyl thiophene; aliphatic diamines and alicyclic diamines such as 1,1-methaxylenediamine, 1,3-propane diamine, tetramethylene diamine, pentamethylene diamine, octamethylene diamine, nonamethylene diamine, 4,4-diaminoheptamethylene diamine, 1,4-diaminocyclohexane, isophorone diamine, tetrahydrodicyclo pentadienylene diamine, hexahydro-4,7-methanoindanylene dimethylene diamine, tricyclo[6,2,1,0^{2.7}]-undecylene dimethyldiamine, and 4,4′-methylenebis(cyclohexylamine); mono-substituted phenylene diamines represented by the general formula (4):

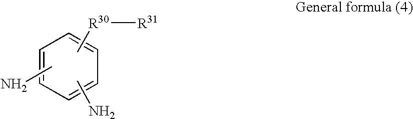

(wherein R³⁰ represents a divalent organic group selected from the group consisting of —O—, —COO—, —OCO—, —CONH—, and —CO—, and R³¹ represents a monovalent organic group having a steroid skeleton). Such diamine compounds can be used alone or in combination.

If an aromatic diamine having an amino group at meta position (3-) is used, the light absorption of the resultant soluble imide itself tends to be reduced at g or i rays, so that it is useful for designing photosensitive resin.

The aforementioned soluble polyimide having a carboxy group can provide resin composition that is soluble in alkaline solution because of the carboxy group. Also, the soluble polyimide having a hydroxy group contributes to improvement of solubility in alkaline solution.

In order to provide reactivity and curability, a soluble polyimide with a hydroxy group and/or carboxy group introduced thereinto is reacted with a compound having an epoxy group so as to produce modified polyimide with various functional groups (later described) introduced thereinto.

When a carboxy group (—COOH) is developed in an alkaline solution, COO⁻K⁺is produced (in the case where a developing solution containing potassium is used) and metal ion remains in the photosensitive resin composition. This exerts an adverse effect on electric properties of the composition.

When an epoxy group is reacted with COOH, an ester bond and a secondary hydroxy group (for example, COO—CH₂—CH(OH)—) are produced. A compound having a ester bond and a secondary hydroxy group hardly incorporates metal ion when it is developed. In other words, such compound does not deteriorate its electric properties. In addition, it is discovered that such compound can be developed in an alkaline solution.

In this specification, it is preferable that the compound having an epoxy group has two or more functional groups selected from the group consisting of an epoxy group, carbon-carbon triple bond, and carbon-carbon double bond as a photopolymerized and/or thermopolymerized functional group. By introducing such photopolymerized and/or thermopolymerized functional group, excellent curability and adhesiveness can be provided to the resultant composition.

Specifically, the modified polyimide used herein means a soluble polyimide represented by the general formula (1):

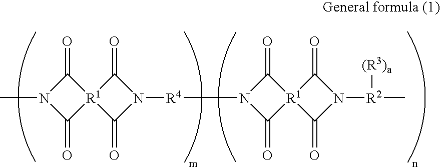

wherein R¹ is a tetravalent organic group, R² is (a+2) valence organic group, R³ is a monovalent organic group, R⁴ is a divalent organic group, a is an integer of 1 to 4, m is an integer of 0 or more, n is an integer of 1 or more, in which R³ is a residue of epoxy compound having two or more epoxy groups. Even if such soluble polyimide is epoxy modified, solubility thereof is retained and other good properties can be further added.

In the general formula (1), R³ may be a residue of a compound having an epoxy group and a carbon-carbon double bond or a carbon-carbon triple bond.

Specifically, the modified polyimide is a soluble polyimide represented by the general formula (1) in which R³ can be selected from a structural unit having an organic group represented by the following group (V):

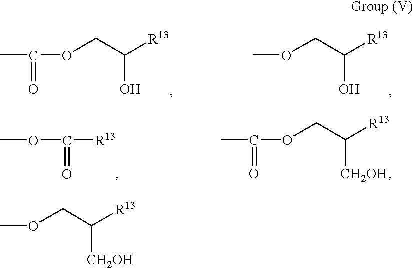

wherein R¹³ is a monovalent organic group having at least one kind of functional group selected from the group consisting of an epoxy group, carbon-carbon triple bond, and carbon-carbon double bond. The photosensitive resin composition of the present invention may contain 1 wt % or more of the aforementioned epoxy modified polyimide.

A solvent to be used in a reaction is not particularly limited, as far as it does not have reactivity with an epoxy group but dissolves polyimide having a hydroxy group and/or carboxy group. Examples of such solvent include: ether solvents such as tetrahydrofuran and dioxane; alcohol solvents such as methanol, ethanol, and butanol; cellosolve solvents such as butylcellosolve; hexamethylphosphoramide; γ-butyrolactone; aromatic hydrocarbons such as xylene and toluene. These solvents can be used alone or in combination. Since the solvents are removed later, it is advantageous to use such solvents that can solve a thermoplastic polyimide having a hydroxy group or carboxy group and has a low boiling point.

Preferably, the reaction is carried out at a reaction temperature of 400 or more to 1300 or less at which an epoxy group is reacted with a hydroxy group and/or carboxy group. Particularly, where an epoxy group is reacted with a compound having a double bond or triple bond, it is preferably reacted at a temperature at which the double bond and triple bond are not cross-linked or polymerized. Specifically, a reaction temperature is preferably 40° or more to 100° or less, more preferably 50° or more to 80° or less. The reaction time ranges from about one hour to 15 hours.

In this way, a solution of the modified polyimide can be obtained. In order to increase adhesiveness to a copper foil and to improve developability, thermosetting resin such as epoxy resin, acryl resin, cyanate ester resin, bismaleimide resin, bisallylnadiimide resin, and phenol resin or thermoplastic resin such as polyester, polyamide, polyurethane, and polycarbonate can be mixed to the solution of the modified polyimide.

Next, a method of producing an epoxy-modified polyimide will be described. The aforementioned soluble polyimide having a carboxy group is dissolved in an organic solvent. Then an epoxy compound is reacted with the polyimide having a hydroxy group or carboxy group. Thus an epoxy modified compound is obtained. This epoxy modified polyimide exhibits solubility, but preferably it further exhibits thermoplasticity and has a glass transition temperature (Tg) of 350° or less.

A solvent to be used in a reaction is not particularly limited, as far as it does not have reactivity with an epoxy group and can dissolve polyimide having a hydroxy group or carboxy group. Examples of solvents to be used include: sulfoxide solvents such as dimethyl sulfoxide and diethyl sulfoxide; formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; ether solvents such as tetrahydrofuran and dioxane; alcohol solvents such as methanol, ethanol, and butanol; cellosolve solvents such as butylcellosolve; hexamethylphosphoramide; γ-butyrolactone; and aromatic hydrocarbon such as xylene and toluene. These solvents can be used alone or in combination. Since the epoxy modified polyimide of the present invention is used after solvents are removed therefrom, it is important to use solvents having a low boiling point.

Next, there will be described an epoxy compound that is reacted with polyimide having a hydroxy group or carboxy group. Preferable epoxy compound has two or more epoxy groups or has an epoxy group and a carbon-carbon double bond or a carbon-carbon triple bond, for example.

In this specification, an epoxy compound having two or more epoxy groups indicates a compound having two or more epoxy groups in one molecule. Examples of such compounds include bisphenol resin such as Epikote 828 (Yuka Shell Epoxy Co., Ltd.), orthocresol novolak resin such as 180S65 (Yuka Shell Epoxy Co., Ltd.), bisphenol A novolak resin such as 157S70 (Yuka Shell Epoxy Co., Ltd.), trishydroxy phenylmethane novolak resin such as 1032H60 (Yuka Shell Epoxy Co., Ltd.), naphthalene aralkyl novolak resin such as ESN375, glycidyl amine type resin such as tetraphenylol ethane 1031S (Yuka Shell Epoxy Co., Ltd.), YGD414S (Toto Kasei KK), trishydroxy phenylmethane EPPN502H (Nippon Kayaku Co., Ltd.), special bisphenol VG3101L (Mitsui Chemicals, Inc.), special naphthol NC7000 (Nippon Kayaku Co., Ltd.), and TETRAD-X and TETRAD-C (Mitsubishi Gas Chemical Company, Inc.).

An epoxy compound having an epoxy group and a carbon-carbon double bond is not particularly limited, as far as it has an epoxy group and a carbon-carbon double bond in its molecule. Examples of such epoxy compound include allyl glycidyl ether, glycidyl acrylate, glycidyl methacrylate, and glycidyl vinyl ether.

An epoxy compound having an epoxy group and a carbon-carbon triple bond is not particularly limited, as far as it has an epoxy group and a carbon-carbon triple bond in its molecule. Examples of such epoxy compound include propargyl glycidyl ether, glycidyl propiolate, and ethinyl glycidyl ether.

In order to react an epoxy compound with polyimide having a hydroxy group or a carboxy group, they are dissolved in an organic solvent and heated. They can be dissolved by any technique. However, preferable reaction temperature ranges from 40° C. or more to 130° C. or less. Preferably, an epoxy compound having a carbon-carbon double bond or a carbon-carbon triple bond is reacted at a temperature at which a carbon-carbon double bond or a carbon-carbon triple bond is not decomposed or cross-linked. Specifically, a reaction temperature is preferably 40° C. or more to 100° C. or less, and more preferably 50° C. or more to 90° C. or less. The reaction time ranges from several minutes to about 8 hours. In this way, a solution of epoxy modified polyimide can be obtained. To such solution of epoxy modified polyimide may be mixed a thermoplastic resin such as polyester, polyamide, polyurethane, and polycarbonate or a thermosetting resin such as epoxy resin, acrylic resin, bismaleimide, bisallylnadiimide, phenol resin, and cyanate resin. Alternatively, a coupling agent may be mixed to the solution of epoxy modified polyimide.

When a curing agent used generally for epoxy resin is mixed with the epoxy modified polyimide of the present invention, a cured product having excellent properties may often be obtained. Particularly, this is shown in use of an epoxy modified polyimide obtained by reacting an epoxy compound having two or more epoxy groups with polyimide having a hydroxy group or a carboxy group. In this case, examples of usable curing agents for epoxy resin include curing agents containing amines, imidazoles, acid anhydrides, and acids.

Next, a compound having a carbon-carbon double bond will be described. This component provides flowability to a resultant composition and a dry film in thermo compression bonding, so that high resolution can be achieved.

Preferably, such compound has one or more aromatic rings and two or more carbon-carbon double bonds.

Further, a compound having a carbon-carbon double bond is an acrylic compound having at least one kind selected from aromatic rings and heterocycles.

Particularly, if a compound having, in one molecule, 1 to 40 repeating units represented by —(CHR¹⁴—CH₂—O)— wherein R¹⁴ is a hydrogen group or methyl group is used, a monomer before curing is easy to be dissolved in an alkaline solution, so that unexposed resin is quickly removed by being dissolved in an alkaline solution. At the result, excellent resolution can be achieved for a short time.

Such component is preferably a di(metha)acrylate compound having at least one aromatic ring represented by the following group (VI):

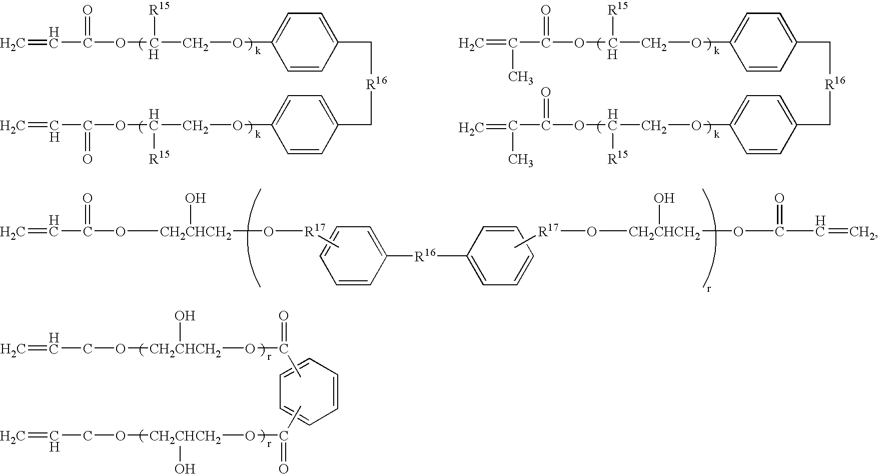

Group (VI)

(wherein R¹⁵ is a hydrogen, methyl group, or ethyl group, R¹⁶ is a divalent organic group, R¹⁷ is a single bond or a divalent organic group, k is the same or different and is an integer of 2 to 20, and r is the same or different and is an integer of 1 to 10.)

A di(metha)acrylate compound represented by the group (VI) wherein k and r are an integer of 21 or more is not preferable because its materials are hard to obtain and because resultant film tends to easily absorb moisture while it has excellent solubility in an alkaline solution.

It is preferable to use a di(metha)acrylate compound represented by the group (VI) wherein k and r are an integer of 2 to 5 and a di(metha)acrylate compound represented by the group (VI) wherein k and r are an integer of 11 to 16 in combination.

Preferably, the former di(metha)acrylate compound and the latter di(metha)acrylate compound are mixed in a ratio of 1 to 0.1-100 weight parts. If the di(metha)acrylate compound represented by the group (VI) wherein k and r are an integer of 2 to 10 is used alone, the resultant composition tends to have poor solubility in an alkaline solution and poor developability.

Examples of a compound having at least one aromatic ring and two or more carbon-carbon double bonds in one molecule are as follows.

For example, preferable such compounds are: bisphenol F EO-modified (n=2 to 50) diacrylate, bisphenol A EO-modified (n=2 to 50) diacrylate, bisphenol S EO-modified (n=2 to 50) diacrylate, 1,6-hexanediol acrylate, neopentyl glycol diacrylae, ethylene glycol diacrylate, pentaerithritol diacrylate, trimethylolpropane triacrylate, pentaerithritol triacrylate, dipentaerithritol hexaacrylate, tetramethylolpropane tetraacrylate, tetraethylene glycol diacrylate, 1,6-hexanediol dimethacrylate, neopentyl glycol dimethacrylate, ethylene glycol dimethacrylate, pentaerithritol dimethacrylate, trimethylolpropane trimethacrylate, pentaerithritol trimethacrylate, dipentaerithritol hexamethacrylate, tetramethylolpropane tetramethacrylate, tetraethylene glycol dimethacrylate, methoxy diethylene glycol methacrylate, methoxypolyethylene glycol methacrylate, β-methacroyl oxyetyl hydrogen phthalate, β-methacroyl oxyetyl hydrogen succinate, 3-chloro-2-hydroxypropyl methacrylate, stearyl methacrylate, phenoxy ethyl acrylate, phenoxy diethylene glycol acrylate, phenoxypolyethylene glycol acrylate, β-acryloyl oxyetyl hydrogen succinate, laurylacrylate, ethylene glycol dimethacrylate, diethylene glycol dimethacrylate, triethylene glycol dimethacrylate, polyethylene glycol dimethacrylate, 1,3-butylene glycol dimethacrylate, 1,6- hexanediol dimethacrylate, neopentyl glycol dimethacrylate, polypropylene glycol dimethacrylate, 2-hydroxyl, 3dimethacryloxy propane, 2,2-bis[4-(methacroxyethoxy)phenyl]propane, 2,2-bis[4-(methachroxy.diethoxy)phenyl]propane, 2,2-bis[4-(methachroxy.polyethoxy)phenyl]propane, polyethylene glycol dicrylate, tripropylene glycol diacrylate, polypropylene glycol diacrylate, 2,2-bis[4-(acryloxy.diethoxy)phenyl]propane, 2,2-bis[4-(acryloxy.polyethoxy)phenyl]propane, 2-hydroxyl-acryloxy3-methacroxy propane, trimethylolpropane trimethacrylate, tetramethylmethane triacrylate, tetramethylolmethane tetraacrylate, methoxy dipropylene glycol methaclate, methoxy triethylene glycol acrylate, nonylphenoxy polyethylene glycol acrylate, nonylphenoxy polypropylene glycol acrylate, 1-acryloyl oxypropyl-2-phthalate, isostearyl acrylate, polyoxyethylenealkylether acrylate, nonylphenoxy ethylene glycol acrylate, polypropylene glycol dimethaclate, 1,4-butanediol dimethacrylate, 3-methyl-1,5-pentanediol dimethacrylate, 1,6-hexanediol dimethacrylate, 1,9-nonane diol metacrylate, 2,4-diethyl-1,5-pentanediol dimethacrylate, 1,4-cyclohexane dimethanol dimethacrylate, dipropylene glycol diacrylate, tricyclodecanedimethanol diacrylate, 2,2-hydrogenerated bis[4-(acryloxy.polyethoxy)phenyl]propane, 2,2-bis[4-(acryloxy.polyproxy) phenyl]propane, 2,4-diethyl-1,5-pentanediol diacrylate, ethoxy trimethylol propane triacrylate, propoxy trimethylolpropane triacrylate, isocyanuric acid tri(ethaneacrylate), pentaerithritol tetraacrylate, ethoxy pentaerithritol tetraacrylate, propoxy pentaerithritol tetraacrylate, ditrimethylolpropane tetraacrylate, dipentaerithritol polyacrylate, isocyanuric acid triallyl, glycidyl methaclate, glycidyl allyl ether, 1,3,5-triacryloylhexahydro-s-triazine, triallyl 1,3,5-benzene carboxylate, triallyl amine, triallyl citrate, triallyl phosphate, allobarbital, diallyl amine, diallyl dimethyl silane, diallyl disulfide, diallylether, zalilsialate, diallylisophthalate, diallylterephthalate, 1,3-diallyloxy-2-propanol, diallylsulfide diallyl, maleate, 4,4′-isopropylidene diphenol dimetaacrylate, and 4,4′-isopropylidene diphenol diacrylate. However, such compounds are not limited to the above. In order to improve crosslinking density, it is preferable to use a monomer containing at least two functional groups.

In order that a cured photosensitive dry film resist obtained from the photosensitive resin composition of the present invention can express flexibility, a compound having a carbon-carbon double bond is preferably used with bisphenol F, EO-modified diacrylate.bisphenol A, EO-modified diacrylate.bisphenol S, EO-modified diacrylate bisphenol F, EO-modified dimethacrylate.bisphenol A, EO-modified dimethacrylate.bisphenol S, and EO-modified dimethacrylate. In particular, it is preferable that diacrylate or methacrylate has 2 to 50 repeating units of EO in one molecule thereof, and more preferably has 2 to 40 repeating units. The repeating units of EO improves solubility in alkaline solution and reduces the developing time. It is not preferable to contain 50 or more of repeating units of EO, because heat resistance tends to be deteriorated.

Preferably, 1 to 200 parts by weight of the compound having a carbon-carbon double bond are contained in 100 parts by weight of the soluble polyimide of the present invention, and more preferably 3 to 150 parts by weight are contained. If the content of the compound deviates from the range of 1 to 200 parts by weight, desired effects cannot be produced or undesirable effects are exerted on its developing properties. As the compound having a carbon-carbon double bond, one kind of compound may be used alone or various compounds may be used in combination.

Further, in order to improve adhesiveness, epoxy resin may be added to the photosensitive resin composition of the present invention. Any epoxy resin can be used as far as it has an epoxy group in its molecule. Examples of epoxy resins are as follows.

Examples of epoxy resins include: bisphenol resin such as Epikote 828 (Yuka Shell Epoxy Co., Ltd.), orthocresol novolak resin shch as 180S65 (Yuka Shell Epoxy Co., Ltd.), bisphenol A novolak resin such as 157S70 (Yuka Shell Epoxy Co., Ltd.), trishydroxy phenylmethane novolak resin such as 1032H60 (Yuka Shell Epoxy Co., Ltd.), naphthalene aralkyl novolak resin such as ESN375, glycidyl amine resins such as tetraphenylol ethane 1031S (Yuka Shell Epoxy Co., Ltd.), YGD414S (Toto Kasei KK),trishydroxy phenylmethane EPPN502H (Nippon Kayaku Co., Ltd.), special bisphenol VG3101L (Mitsui Chemicals, Inc.), special naphthol NC7000 (Nippon Kayaku Co., Ltd.), and TETRAD-X and TETRAD-C (Mitsubishi Gas Chemical Company, Inc.).

Also, a compound having an epoxy group and a carbon-carbon double bond or a carbon-carbon triple bond in a molecule thereof can be added. Example of such compounds include: allyl glycidyl ether, glycidyl acrylate, glycidyl methacrylate, glycidyl vinyl ether, propargyl glycidyl ether, glycidyl propiolate, and ethinyl glycidyl ether.

For example, the following acrylate may be contained: bisphenol A EO-modified di(metha)acrylate such as ARONIX M-210 and M-211B (Toagosei Co., Ltd.) and NK ester ABE-300, A-BPE-4, A-BPE-10, A-BPE-20, A-BPE-30, BPE-100 and BPE-200 (Shin-Nakamura Chemical Co., Ltd), bisphenol F EO-modified (n=2 to 20) di(metha)acrylate such as ARONIX M-208 (Toagosei Co., Ltd.), bisphenol A PO-modified (n=2 to 20) di(metha)acrylate such as Denacol acrylate DA-250 (Nagase Kasei Co., Ltd.) and Biscote #540 (Osaka Organic Chemical Industry Ltd.), phthalic PO-modified diacrylate such as Denacol acrylate DA-721 (Nagase Kasei Co., Ltd.), isocyanuric acid EO-modified diacrylate such as ARONIX M-215 (Toagosei Co., Ltd.), ARONIX M-315 (Toagosei Co., Ltd.), and isocyanuric acid EO-modified triacrylate such as NK ester A-9300 (Shin-Nakamura Chemical Co., Ltd).

Such components may be one kind of the aforementioned compounds or a blend of various kinds thereof.

Preferably, the component having a carbon-carbon double bond constitutes 5 to 90 wt % of the total (soluble polyimide, a compound having a carbon-carbon double bond in one molecule, and photoreactive initiator and/or sensitizer). If the component constitutes less than 5 wt % of the total, compression temperature tends to be high and resolution tends to be low. On the contrary, if the component constitutes more than 90 wt %, B-stage film tends to be sticky, resin tends to easily seeps out during thermocompression bonding, and cured compound tends to be too britle. Preferably, the compound constitutes 1 to 40 wt % of the total, and more preferably 5 to 10 wt %.

The photosensitive resin composition of the present invention contains a photoreaction initiator as an essential component so as to provide photosensitivity to the composition.

An example of a compound that generates radicals by long wavelength light, e.g., g or i ray, and that is used as a photoreaction initiator is an acyl phosphine oxide compound represented by the following general formulas (α) and (β):

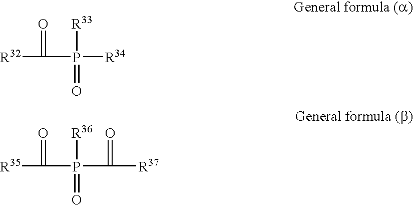

wherein R³², R³⁵, and R³⁷ represent C₆H₅—, C₆H₄(CH₃)—, C₆H₂(CH₃)₃—, (CH₃)₃C—, and C₆H₃Cl₂—, R³³, R³⁴, and R³⁶ represent C₆H₅—, methoxy, ethoxy, C₆H₄(CH₃)—, and C₆H₂(CH₃)₃—. The generated radicals are reacted with a reaction group (vinyl, acroyl, methacroyl, allyl, etc.) to promote cross-links. Particularly, the acyl phosphine oxide represented by the general formula (βP) is preferable because it generates four radicals by α-cleavage reaction. (In the general formula (α), two radicals are generated.)

As a radical initiator, various peroxides can be used in combination with any of the following sensitizer. Particularly preferable sensitizer is 3,3′, 4,4′-tetra(t-butylperoxy carbonyl)benzophenone.

In order to achieve a practicable degree of photosensitivity, the polyimide resin composition of the present invention can contain a sensitizer.

Preferable examples of sensitizers include: Michler's ketone, bis-4,4′-diethylamino benzophenone, benzophenone, camphorquinone, benzil, 4,4′-dimethylaminobenzil, 3,5-bis(diethylamino benzylidene)-N-methyl-4-piperidone, 3,5-bis(dimethylamino benzylidene)-N-methyl-4-piperidone, 3,5-bis(diethylamino benzylidene)-N-ethyl-4-piperidone, 3,3′-carbonylbis(7-diethylamino)coumarin, riboflavin tetrabutyrate, 2-methyl-1-[4-(methylthio)phenyl]-2-morpholinopropane-1-one, 2,4-dimethylthioxanthone, 2,4-diethylthioxanthone, 2,4-diisopropylthioxanthone, 3,5-dimethylthioxanthone, 3,5-diisopropylthioxanthone, 1-phenyl-2-(ethoxycarbonyl)oxiiminopropane-1-one, benzoin ether, benzoin isopropyl ether, benzanthrone, 5-nitroacenaphthene, 2-nitrofluorene, anthrone, 1,2-benzanthraquinone, 1-phenyl-5-mercapto-1H-tetrazole, thioxanthen-9-one, 10-thioxanthenon, 3-acetylindole, 2,6-di(p-dimethylaminobenzal)-4-carboxy cyclohexanone, 2,6-di(p-dimethylaminobenzal)-4-hydroxy cyclohexanone, 2,6-di(p-diethylaminobenzal)-4-carboxy cyclohexanone, 2,6-di(p-diethylaminobenzal)-4-hydroxy cyclohexanone, 4,6-dimethyl-7-ethylaminocoumarin, 7-diethylamino-4-methylcoumarin, 7-diethylamino-3-(1-methylbenzimidazolyl)coumarin, 3-(2-benzoimidazolyl)-7-diethylamino coumarin, 3-(2-benzothiazolyl)-7-diethylamino coumarin, 2-(p-dimethylamino styryl)benzooxazole, 2-(p-dimethylamino styryl)quinoline, 4-(p-dimethylamino styryl)quinoline, 2-(p-dimethylamino styryl)benzothiazole, and 2-(p-dimethylamino styryl)-3,3-dimethyl-3H-indole. However, the sensitizer is not limited to the above.

Preferably, 0.1 to 50 parts by weight of sensitizer are contained in 100 parts by weight of the polyimide of the present invention, and more preferably 0.3 to 20 wt % of sensitizer are contained. If the content of the sensitizer deviates from the above range, desired sensitizing effects cannot be produced and undesirable effects are exerted on developability of the polyimide. As a sensitizer, one or more kinds of compounds may be mixed.

In order to achieve a practicable degree of photosensitivity, a polyimide resin composition of the present invention may contain a photopolymerization assistant. Examples of photopolymerization assistants include: 4-diethylaminoethylbenzoate, 4-dimethylaminoethylbenzoate, 4-diethylaminopropylbenzoate, 4-dimethylaminopropylbenzoate, 4-dimethylamino isoamylbenzoate, N-phenylglycine, N-methyl-N-phenylglycine, N-(4-cyanophenyl)glycine, 4-dimethylaminobenzonitrile, ethylene glycol dithioglycolate, ethylene glycol di(3-mercapto propionate), trimethylolpropane thioglycolate, trimethylolpropane tri(3-mercapto propionate), pentaerythritol tetrathioglycolate, pentaerythritol tetra(3-mercapto propionate), trimethylolethane trithioglycolate, trimethylolpropane trithioglycolate, trimethylolethane tri(3-mercapto propionate), dipentaerythritol hexa(3-mercapto propionate), thioglycolic acid, α-mercapto propionic acid, t-butylperoxibenzoate, t- butylperoximethoxybenzoate, t-butylperoxinitrobenzoate, t-butylperoxiethylbenzoate, phenylisopropylperoxibenzoate, di-t-butylperoxiisophthalate, tri-t-butyltriperoxitrimeritate, tri-t-butyltriperoxitrimeritate, tetra-t-butyltetraperoxipyromeritate, 2,5-dimethyl-2,5-di(benzoylperoxi)hexane, 3,3′,4,4′-tetra(t-butylperoxicarbonyl)benzophenone, 3,3,4,4′-tetra(t-amylperoxicarbonyl) benzophenone, 3,3′,4,4′-tetra(t-hexylperoxicarbonyl)benzophenone, 2,6-di(p-azidobenzale)-4-hydroxycyclohexanone, 2,6-di(p-azidobenzale)-4-carboxycyclohexanone, 2,6-di(p-azidobenzale)-4-methoxycyclohexanone, 2,6-di(p-azidobenzale)-4-hydroxymethylcyclohexanone, 3,5-di(p-azidobenzale)-1-methyl-4-piperidone, 3,5-di(p-azidobenzale)-4-piperidone, 3,5-di(p-azidebenzale)-N-acetyl-4-piperidone, 3,5-di(p-azidobenzale)-N-methoxycarbonyl-4-piperidone, 2,6-di(p-azidobenzale)-4-hydroxycyclohexanone, 2,6-di(m-azidobenzale)-4-carboxycyclohexanone, 2,6-di(m-azidobenzale)-4-methoxycyclohexanone, 2,6-di(m-azidobenzale)-4-hydroxymethylcyclohexanone, 3,5-di(m-azidobenzale)-N-methyl-4-piperidone, 3,5-di(m-azidobenzale)-4-piperidone, 3,5-di(m-azidobenzale)-N-acetyl-4-piperidone, 3,5-di(m-azidobenzale)-N-methoxycarbonyl-4-piperidone, 2,6-di(p-azidocinnamylidene)-4-hydroxycyclohexanone, 2,6-di(p-azidocinnamylidene)-4-carboxycyclohexanone, 2,6-di(p-azidocinnamylidene)-4-cyclohexanone, 3,5-di(p-azidocinnamylidene)-N-methyl-4-piperidone, 4,4′-diazidochalcone, 3,3′-diazidochalcone, 3,4′-diazidochalcone, 4,3′-diazidochalcone, 1,3-diphenyl-1,2,3-propanetrione-2-(o-acetyl)oxime, 1,3-diphenyl-1,2,3-propanetrione-2-(o-n-propylcarbonyl)oxime, 1,3-diphenyl-1,2,3-propanetrione-2-o-methoxycarbonyl)oxime, 1,3-diphenyl-1,2,3-propanetrione-2-(o-ethoxycarbonyl)oxime, 1,3-diphenyl-1,2,3-propanetrione-2-(o-benzoyl)oxime, 1,3-diphenyl-1,2,3-propanetrione-2-(o-phenyl oxicarbonyl)oxime, 1,3-bis(p-methylphenyl)-1,2,3-propanetrione-2-(o-benzoyl)oxime, 1,3-bis(p-methoxyphenyl)-1,2,3-propanetrione-2-(o-ethoxyc arbonyl)oxime, and 1-(p-methoxyphenyl)-3-(p-nitrophenyl)-1,2,3-propanetrione-2-(o-phenyloxycarbonyl)oxime. However, the photopolymerization assistant is not limited to the above. As other assistant, trialkylamines such as triethylamine, tributylamine, and triethanol can be also used.

Preferably, 0.1 to 50 parts by weight of photopolymerization assistant is contained in 100 parts by weight of polyimide, and more preferably 0.3 to 20 parts by weight is contained. If the content of the photopolymerization assistant deviates from the above range, desired sensitizing effects cannot be produced or an undesirable effect is exerted on developing properties. In the present invention, one or more kinds of compounds may be mixed as a photopolymerization assistant.

Preferably, the photoreaction initiator and sensitizer constitute 0.001 to 10 parts by weight of the total amount of the soluble polyimide, the compound having a carbon-carbon double bond and photoreaction initiator and/or sensitizer, and more preferably 0.01 to 10 parts by weight. If the content of the photoreaction initiator and sensitizer deviates from the range of 0.001 to 10 parts by weight, desired sensitizing effects cannot be produced or an undesirable effect is exerted on developing properties. In the present invention, one or more kinds of compounds may be mixed as a photoreaction initiator and sensitizer.

These compounds can be easily mixed by dissolving them in a solvent, and thus the photosensitive resin composition of the present invention can be produced. Using the photosensitive resin composition as a coverlay film, excellent heat resistance, mechanical properties, electrical insulating properties, and alkali resistance can be provided to a flexible printed wiring board.

In an embodiment of the photosensitive resin composition of the present invention, the soluble polyimide constitutes 5 to 90 wt % and preferably 10 to 80 wt %, the compound having a carbon-carbon double bond constitutes 5 to 80 wt % and preferably 10 to 70 wt %, and the photoreaction initiator and/or sensitizer component(s) constitute(s) 0.001 to 10 wt % and preferably 1 to 5 wt % of the total amount (soluble polyimide component, compound component having a carbon-carbon double bond, and photoreaction initiator component and/or sensitizer component).

Particularly preferably, the soluble polyimide component constitutes 30 to 70 wt %, the compound component having a carbon-carbon double bond constitutes 10 to 50 wt %, and the photoreaction initiator component and/or sensitizer component constitute(s) 1 to 50 wt % of the total amount.

By changing the mixing ratios of these components, heat resistance and compression temperature can be adjusted.

In another embodiment of the present invention, a flame resistance and self-extinguishing properties that meets the standard for tests for flammability of plastic materials known as UL94V-0 can be provided by additionally mixing a special compound. Specifically, by additionally mixing a flame-retardant compound such as a phosphorous compound, halogen- containing compound, or phenylsiloxane having a structural unit represented by:

R²²SiO_{3/2} and/or R²³SiO_{2/2}

wherein R²² and R²³ are selected from a phenyl group, an alkyl group having a carbon number of 1 to 4, and an alkoxy group, excellent flame retardance can be provided.

These compounds may be added alone or in combination.

Among the aforementioned flame-retardant compounds, the phosphorous compound preferably contains 5.0 wt % or more of phosphorous. It is generally known that a phosphorous compound has an effect as a flame-retardant agent. Therefore, the phosphorous compound can provide flame retardance and excellent solder heat resistance to a cured photosensitive coverlay film.

Examples of the phosphorous compounds include: phosphine, phosphine oxide, phosphate (including condensed phosphate), and phosphite. In terms of compatibility with the soluble polyimide, the phosphorous compound is preferably phosphine oxide or phosphate (including condensed phosphate). The phosphorous content is preferably 7.0 wt % or more, and more preferably 8.0% or more.

Furthermore, in terms of flame retardance and hydrolysis resistance, the phosphorous compound is preferably phosphate having two or more aromatic rings and represented by the group (VII):

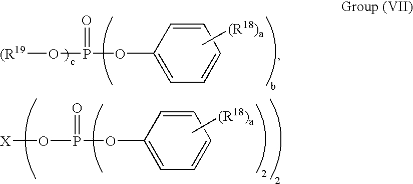

(wherein R¹⁸ is a methyl group, R¹⁹ is an alkyl group, X is a divalent organic group, a is an integer of 0 to 3, b plus c equals 3, and b is an integer of 2 or 3). Such phosphate compound is soluble in alkaline solution, so that it can be developed in alkaline solution when it is used as a material for a photosensitive coverlay film.

Examples of phosphorous compounds having two or more aromatic rings and having a phosphorous content of 5.0 wt % or more are as follows.

For example, the phosphorous compound may be phosphate such as TPP (triphenylphosphate), TCP (tricresylphosphate), TXP (trixylenyl phosphate), CDP (cresyl diphenyl phosphate), and PX-110 (cresyl 2,6-xylenyl phosphate)(all of them are available from Daihachi Chemical Industry Co., Ltd.), non-halogen condensed phosphate such as CR-733S (resorcinol diphosphate), CR-741, CR-747, and PX-200 (all of them are available from Daihachi Chemical Industry Co., Ltd.), (meta)acrylate phosphate such as Biscote V3PA (Osaka Organic Chemical Industry Ltd.) and MR-260 (Daihachi Chemical Industry Co., Ltd.), and phosphate such as triphenylester phosphite.

The phosphorous compound may further contain halogen in one molecule. Therefore, the phosphorous compound may be halogen-containing phosphate such as CLP (tris(2-chloroethyl)phosphate), TMCPP (tris(chloropropyl)phosphate), CRP (tris(dichloropropyl)phosphate), and CR-900 (tris(trybromoneopentyl)phosphate) (all of them are available from Daihachi Chemical Industry Co., Ltd.).

The phosphorous compound component preferably constitutes 5 to 90 wt % of the total amount (soluble polyimide component, compound component having a carbon-carbon double bond, photosensitive initiator component and/or sensitizer component). If the phosphorous compound content is less than 5 wt %, it tends to be difficult to provide flame retardance to the cured coverlay film. On the contrary, if the phosphorous compound content is more than 90 wt %, the cured coverlay film tends to have poor mechanical properties.

An embodiment of the photosensitive resin composition of the present invention is preferably adjusted by adding 5 to 90 wt % of the soluble polyimide, 5 to 90 wt % of the phosphorous compound, 5 to 90 wt % of the compound having a carbon-carbon double bond, and 0.001 to 10 wt % of the photoreaction initiator and/or sensitizer component(s) with respect to the total amount (soluble polyimide, phosphorous compound, compound having a carbon-carbon double bond, and photoreaction initiator component and/or sensitizer component).

Next, as a flame-retardant compound, a halogen-containing compound will be described. The halogen-containing compound can provide flame retardance and high solder heat resistance to the cured photosensitive coverlay film. The compounds containing chlorine or bromine is generally used.

Preferably, the halogen content of the halogen-containing compound component is 15%, and more preferably 20% or more. If the halogen content is less than 15%, it tends to be difficult to provide flame retardance.

The aforementioned halogen-containing compound is at least one kind selected from the group consisting of halogen-containing (meta)acrylic compound, halogen-containing phosphate, and halogen-containing condensed phosphate.

Further, in terms of that a curable reactive group can be contained and that heat resistance and flame retardance can be provided, the halogen-containing compound preferably contains at least one kind selected from the acrylic compounds represented by the group (VIII):

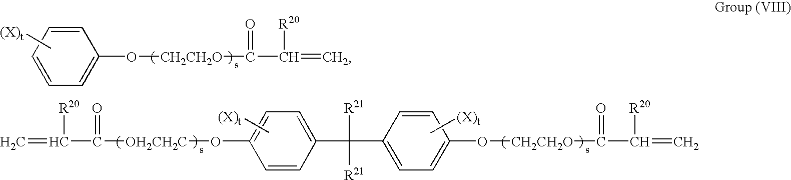

wherein X represents a halogen group, R²⁰ and R²¹ are hydrogen or a methyl group, s is an integer of 0 to 10, t is the same or different and is an integer of 1 to 5).

The halogen content of the halogen-containing compound is preferably 30 wt % or more, more preferably 40 wt % or more, and most preferably 50 wt % or more. In terms of improvement in flame retardance, the more halogen content is more preferable.

As a flame-retardant, the halogen-containing compound may be bromine-type acrylic compound having at least one aromatic ring, at least one carbon-carbon double bond, and at least three bromines in one molecule. In terms of improvement in flame retardance, the more bromine content is more preferable. However, the use of too much halogen compound for a plastic material is not environmentally preferable.

Examples of bromine-type acrylic compounds include: bromine-type monomer such as New Frontier BR-30 (tribromophenyl acrylate), BR-30M (tribromophenyl methacrylate), BR-31 (EO-modified tribromophenyl acrylate), and BR-42M (EO-modified tetrabromobisphenol A dimethacrylate) (all of them are available from Dai-ichi Kogyo Seiyaku Co., Ltd.), brominated aromatic triazine such as Pyroguard SR-245 (Dai-ichi Kogyo Seiyaku Co., Ltd.), brominated aromatic polymer such as Pyroguard SR-250 and SR-400A(Dai-ichi Kogyo Seiyaku Co., Ltd.), and brominated aromatic compound such as Pyroguard SR-990A (Dai-ichi Kogyo Seiyaku Co., Ltd.).

Also, the flame retardant may be a phosphorous compound having a halogen atom in one molecule. An example of such compound is a halogen-containing phosphate such as CLP (tris(2-chloroethyl)phosphate), TMCPP (tris(chloropropyl)phosphate), CRP (tris(dichloropropyl)phosphate), and CR-900 (tris(tribromoneopentyl)phosphate) (all of them are available from Daihachi Chemical Industry Co., Ltd.).

Since a phosphorous compound is occasionally hydrolyzed under pressure and humidity, the combined use of a bromine-containing compound and a phosphorous compound can provide flame retardance and hydrolytic resistance.

The halogen-containing compound component preferably constitutes 5 to 90 wt % of the total amount (soluble polyimide component, compound component having a carbon-carbon double bond, halogen-containing compound, photosensitive initiator component and/or sensitizer component). If the halogen-containing compound content is less than 5 wt %, it tends to be difficult to provide flame retardance to the cured coverlay film. On the contrary, if the halogen-containing compound content is more than 90 wt %, the cured coverlay film tends to have poor mechanical properties.

An embodiment of the photosensitive resin composition of the present invention is preferably adjusted by adding 5 to 90 wt % of the soluble polyimide, 5 to 90 wt % of the halogen-containing compound, 5 to 90 wt % of the compound having a carbon-carbon double bond, and 0.001 to 10 wt % of the photoreaction initiator and/or sensitizer component(s) with respect to the total amount (soluble polyimide component, halogen-containing compound component, compound component having a carbon-carbon double bond, and photoreaction initiator component and/or sensitizer component).

When antimony trioxide and/or antimony pentoxide are added, antimony oxide removes a halogen atom from a flame retardant at thermal decomposition starting temperature of plastic to produce antimony halide. Therefore, flame retardance is synergistically increased. The amount to be added is preferably 1 to 10 wt % of the total amount of the aforementioned components, and more preferably 1 to 6 wt %.

The white powders of antimony trioxide and/or antimony pentoxide are not soluble in an organic solvent. If the powders having a particle size of 100 μm or more are mixed with photosensitive resin composition, the mixture become clouded. Thus, flame retardance can be provided to the resulting photosensitive coverlay film, but transparency and developing properties of the film tend to be deteriorated. For this reason, the particle size of the powder is preferably 100 μm or less. Furthermore, in order to increase flame retardance of the photosensitive coverlay film without losing its transparency, it is preferable to use antimony trioxide and/or antimony pentoxide powders having a particle size of 50 μm or less, more preferably 10 μm or less, and most preferably 5 μm or less.

Commercially available antimony trioxide powders have a particle size of 200 to 1500 μm and are not soluble in an organic solvent. Therefore, if they are mixed with photosensitive resin composition, flame retardance can be provided to the resulting coverlay film, but transparency of the film is lost. On the contrary, if antimony pentoxide powders having a particle size of 2 to 5 μm, flame retardance of the film can be increased without losing its transparency.

Examples of antimony pentoxide having a particle size of 5 to 50 μm are SunEpoch NA-3181 and NA-4800 (Nissan Chemical Industries, Ltd.).

Antimony trioxide and/or antimony pentoxide powders may be mixed with photosensitive resin composition. If the powders are sedimented in the photosensitive resin composition, the powders may be dispersed in an organic solvent, and then mixed with the photosensitive resin composition in a sol state. In order to make powders in the sol state, antimony trioxide and/or antimony pentoxide powders are added to the organic solvent with dispersant so that a network formed thereof prevents the sedimentation of the powders. As the dispersant, a mixture of vapor-phase silica (silicon dioxide) and alumina (alumina trioxide) can be used. Preferably, the dispersant to be added is twice or five times as much by weight as antimony trioxide and/or antimony pentoxide.

Next, phenylsiloxane will be described as a flame-retardant component.

Generally, silicon resin is composed of a combination of trifunctional siloxane unit (T unit), bifunctional siloxane unit (D unit), and tetrafunctional siloxane unit (Q unit). In the present invention, preferable combinations comprise D unit, i.e., a T/D, T/D/Q, or D/Q system. This can provide an excellent flame retardance. Essentially, in any combination, the D unit content is 10 to 95 mol %. If the D unit content is less than 10 mol %, the silicon resin has poor flexibility, so that sufficient flame retardance cannot be provided. If the D unit content is over 95 mol %, dispersibility and compatibility of photosensitive resin composition in the soluble polyimide is reduced, so that appearance, optical transparency, and strength of the polyimide resin composition are deteriorated. More preferably, the D unit content is in a range of 20 to 90 mol %. Therefore, in accordance with the preferable content of the D unit, the content of the T unit is in a range of 5 to 90 mol % in the case of the T/D system. In the T/D/Q or D/Q system, the content of the T unit is 0 to 89.99 mol %, preferably 10 to 79.99 mol %, and the content of the Q unit is 0.01 to 50 mol %. As far as space flexibility is secured, it is more favorable to contain more amount of high oxidative Q unit so as to reproduce flame retardance. However, if the content of Q unit exceeds 60 mol % in siloxane resin, characteristics of inorganic particles become too strong. As the result, the dispersibility in soluble polyimide becomes poor. Therefore, the content of Q unit must be reduced to 60 mol % or less. In view of the aforementioned content range of siloxane unit, flame retardance, workability, and quality of the resultant product, it is further more preferable that the content of the T unit is 1,0 to 80 wt % of the total amount of phenylsiloxane.

Preferable siloxane units are, for example,:

C₆H₅SiO_{3/2} as a trifunctional siloxane unit; and

(C₆H₅)₂SiO_{2/2}, (CH₃)C₆H₅SiO_{2/2}, and (CH₃)₂SiO_{2/2}

as a bifunctional siloxane unit.

In this case, a dimethylsiloxane ((CH₃)₂SiO_{2/2}) unit can be used as a D unit for providing flexibility. This unit is most effectively used to provide flexibility to silicon resin, however, too much of this unit tends to reduce flame retardance, so that it is not desirable to contain too much of this unit. Therefore, the dimethylsiloxane unit is preferably reduced to less than 90 mol % of the total. The most preferable D unit is methylphenyl siloxane ((CH₃)C₆H₅SiO_{2/2}) unit because this unit can not only provide flexibility but also increase phenyl group content. Diphenyl siloxane ((C₆H₅)₂SiO_{2/2}) unit is excellent in maintaining high phenyl group content. However, it has a structure in which bulky phenyl groups are densely placed on one Si, so that too much content of this unit provides a large steric hindrance structure to an organopolysiloxane molecule. This reduces space flexibility of a siloxane skeleton, makes it difficult to overlap aromatic rings, which is required to activate the flame-retardant mechanism by coupling aromatic rings, and thus reduces a flame-retardant effect. Therefore, these three materials may be used as D units in such a manner that they satisfy the above ranges. However, it is preferable to mainly use a methylphenylsiloxane unit.

As far as T, D, and Q units satisfy the aforementioned range and physical properties are not changed, phenylsiloxane may contain a siloxane unit (M unit) represented by

R³⁴R³⁵R³⁶SiO_{3/2}

wherein R³⁴, R³⁵ and R³⁶ represent a phenyl group or an alkyl group having 1 to 4 carbons.

Further, it is preferable that weight-average molecular weight of phenylsiloxane is in a range of 300 to 50,000. If the weight-average molecular weight is less than 300, B-stage photosensitive resin is often seeped out. For this reason, the weight-average molecular weight of this range is not preferable. On the contrary, if the weight-average molecular weight is over 50,000, the solubility in a developing solution is reduced. At the result, developing time becomes longer and workability is reduced. More preferable weight-average molecular weight is in a range of 400 to 30,000.

Such phenyl siloxane can be produced by a known method. For example, phenyl siloxane can be produced by mixing organochlorosilane and/or organoalkoxysilane or partially-hydrolyzed condensate thereof that can form the aforementioned siloxane unit under hydrolytic condensation reaction into a mixed solution of excessive water necessary for hydrolyzing all the hydrolyzable groups (such as chloro groups and alkoxy groups) and organic solvent which can dissolve silane compound (raw material) and organopolysiloxane (to be prepared) and then bringing them into hydrolytic condensation reaction. A desired weight-average molecular weight of olganopolysiloxane can be obtained under control over reaction temperature, reaction time, and a mixing ratio between water and organic solvents. Olganopolysiloxane may be used in the powder state by removing unnecessary organic solvents therefrom.

An example of synthesis of siloxane is shown as follows.

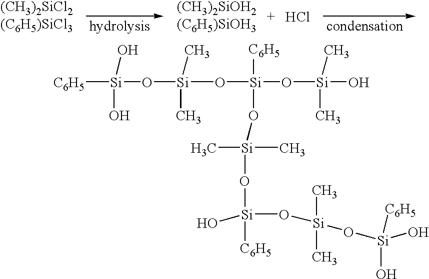

For example, when (CH₃)₂SiCl₂ and C₆H₅SiCl₃ are hydrolyzed and condensed, a compound shown above is produced. (This structure is only one of the examples. Various structures can be synthesized because the numbers of their bonding hands 1 and 3, respectively, and thus they can form various kinds of branch chain, therefore, various variations of olganopolysiloxane can be made.)

Various siloxane can be synthesized by changing reaction ratio of (CH₃)ₐSiCl_{b} and (C₆H₅)_{d}SiClₑ or by changing the numbers of a, b, d, and e. The a, b, d, and e represent an integer of 1 to 3, a+b=4, and d+e=4.

In order to show a relationship between the introduced methyl group and phenyl group by mole percent, a phenyl group content is expressed as follows:

Phenyl group content(%)=number of moles of phenyl groups÷(number of moles of phenyl groups+number of moles of methyl groups)×100

In the above explanation diagram, the content of phenyl group is about 33.3%.

Preferable content of the phenyl group is 10% or more, more preferably 20% or more, and most preferably 25% or more. If the phenyl group content is low, a little flame-retardant effect is produced. Therefore, the phenyl group content is preferably high because more flame-retardant effect is produced as the phenyl content is higher.

Preferably, a phenylsiloxane component constitutes 10 to 300 wt % of all the component having a carbon-carbon double bond. If the phenylsiloxane component is less than 10 wt %, it tends to be difficult to provide flame retardance to the cured coverlay film. On the contrary, if the phenylsiloxane component is over 300 wt %, mechanical properties of the cured coverlay film tends to be poor.

In an embodiment of the photosensitive resin composition of the present invention, it is preferable to add 5 to 90 wt % of the aforementioned soluble polyimide and 5 to 90 wt % of a compound having a carbon-carbon double bond with respect to the total amount (soluble polyimide, compound having a carbon-carbon double bond, photoreactive initiator and/or sensitizer, and phenyl siloxane) and 0.001 to 10 wt % of photoreactive initiator and/or sensitizer and 5 to 90 wt % of a compound containing phenyl siloxane with respect to the total amount (soluble polyimide component, compound component having a carbon-carbon double bond, and phenyl siloxane component).

Thus, a solution of photosensitive resin composition can be obtained. In order to make the solution easier to adhere to a copper foil and to be developed, thermosetting resin such as epoxy resin and acryl resin and thermoplastic resin such as polyester, polyamide, polyurethane, and polycarbonate may be mixed to the solution of photosensitive resin composition.

Alternatively, thermosetting resins other than epoxy resin is preferably mixed so as to obtain excellent physical properties. Examples of thermosetting resins to be used include bismaleimide, bisallylnadiimide, phenol resin, and cyanate resin.

When the photosensitive resin composition of the present invention is used as a dry film resist, the amount of the epoxy resin to be added may be 1 to 10 wt % to the total amount of the aforementioned compositions. This amount of epoxy resin increases an adhesive strength of the resist to a copper foil. If the epoxy resin to be added is less than 1 wt %, the resultant photosensitive dry film resist does not have enough adhesive strength to a copper foil. On the contrary, if the epoxy resin is over 10 wt %, the film tends to be hard and brittle after it is cured. For this reason, less than 1 wt % and more than 10 wt % of epoxy resin are not preferable.

The epoxy resin used herein is not particularly limited as far as it has two epoxy groups in a molecule. Examples of epoxy resin include: bisphenol resins such as Epikote 828 (Yuka Shell Epoxy Co., Ltd.), orthocresol novolak resins such as 180S65 (Yuka Shell Epoxy Co., Ltd.), bisphenol A novolak resins such as 157S70 (Yuka Shell Epoxy Co., Ltd.), trishydroxy phenylmethane novolak resins such as 1032H60 (Yuka Shell Epoxy Co., Ltd.), naphthalene aralkyl novolak resins such as ESN375, and glycidyl amine resins such as tetraphenylol methane 1031S(Yuka Shell Epoxy Co., Ltd.), YGD414S (Toto Kasei KK), trishydroxy phenylmethane EPPN502H (Nippon Kayaku Co., Ltd.), special bisphenol VG3101L (Mitsui Chemicals, Inc.), special naphthol NC7000 (Nippon Kayaku Co., Ltd.), and TETRAD-X and TETRAD-C (Mitsubishi Gas Chemical Company, Inc.).

Also, it is preferable to add 1 to 10 wt % of an epoxy curing agent to an epoxy resin for efficient curing. As an epoxy curing agent, an amine compound such as 4,4′-diaminodiphenylmethane is generally used.

In order to obtain a cured object having good physical properties, it is generally desirable to mix the photosensitive resin composition of the present invention with a curing agent for epoxy resin. As far as the curing agent is for epoxy resin, any curing agent can be used. Examples of curing agents include: amine curing agents, imidazole curing agents, acid anhydride curing agents, and acid curing agents. Also, various coupling agent may be mixed.

The photosensitive composition to be used in the present invention may contain a suitable organic solvent. Where the photosensitive composition is dissolved in a suitable organic solvent, it can be used in a solution (varnish) state, so that it is convenient when it is applied and dried.

The concentration of the photosensitive composition is preferably several wt % to less than 80 wt %. The concentration may vary depending on desired thickness of coating. When a thicker coating is required, the photosensitive composition is adjusted to a higher concentration. On the contrary, when a thinner coating is required, it is adjusted to a lower concentration.

In terms of solubility, preferable solvent is an aprotic solvent. Examples of aprotic solvents include: N-metyl-2-pyrrolidone, N-acetyl-2-pyrrolidone, N-benzil-2-pyrrolidone, N,N-dimethylformamide, N,N-dimethylacetamide, dimethylsulfoxide, hexamethyl phosphoryltriamide, N-acetyl-ε-caprolactam, dimethyl imidazolidinone, diethylene glycol dimethyl ether, triethylene glycol dimethyl ether, γ-butyrolactone, dioxane, dioxolane, tetrahydrofuran, chloroform, and methylene chloride. These solvents can be used alone or in combination. These organic solvents may be a residue of a solvent that is used in the synthesis reaction of polyimide, or may be added to a soluble polyimide after isolation. Further, in order to improve application properties, a solvent such as toluene, xylene, diethyl ketone, methoxybenzene, and cyclopentanone may be mixed to the extent without exerting an adverse effect on the solubility of a polymer.

Thus-obtained solution of photosensitive resin composition is then dried to obtain a film-like photosensitive dry film resist. The solution may be applied to a substrate such as metal or PET, dried, and then peeled off from the substrate to use it as a film. Alternatively, it may be used without being peeled off from the film such as PET. Preferably, this photosensitive resin composition is dried at such a temperature that epoxy or double bond or triple bond is not broken by heat. Specifically, the temperature is preferably 180° C. or less and more preferably 150° C. or less.

By changing the mixing ratios of these components, heat resistance and compression temperature of the photosensitive film can be adjusted.

In this specification, the compression temperature is a temperature required to compress the dry film resist of the present invention on CCL or the like. The compression temperature range varies depending on film material. The compression temperature of a B-stage photosensitive film is preferably 20° C. to 150° C. A photosensitive film that does not have a compression temperature in the above range may cause some problems in use. For example, In the case of a photosensitive film having a compression temperature over the above range, the reaction which is supposed to proceed by the application of light may proceed by heat, or the temperature difference between the compression temperature and constant temperature may be too wide and therefore the film may warp or curl after being cooled due to the difference in coefficient of thermal expansion between the film and an adherend. On the contrary, a photosensitive film having a compression temperature less than the above range must be cooled down. Therefore, condensation is formed on its surface due to temperature differences of the respective processes and condensate may spoil the properties of the film.

When the photosensitive dry film resist is produced, a soluble polyimide component, a compound component having a carbon-carbon double bond, photoreactive initiator and/or sensitizer, a compound component that provides flame retardance, and other additives are uniformly dissolved in an organic solvent.

Any organic solvent can be used, as far as it dissolves a photosensitive resin composition. Examples of organic solvents include: formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-cresol, m-cresol, p-cresol, xylenol, phenol halide, and catechol; ether solvents such as tetrahydrofuran, dioxane, and dioxolane; alcohol solvents such as methanol, ethanol, and butanol; ketone solvents such as acetone and methyl ethyl ketone; cellosolve solvents such as butylcellosolve; hexamethylphosphorylamide; and γ-butyrolactone. These solvents can be used alone or in combination. Since the solvents are removed later, it is advantageous to use solvents that can dissolve a soluble polyimide, compound having a carbon-carbon double bond, photoreactive initiator and/or sensitizer, and compound that provides flame retardance, and that have a boiling point as low as possible.

The photosensitive dry film resist is a photosensitive composition in a semi-cured state(B-stage). It is fluid when it is thermally pressed or laminated and is brought into tight contact to a flexible printed circuit board (FPC) in accordance with projections and depressions of a circuit. The photosensitive dry film resist is so designed that curing is completed by a crosslinking reaction when it is exposed to light and by heat curing applied when it is pressed or after it is pressed.

In general, a flexible printed wiring board is produced by successive steps of applying an adhesive agent to a long film, drying it, and then laminating a copper foil on it. Such production process provides high productivity. However, in such conventional production process, holes or windows would be formed in predetermined portions of a photosensitive cover lay film that correspond to joint parts of terminals or components of a circuit before the laminating step, as described in the Background of the Invention. Since an alignment between the holes of the coverlay film and the joint parts of the terminal or components of the FPC must be carried out almost by hand and a batch of the coverlay film and FPC of small work size must be bonded together, this causes bad workability and positioning accuracy and high production cost.

On the contrary, the photosensitive dry film resist of the present invention can be laminated at a temperature of 150° C. or less, and can be laminated directly on a printed board without using an adhesive agent. The laminating temperature is preferably low. Preferable laminating temperature is 130° C. or less and more preferable laminating temperature is in a range of 20° C. to 110° C.

Further, since the photosensitive dry film resist of the present invention is exposed to light and developed after it is bonded to the FPC, there can be formed holes for bonding to terminals of the FPC. For this reason, positioning accuracy and workability can be improved.

The FPC is soldered to the photosensitive dry film resist by being exposed to a high temperature of 200° C. or more for a few minutes. Therefore, it is preferable that the cured photosensitive dry film resist has higher heat resistance than the FPC. The thermal decomposition starting temperature of the cured photosensitive dry film resist is 300° C. or more, preferably 320° C. or more, and more preferably 340° C. or more.

A conductor layer of the FPC is mainly made of copper. When copper is exposed to a temperature of more than 200° C., a crystal structure of the copper is gradually changed and its strength is reduced. Therefore, it is necessary to set a curing temperature to 200° C. or less.

The photosensitive dry film resist of the present invention has a thickness of 10 to 50 μm, preferably 20 to 40 μm. If the photosensitive dry film resist is too thin, the projections and depressions made of the copper circuit and polyimide film (base film) are not embedded in the flexible printed wiring board, so that the surface of the film after being bonded does not become flattened. On the contrary, if the photosensitive dry film resist is too thick, a micropattern is hard to develop and a sample board is easy to warp. For this reason, too thick dry film resist is not preferable.

The photosensitive dry film resist can be a single-layer film of the aforementioned photosensitive resin composition.

Alternatively, the photosensitive dry film resist can be a two-layer film obtained by applying liquid photosensitive resin composition to a base material such as polyethylene terephthalate film and then removing a solvent by heating and/or hot air blowing.

A preferable base material is the one that is brought into tight contact with a B-stage photosensitive dry film resist. Among them, a preferable base material is a surface-treated base material that can be easily peeled off from the base material when a crosslinking reaction starts by exposure to light.

As a base material, there can be used various commercially available film such as polyethylene terephthalate (hereinafter referred to as PET) film, polyphenylene sulfide, and polyimide film. Further, bonded surfaces of the base material and the photosensitive film are preferably surface-treated so as to easily peel them off. A particularly preferable base material is a PET film because the PET film is relatively cheap, easily available, and has a sufficient heat resistance.

A protective film is laminated on the photosensitive dry film resist on the base material at a room temperature.

Further, the photosensitive dry film obtained by applying a photosensitive resin composition to a base material resist is preferably a three-layer structure by laminating a protective film such as polyethylene film on the photosensitive dry film resist. The protective film can prevent adhesion of dust in the air to the dry film resist and deterioration of the photosensitive dry film resist due to drying.

In general, polyethylene film is used as a protective film because it is cheap and releasable. Particularly, it is preferable to use a film having good adhesion to a photosensitive dry film resist and good releasability.

A typical protective film is a laminated film composed of “copolymer film of polyethylene and ethylenevinyl alcohol (hereinafter referred to as (PE+EVA) copolymer film)” and “oriented polyethylene film (hereinafter referred to as OPE film” or a film (having a PE film surface and (PE+EVA) copolymer film surface) produced by simultaneously extruding copolymer of polyethylene and vinyl alcohol resin” and “polyethylene”, and the (PE+EVA) copolymer film surface is bonded to the photosensitive dry film resist.

There are two methods for producing a protective film. In one of the method, a protective film is produced by bonding two kinds of films together, and in the other method, a protective film is produced by simultaneously extruding two kinds of resins.

In the former method, a (PE+EVA) copolymer film and an OPE film are bonded together. Alternatively, an ethylene vinyl alcohol resin film and an OPE film may be bonded together. Generally, bonded surfaces of these films are slightly coated with adhesive agent. Preferably, a bonded surface of the (PE+EVA) copolymer film that is bonded to the OPE film is subjected to easy adhesion treatment such as corona treatment.

In the latter method, a polyethylene resin and a copolymer resin of polyethylene and ethylene vinyl alcohol are simultaneously extruded into a film. Using this method, a film whose one surface is PE film and whose other surface is (PE+EVA) copolymer film is produced.

Preferably, this (PE+EVA) copolymer film does not contain any additives such as lubricant and static stopper. Since the (PE+EVA) copolymer film is in direct contact with the photosensitive dry film resist, if additives bleed out from the protective film and is transferred to the photosensitive dry film resist, adhesion between the photosensitive dry film resist and CCL may be degraded. Therefore, due consideration must be given to the aforementioned matters when additives are used in a protective film and when the film is surface treated.

The (PE+EVA) copolymer film is preferably thin. In terms of handling, preferable thickness of the film is 2 to 50 μm. This (PE+EVA) copolymer film has good adhesion to the photosensitive film, can prevent, for example, the deterioration of the film due to drying, and can be easily peeled off when the photosensitive dry film resist is used.

The OPE film to be used as a protective film is bonded to the (PE+EVA) copolymer film as a reinforcing material. The thickness of the OPE film is preferably 10 to 50 μm. If the OPE film is too thin, it tends to get wrinkled. Particularly preferable thickness of the OPE film is 10 to 30 μm. One of the reasons for preferably using this OPE film is because it makes a rolled sheet smooth.

Various methods can be used for bonding the (PE+EVA) copolymer film and the OPE film together. Generally, an adhesive agent is slightly applied to the OPE film and dried, and then the bonding surface of the OPE film and the corona-treated surface of the (PE+EVA) copolymer film are laminated with a heated roll. The adhesive agent is not particularly limited. Any commercially available adhesive agent can be used. Particularly, polyurethane adhesive agent is effectively used.

When the protective film is produced by extrusion, the thicknesses of the (PE+EVA) copolymer film and PE film can be adjusted by the amounts of a copolymer resin of polyethylene and ethylene vinyl alcohol and a polyethylene resin. In this case, the thicknesses of the (PE+EVA) copolymer film and PE film are preferably 2 to 50 μm and 10 to 50 μm, respectively, for the same reason as described above.

Next, an example of the use of the photosensitive dry film resist will be described.

There will be described a step of bonding the photosensitive dry film resist and FPC (flexible printed circuit board). In this step, a conductive surface of the FPC on which a circuit is previously formed of an electric conductor such as copper foil is protected with a photosensitive dry film resist. Specifically, the FPC and the photosensitive dry film resist are bonded together by thermally laminating, heat-pressing, or thermally laminating them under vacuum. It is preferable that this step is carried out at a temperature at which epoxy, double bond, or triple bond is not broken. Specifically, preferable temperature is 180° C. or less, preferably 150° C. or less, and more preferably 130° C. or less.

The coverlay for a flexible printed wiring board may be a three-layer sheet composed of the aforementioned substrate, photosensitive dry film resist, and protective film.

When a coverlay for a flexible printed wiring board is produced using a three-layer sheet of the present invention, a flexible printed wiring board with a circuit formed thereon and a photosensitive dry film resist are laminated by heat after a protective film is removed. By thermally laminating a the photosensitive dry film resist of a two layer structure and the flexible wiring board with a circuit formed thereon, a flexible printed wiring board which is adhesively coated with the photosensitive dry film resist is produced. If the laminating temperature is too high, photosensitive parts are crosslinked and thereby the film is cured. Such cured film does not act as a photosensitive coverlay. Therefore, it is preferable that the laminating temperature is low. Specifically, the laminating temperature is preferably 60° C. to 150° C., and more preferably 80° C. to 120° C. If the laminating temperature is too low, flowability of the photosensitive dry film resist is deteriorated. This makes it difficult to coat a fine circuit on the flexible printed wiring board and causes the deterioration of its adhesion.

In this way, the photosensitive dry film resist is laminated on the flexible printed wiring board, and the base material is laminated on the photosensitive dry film resist. The base material may be peeled off after the laminating step is completed or after the exposing step is completed. In terms of protection of the photosensitive dry film resist, it is preferable that the base material may be peeled off after it is exposed to light under a photomask pattern.

The photosensitive dry film resist is bonded onto the circuit on the flexible printed wiring board and then exposed to light such as ultraviolet light. After that, it is cured by heat, and thus a coverlay film for electrically isolating the circuit is produced.

A photoreactive initiator contained in the photosensitive dry film resist of the present invention normally absorbs light of a wavelength of 450 nm or less. Therefore, it is preferable to use a light source that radiates light of a wavelength of 300 to 430 nm.

Where the photosensitive dry film resist of the present invention is used as a photosensitive coverlay for a flexible printed wiring board, after the dry film is bonded to the flexible printed wiring board, holes can be formed at predetermined positions thereof by being exposed to light under a photomask pattern and developed.

After this dry film resist is exposed to light through a certain patterned photomask, an unexposed part is removed using a basic solution so as to obtain a desired pattern. This developing step may be carried out using an ordinal positive type photoresist developing machine.

Any basic solution or organic solvent can be used as a developing solution. A solvent for dissolving a basic compound may be water or an organic solvent. The basic solution may be a solution containing one kind of compound or more kinds of compounds.

In order to improve solubility of polyimide, the developing solution may further contain a water-soluble organic solvent such as methanol, ethanol, propanol, isopropyl alcohol, isobutanol, N-methyl-2-pyrrolidone, N,N-dimethylformamide, and N,N-dimethylacetamide, or may contain two or more kinds of solvents. The basic compound may be one kind of compound or two or more kinds of compounds.

The basic solution is generally prepared by dissolving a basic compound in water. The concentration of the basic compound is generally 0.1 to 50 wt %, and preferably 0.1 to 30 wt % in consideration of effects on a support substrate. In order to improve solubility of polyimide, the developing solution may partially contain a water-soluble organic solvent such as methanol, ethanol, propanol, isopropyl alcohol, N-methyl-2-pyrrolidone, N,N-dimethylformamide, and N,N-dimethylacetamide.

The basic compound may be one kind of compound or two or more kinds of compounds. The concentration of the basic compound is generally 0.1 to 10 wt %, but preferably 0.1 to 5 wt % in consideration of effects on the film. Examples of the aforementioned basic compounds may include hydroxide or carbonate of alkali metals, alkaline earth or ammonium ion, and amine compounds.

Examples of the aforementioned basic compounds include hydroxide or carbonate of alkali metal, alkaline earth metal, or ammonium ion, and amine compound. More specifically, examples of preferable basic compounds include: 2-dimethylaminoethanol, 3-dimethylamino-1-propanol, 4-dimethylamino-1-butanol, 5-dimethylamino-1-pentanol, 6-dimethylaino-1-hexanol, 2-dimethylamino-2-methyl-1-propanol, 3-dimethylamino-2,2-dimethyl-1-propanol, 2-diethylaminosthanol, 3-diethylamino-1-propanol, 2-diisopropylaminoethanol, 2-di-n-butylaminoethanol, N,N-dibenzyl-2-aminoethanol, 2-(2-dimethylaminoethoxy)ethanol, 2-(2-diethylaminoethoxy)ethanol, 1-dimethylamino-2-propanol, 1-diethylamino-2-propanol, N-methyldiethanolamine, N-ethyldiethanolamine, N-n-butyldiethanolamine, N-t-butyldiethanolamine, N-lauryldiethanolamine, 3-diethylamino-1,2-propanediol, triethanolamine, triisopropanolamine, N-methylethanolamine, N-ethylethanolamine, N-n-butylethanolamine, N-t-butylethanolamine, diethanolamine, diisopropanolamine, 2-aminoethanol, 3-amino-1-propanol, 4-amino-1-butanol, 6-amino-1-hexanol, 1-amino-2-propanol, 2-amino-2,2-dimethyl-1-propanol, 1-aminobutanol, 2-amino-1-butanol, N-(2-aminoethyl)ethanolamine, 2-amino-2-methyl-1,3-propanediol, 2-amino-2-ethyl-1,3-propanediol, 3-amino-1,2-propanediol, 2-amino-2-hydroxymethyl-1,3-propanediol, sodium hydroxide, potassium hydroxide, ammonium hydroxide, sodium carbonate, potassium carbonate, ammonium carbonate, sodium hydrogencarbonate, potassium hydrogencarbonate, amonium hydrogencarbonate, tetramethyl ammonium hydroxide, tetraethylammonium hydroxide, tetrapropylamonium hydroxide, tetraisopropylammonium hydroxide, aminomethanol, 2-aminoethanol, 3-aminopropanol, 2-aminopropanol, methylamine, ethylamine, propylamine, isopropylamine, dimethylamine, diethylamine, dipropylamine, diisopropylamine, trimethylamine, triethylamine, tripropylamine, or triisopropylamine. Any basic compound can be used as far as it is soluble in water or alcohol and a solution thereof exhibits basicity.

The pattern formed by development is washed with a rinse solution and then a developer is removed. Examples of preferable rinse solution include methanol, ethanol, isopropyl alcohol, and water which are miscible with a developing solution.

By heating the above pattern at a temperature of 20° C. to 200° C., a high-resolution polyimide resin pattern of the present invention can be obtained. This resin pattern has a high heat resistance and excellent mechanical properties.

Thus, using the photosensitive dry film resist of the present invention, a coverlay for an FPC can be produced.

Since the photosensitive dry film resist of the present invention has polyimide as main component, it has an excellent electrical isolation, heat resistance, and mechanical properties. For this reason, the photosensitive dry film resist of the present invention can be suitably used for a photosensitive coverlay film for a hard disk head of a personal computer.

### EXAMPLES

The present invention will be more concretely described by referring to the examples which follow. These examples should not be construed to limit the invention in any way. In Examples, ESDA represents 2,2-bis(4-hydroxyphenyl)propane dibenzoate-3,3′,4,4′-tetracarboxylic dianhydride, BAPS-M represents bis[4-(3-aminophenoxy)phenyl]sulfone, DMAc represents N,N-dimethylacetamide, and DMF represents N,N-dimethylformamide.

Weight changes were measured using TG/DTA220 Thenmogravimetric Differential Thermal Analyzer (Seiko Instruments Inc.) in a temperature range from room temperature to 500° C. at a temperature increase rate of 10° C./min. in the air. A temperature where a weight decrease ratio was 5% was determined as a thermal decomposition starting temperature.

The elastic coefficient was measured in accordance with the Japanese Industrial Standard C 2318.

The peel adhesive strength was measured in accordance with peel strength (90°) in the Japanese Industrial Standard C 6481. The width was measured at the width of 3 mm and converted into 1 cm.

The weight-average molecular weight was measured with a GPC produced by Waters Corporation under the following conditions:

Column: 2 pieces of KD-806M (produced by Shodex)

Temperature: 60° C.

Detector: R¹ (Refractive Index)

Flow rate: 1 ml/minute

Developer: Dimethylformamide (DMF: lithium bromide 0.03M, phosphoric acid 0.03M)

Concentration of test specimen solution: 0.2% by weight

Injection amount: 20 μl

Reference material: polyethylene oxide

Measurement of imidization ratio was performed as follows:

(1) A polyamic acid solution (DMF solution) was cast on a poly(ethylene terephthalate) film (PET film), dried by heating at 100° C. for 10 minutes and 130° C. for 10 minutes, peeled off from the PET film, fixed to a pin frame, and further heated at 150° C. for 60 minutes, 200° C. for 60 minutes, and 250° C. for 60 minutes. Then, a polyimide film with a thickness of 5 μm was obtained.

(2)Polyimide prepared in the examples and the comparative examples was dissolved in DMF and cast on a PET film, peeled off from the PET film after drying by heating at 100° C. for 30 minutes, fixed to a pin frame, and dried by heating at 80° C. for 12 hours under the pressure of 5 mmHg in a vacuum laminater. Then, a polyimide film with a thickness of 5 μm was obtained. Infrared radiation (IR) of respective films was measured to determine the ratio of imide absorbance/absorbance of benzene ring. Imidization ratio was obtained by determining the percentage of the absorbance in (2)(imide/benzene ring) when the absorbance (imide/benzene ring) obtained in (1) was 100% imidization ratio. This ratio is used as “imidization ratio”.

COOH equivalent amount (carboxylic acid equivalent amount) means average molecular weight per COOH.

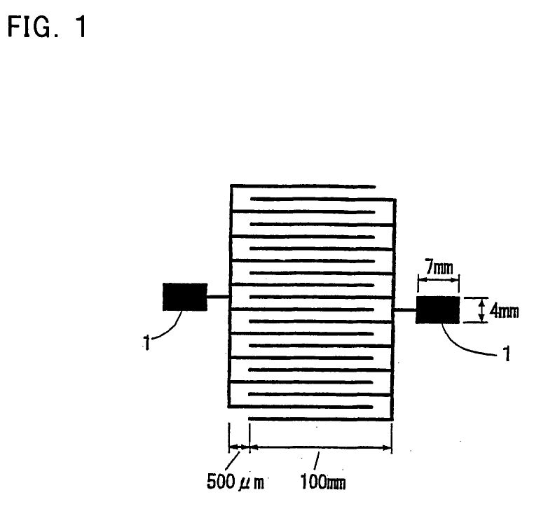

For measurement of insulation resistance, a copper foil of a flexible copper-clad laminate (a double copper-clad laminate in which a copper foil was formed on both sides of a polyimide resin) SC18-25-00WE produced by Nippon Steel Chemical Group was removed from only its side by etching to obtain a one-side flexible copper-clad laminate. A comb-shaped pattern was formed on this side. A photosensitive film wherein a protective film was peeled off was laminated on this comb-shaped pattern under the condition of 100° C. and 20,000 Pain, exposed in the range of 400 nm at 1,800 mJ/cm², and heated at 180° C. for 2 hours so that a cover lay film was laminated on it. The laminate with cover (lay) film was conditioned its moisture under an atmosphere of 20° C., 65% RH for 24 hours. Line insulation resistance was measured under an atmosphere of. 20° C., 65% RH. A digital ultra-high resistance R¹²⁷⁰⁶A produced by Advantest was used as a measuring device. Electrode terminals of a cover lay film-like laminate (Code 1 in FIG. 1) whose width was adjusted to the width of a test sample box (test fixture R¹²⁷⁰⁶A produced by Advantest) were secured to terminals of a test socket and the lid of the sample box was shut to obtain a resistivity 1 minute after the application of DC 500V as line insulation resistance. FIG. 1 shows a comb-shaped pattern having a line/space=100 μm.

In the following Examples 1 to 4 and Comparative Examples 1 and 2, a photosensitive resin composition and a cover lay film, and a flexible printed board were prepared with a soluble polyimide and measured peel strength, elastic coefficient, elongation, thermal decomposition starting temperature, and insulation resistance.

### Example 1

8.60 g (0.02 mole) of BAPS-M, 16.6 g of KF8010, a product of Shin-Etsu Chemical Co., Ltd. used as siloxane diamine (in the above-mentioned general formula (2), i=3, h=9, R¹¹=CH₃), 200 g of DMF, and 57.65 g (0.10 mole) of ESDA were placed in a 2,000 ml-separable flask equipped with a stirrer to be vigorously stirred and the stirring was continued for 30 minutes. 17.2 g (0.06 mole) of bis(4-amino-3-carboxy-phenyl)methane was dissolved in 75 g of DMF and added to the above-mentioned solution to be stirred for 30 minutes. Then, a polyamic acid solution was obtained. The weight-average molecular weight (hereinafter referred to as Mw) of the polyamic acid was 60,000.

The polyamic acid solution was placed in a butt coated with fluorocarbon resin and successively heated with a vacuum laminater at 150° C. for 10 minutes, 160° C. for 10 minutes, 170° C. for 10 minutes, 180° C. for 10 minutes, 190° C. for 10 minutes, and 210° C. for 30 minutes under reduced pressure while maintaining the pressure of 5 mmHg.

The polyimide was taken out of the vacuum laminater and 96 g of soluble polyimide with carboxylic acid was obtained. The Mw of the polyimide was 62,000 and the imidization ratio was 100% (COOH equivalent amount was 804).

<Synthesis of Epoxy-Modified Polyimide>

33 g of polyimide synthesized in the above-mentioned was dissolved in 66 g of dioxolane, and 6.4 g (45 milli mole) of glycidyl methacrylate and 0.1 g of triethylamine were added, and heated with stirring at 70° C. for 2 hours. An epoxy-modified polyimide was synthesized.

0.5 g (1.2 milli mole) of bis(2,4,6-trimethyl-benzoil)-phenylphosphine oxide and 25 g of ABE-30 (Bisphenol A EO modified (n≈0.30) diacrylate) as photoreaction initiators, and 10 mg of methoxyphenol as a copolymerization inhibitor were added to 100 g of epoxy-modified polyimide solution to be applied onto a PET film with a thickness of 25 μm. A double-layer photosensitive polyimide film with a thickness of 38 μm/25 μm was obtained by drying at 45° C. for 5 minutes and 65° C. for 5 minutes.

A copper foil (1 once of 3EC-VLP produced by Mitsui Mining & Smelting Co., Ltd.), a photosensitive polyimide film with a thickness of 38 μm, and a PET film with a thickness of 25 μm were laminated in order by heating at 100° C. under the condition of 100 N/cm. After laminating, this laminate was exposed to light for 3 minutes (Exposure conditions: light at 400 nm, 10 mJ/cm²) and post-baked at 100° C. for 3 minutes after the peeling off of the PET film and heated at 180° C. for 2 hours to be cured.

The peel adhesive strength of this flexible copper-clad plate was 11.8 N/cm (1.2 Kg weight/cm), which enabled to form patterns with line/space of 100 μm. In addition, no defects such as swelling were found even after this flexible plate was soaked in a solder bath at 260° C. for 1 minute.

The elastic coefficient of the residual cover lay film after curing obtained by removing the copper foil of the flexible copper-clad plate by etching was 1,000 N/mm², the elongation was 25%, and the thermal decomposition starting temperature was 370° C.

A comb-shaped pattern having a line/space=100/100 μm (FIG. 1) was prepared by etching the copper foil of the above-mentioned flexible copper-clad plate (Configuration of photosensitive polyimide/copper foil). A PET film with a thickness of 25 μm was overlaid on a photosensitive polyimide film with a thickness of 38 μm so that this plate might be coated with a pattern of copper foil to be laminated by heating at 100° C. under the condition of 100 N/cm. After laminating, this laminate was exposed to light for 3 minutes (Exposure conditions: light at 400 nm, 10 mJ/cm²) and post-baked at 100° C. for 3 minutes after the peeling off of the PET film to be cured by heating at 180° C. for 2 hours (Flexible printed board with a configuration of overlaying the photosensitive polyimide/copper foil/photosensitive polyimide). The resistivity (insulation resistance) was measured 1 minute after the application of DC 500V after the conditioning of the flexible printed board under the following conditions:

(1) Normal condition: 24 hours after moisture conditioning at 20° C./65% RH=9×10^{15 Ω}

(2) Moisture: 24 hours after moisture conditioning at 35° C./85% RH=3×10^{15 Ω}

A copper foil, a photosensitive polyimide film with a thickness of 38 μm, and a PET film with a thickness of 25 μm were overlaid to be laminated by heating at 100° C. under the condition of 100 N/cm. After laminating, photo-masks of line/space=100/100 μm were placed on this laminate to be exposed to light for 3 minutes (Exposure conditions: light at 400 nm, 10 mJ/cm²) and post-baked at 100° C. for 3 minutes after the peeling off of the PET film and heated at 180° C. for 2 hours to be cured after being developed by using a water solution of 1% KOH (at liquid temperature of 40° C.). Patterns of line/space=100/100 μm on this photosensitive cover lay film were observed with a microscope.

### Example 2

0.5 g (1.2 milli mole) of bis(2,4,6-trimethyl-benzoil)-phenylphosphine oxide, 5 g of Aronix M-208 produced by Toagosei Co., Ltd. (Bisphenol F EO modified (n≈0.2) diacrylate), 20 g of ABE-30 produced by Shin-Nakamura Chemicals Co., Ltd. (Bisphenol A EO modified (n-0.30) diacrylate), and 10 mg of methoxyphenol as a copolymerization inhibitor were added to 100 g of epoxy-modified polyimide solution synthesized in Example 1 to be applied onto a PET film with a thickness of 25 μm. A double-layer film consisting of a photosensitive polyimide film with a thickness of 38 μm and a PET film with a thickness of 25 μm was obtained by drying at 45° C. for 5 minutes, peeling off the PET film, fixed to a pin frame and heated at 65° C. for 5 minutes.

As well as Example 1, the adhesive strength of this flexible copper-clad plate was 10.8 N/cm (1.1 Kg weight/cm), which enabled to form patterns with line/space of 100 μm. In addition, no defects such as swelling were found even after this flexible plate was soaked in a solder bath at 260° C. for 1 minute. The elastic coefficient of the residual photosensitive polyimide after curing obtained by removing the copper foil of the flexible copper-clad plate through etching was 1,500 N/mm², the elongation was 20%, and the thermal decomposition starting temperature was 375° C.

A flexible printed board was prepared in the same manner as in Example 1 and insulation resistance 24 hours after moisture conditioning was measured.

(1) Normal condition: 24 hours after moisture conditioning at 20° C./65% RH=8×10^{15 Ω}

(2) Moisture: 24 hours after moisture conditioning at 35° C./85% RH=3×10^{15 Ω}

A copper foil, a photosensitive polyimide film with a thickness of 38 μm, and a PET film with a thickness of 25 μm were overlaid in order to be laminated by heating at 100° C. under the condition of 100 N/cm. After laminating, photo-masks of line/space=100/100 μm were placed on this laminate to be exposed to light for 3 minutes (Exposure conditions: light at 400 nm, 10 mJ/cm²) and post-baked at 100° C. for 3 minutes after the peeling off of the PET film and heated at 180° C. for 2 hours after being developed using a water solution of 1% KOH (at liquid temperature of 40° C.) to be cured. Patterns of line/space=100/100 μm on this photosensitive cover lay film were observed with a microscope.

### Example 3

8.61 g (0.02 mole) of BAPS-M, 260 g of DMF, and 57.65 g (0.10 mole) of ESDA were placed in a 2,000 ml-separable flask equipped with a stirrer to be vigorously stirred and the stirring was continued for 30 minutes. 24.9 g (0.03 mole) of KF8010, silicone diamine produced by Shin-Etsu Chemical Co., Ltd. was added to the above-mentioned solution to be stirred for 30 minutes and added 9.81 g (0.05 mole) of 2,5-diaminoterephthalic acid, then polyamic acid solution was obtained. The Mw of this polyamic acid was 53,000. And then cooling was achieved with iced water to afford reaction. This polyamic acid solution was placed in a butt coated with fluorocarbon resin and successively heated with a vacuum laminater at 150° C. for 10 minutes, 160° C. for 10 minutes, 170° C. for 10 minutes, 180° C. for 10 minutes, 190° C. for 10 minutes, and 210° C. for 30 minutes under reduced pressure while maintaining the pressure of 5 mmHg. The polyimide was taken out of the vacuum laminater and 105 g of thermoplastic polyimide with hydroxy group was obtained. The Mw of the polyimide having 60,000 and the imidization ratio was 100% (COOH equivalent amount was 974).

<Synthesis of Epoxy-Modified Polyimide>

33 g of polyimide synthesized in the above-mentioned was dissolved in 66 g of dioxolane, and 15.2 g (40 milli mole) of bisphenol epoxy resin produced by Shell Oil Co., Ltd. and 0.1 g of triethylamine were added. Stirring was conducted by heating at 70° C. for 2 hours to synthesize an epoxy-modified polyimide.

0.3 g of 4,4′-bis(diethylamino) benzophenone, 1.0 g of BTTB produced by NOF Corporation (25% toluene solution), 20 g of ABE-30 produced by Shin-Nakamura Chemicals Co., Ltd. (Bisphenol A EO modified (n≈0.30) diacrylate), 5 g of ABE-10 produced by Shin-Nakamura Chemicals Co., Ltd. (Bisphenol A EO modified (n≈0.10) diacrylate), and 10 mg of methoxyphenol as a copolymerization inhibitor were added to 100 g of epoxy-modified polyimide solution to prepare a photosensitive composition. This solution was applied onto a PET film with a thickness of 25 μm. A double-layer film consisting of a photosensitive polyimide film with a thickness of 38 μm and a PET film with a thickness of 25 μm was obtained by drying at 45° C. for 5 minutes, peeling off the PET film, fixing to a pin frame, and drying at 65° C. for 5 minutes.

As well as Example 1, the adhesive strength of this flexible copper-clad plate was 10 N/cm (1.02 Kg weight/cm), which enabled to form patterns with line/space of 100 μm. In addition no defects such as swelling were found even after this flexible plate was soaked in a solder bath at 260° C. for 1 minute. The elastic coefficient of the residual photosensitive polyimide after curing obtained by removing the copper foil of the flexible copper-clad plate through etching was 1,250/mm², the elongation was 25%, and the thermal decomposition starting temperature was 380° C.

A flexible printed board was prepared in the same manner as in Example 1 and insulation resistance 24 hours after moisture conditioning was measured.

(1) Normal condition: 24 hours after moisture conditioning at 20° C./65% RH=7×10^{15 Ω}

(2) Moisture: 24 hours after moisture conditioning at 35° C./85% RH=1×10^{15 Ω}

A copper foil, a photosensitive polyimide film with a thickness of 38 μm, and a PET film with a thickness of 25 μm were overlaid in order to be laminated by heating at 100° C. under the condition of 100 N/cm. After laminating, photo-masks of line/space=100/100 μm were placed on this laminate to be exposed to light for 3 minutes (Exposure conditions: light at 400 nm, 10 mJ/cm²) and post-baked at 100° C. for 3 minutes after the peeling off of the PET film and heated at 180° C. for 2 hours after being developed to be cured using a water solution of 1% KOH (at liquid temperature of 40° C.). Patterns of line/space=100/100 μm on this photosensitive cover lay film were observed with a microscope.

### Example 4

A polyamic acid solution was obtained in the same manner as in Example 1 except for the following component ratio of soluble polyimide: 17.20 g (0.04 mole) of BAPS-M, 24.9 g (0.03 mole) of siloxane diamine KF8010, a product of Shin-Etsu Chemical Co., Ltd. (in the above-mentioned general formula (2), i=3, h=9, R¹¹=CH₃), 57.65 g (0.10 mole) of ESDA, and 8.6 g (0.03 mole) of bis(4-amino-3-carboxy-phenyl)methane. The Mw of the obtained polyamic acid was 59,000. Similarly, polyamic acid was imidized to obtain 104 g of soluble polyimide (COOH equivalent amount: 1746).

<Synthesis of Epoxy-Modified Polyimide>

33 g of polyimide synthesized in the above-mentioned was dissolved in 66 g of dioxolane, and 3.6 g (25 milli mole) of glycidyl methacrylate and 0.1 g of triethylamine were added. Stirring was conducted by heating at 70° C. for 2 hours to synthesize an epoxy-modified polyimide.

A double-layer film consisting of a photosensitive polyimide film and a PET film was prepared in the same manner as in Example 1 and a flexible copper-clad plate was prepared in the same manner as in Example 1.

The peel adhesive strength of this flexible copper-clad plate was 11.8 N/cm (1.2 Kg weight/cm), which enabled to form patterns with line/space of 100 μm. In addition, no defects such as swelling were found even after this flexible plate was soaked in a solder bath at 260° C. for 1 minute.

The elastic coefficient of the residual cover lay film after curing obtained by removing the copper foil of the flexible copper-clad plate through etching was 1,000 N/mm², the elongation was 25%, and the thermal decomposition starting temperature was 370° C.

A flexible printed board was prepared in the same manner as in Example 1 and insulation resistance 24 hours after moisture conditioning was measured.

(1) Normal condition: 24 hours after moisture conditioning at 20° C./65% RH=6×10^{15 Ω}

(2) Moisture: 24 hours after moisture conditioning at 35° C./85% RH=2×10^{15 Ω}

A copper foil, a photosensitive polyimide film with a thickness of 60 μm, and a PET film with a thickness of 25 μm were overlaid in order to be laminated by heating at 100° C. under the condition of 100 N/cm. After laminating, photo-masks of line/space=100/100 μm were placed on this laminate to be exposed to light for 3 minutes (Exposure conditions: light at 400 nm, 10 mJ/cm²) and post-baked at 100° C. for 3 minutes after the peeling off of the PET film and heated at 180° C. for 2 hours after being developed to be cured using a solution of isopropyl alcohol of 0.5% of tetramethylhydroxide/water=weight ratio of 50/50 (at liquid temperature of 40° C.). Patterns of line/space=100/100 μm on this photosensitive cover lay film were observed with a microscope.

### Comparative Example 1

A polyamic acid solution was obtained in the same manner as in Example 1 except for the following component ratio of soluble imide: 17.22 g (0.04 mole) of BAPS-M, 24.9 g (0.03 mole) of siloxane diamine KF8010; a product of Shin-Etsu Chemical Co., Ltd. (in the above-mentioned general formula (2), i=3, h=9, R¹¹=CH₃), 57.65 g (0.10 mole) of ESDA, and 4.56 g (0.03 mole) of 3,5-diamino benzoic acid. The Mw of the obtained amic acid was 59,000. Similarly, amic acid was imidized to obtain 99 g of soluble polyimide (COOH equivalent amount: 3358).

<Synthesis of Epoxy-Modified Polyimide>

33 g of polyimide synthesized in the above-mentioned was dissolved in 66 g of dioxolane, and 1.4 g (10 milli mole) of glycidyl methacrylate and 0.1 g of triethylamine were added. Stirring was conducted by heating at 70° C. for 2 hours to synthesize an epoxy-modified polyimide.

A double-layer film consisting of a photosensitive polyimide film and a PET film was prepared in the same manner as in Example 1 and a flexible copper-clad plate was prepared in the same manner as in Example 1.

The peel adhesive strength of this flexible copper-clad plate was 11.8 N/an (1.2 Kg weight/cm). In addition, no defects such as swelling were found even after this flexible plate was soaked into a solder bath at 260° C. for 1 minute.

The elastic coefficient of the residual cover lay film after curing obtained by removing the copper foil of the flexible copper-clad plate through etching was 1,000 N/mm², the elongation was 25%, and the thermal decomposition starting temperature was 370° C.

A flexible printed board was prepared in the same manner as in Example 1 and insulation resistance 24 hours after moisture conditioning was measured.

(1) Normal condition: 24 hours after moisture conditioning at 20° C./65% RH=7×10¹⁵ Ω

(2) Moisture: 24 hours after moisture conditioning at 35° C./85% RH=2×10¹⁵ Ω

A copper foil, a photosensitive polyimide film with a thickness of 60 μm, and a PET film with a thickness of 25 μm were overlaid in order to be laminated by heating at 100° C. under the condition of 100N/an. After laminating, photo-masks of line/space=100/100 μm were placed on this laminate to be exposed to light for 3 minutes (Exposure conditions: light at 400 nm 10 mJ/cm²) and post-baked at 100° C. for 3 minutes after the peeling off of the PET film to be developed using a water solution of 1% of KOH solution (at liquid temperature of 40° C.). Patterns were not, however, drawn because unexposed part was insoluble.

### Comparative Example 2

A polyimide film Apical 25NPI (25 μm) produced by Kaneka Corporation, Piralux LFO 100, and a copper foil (1 once of 3EC-VLP produced by Mitsui Mining & Smelting Co., Ltd.) were overlaid in order and were pressed by heating at 180° C. for an hour to obtain a flexible copper-clad plate. A comb-shaped pattern having a line/space=100/100 μm (FIG. 1) was prepared by etching this flexible-copper clad plate. A flexible printed board with cover lay adhered was obtained by overlaying Piralux LFO 100 and Apical 25NPI in order onto this (Configuration of overlaying NPI, Piralux, a copper foil, and NPI in order).

The resistivity (insulation resistance) was measured 1 minute after the application of DC 500V after the moisture conditioning of the flexible printed board under the following conditions:

(1) Normal condition: 24 hours after moisture conditioning at 20° C./65% RH=1×10^{12 Ω}

(2) Moisture: 24 hours after moisture conditioning at 35° C./85% RH=5×10⁹ Ω

In the following Examples 5 to 8 and Comparative Examples 3 and 4, a photosensitive dry film resist using soluble polyimide, epoxy-modified polyimide, and a three-layer structure sheet were prepared to evaluate the photosensitive dry film resist in alkali developing properties and the ratio of residual film or the like.

(1) Preparation of Photosensitive Dry Film Resist

After the dissolution of soluble polyimide resin in organic solvent to a degree that the solid content of the polyimide resin could be 30% by weight, an acrylate resin and a photoreaction initiator were mixed to prepare a varnish of a photosensitive resin composition. This varnish was applied onto a PET film (with a thickness of 25 μm) so that the thickness of the film might be 40 μm after drying and the organic solvent was removed by drying at 45° C. for 5 minutes and then at 65° C. for 5 minutes to bring the photosensitive dry film resist to B-stage status.

(2) Preparation of Three-Layer Structure Sheet

A protect film (Product No. 6221F with a thickness of 50 μm) was used as a protective sheet. This protect film is prepared by a method for simultaneously extruding a polyethylene resin and a copolymer consisting of polyethylene and ethylene vinyl alcohol resin. This protective film (PE+EVA) and a photosensitive dry film resist were laminated so that the surface of a (PE+EVA) copolymer film might make contact with the surface of the dry film resist to prepare a photosensitive dry film resist consisting of a three-layer structure sheet. The laminating conditions were: roll temperature at 40° C. and the nip pressure under 1,500 Pa·m.

(3) Evaluation of Photosensitive Dry Film Resist

The obtained photosensitive dry film resist was evaluated in some properties by the following methods:

<Developing Properties>

After the protective sheet of the three-layer structure sheet was peeled off, the surface of a photosensitive dry film resist was laminated onto a dull surface with a 35 μm-electrolytic copper foil while screening out light by heating at 100° C. under the pressure of 20,000 Pa·m. Mask patterns were overlaid on the support film of this laminate to be exposed to light with a wavelength of 400 nm at the rate of 1,800 mJ/cm². This laminate was heated at 100° C. for 2 minutes after the PET film of this test specimen was peeled off to be developed for 3 minutes using a solution of 1% potassium hydroxide. Photo-mask patterns disposed on the cover film before exposure were fine holes of 500 μm×500 μm square, 200 μm×200 μm square, and 100 μm×100 μm square. The patterns formed by the development were cleansed with distilled water to remove the developer. The evaluation was considered passed as long as a hole of 500 μm×500 μm square was formed.

<Residual Film Ratio>

The film thickness of the resist in the exposed part before and after the development (except for the thickness of a copper foil) was measured. The residual film ratio is a value obtained by dividing the resist thickness after developed by the resist thickness before developed and multiplying 100. The residual film ratio is preferable to be as close as 100% and the value not less than 95% is considered passed.

### Example 5

(2,2′-bis (4-hydroxyphenyl) propanedibenzoate-3,3′, 4, 4′-tetracarboxylic dianhydride (ESDA), bis[4-(3-aminophenoxy phenyl)sulfone (BAPS-M), silicone diamine, diamino benzoic acid, and [bis(4-mino-3-carboxy)phenyl]methane (MBAA) were used as materials for polyimides. N,N′-dimethylformamide (DMF) and dioxolane were used as solvents.

(Synthesis of Polyimide Resin)

17.3 g (0.030 mole) of ESDA and 30 g of DMF were placed in a 500 ml-separable flask equipped with a stirrer to be dissolved by stirring. And 5.15 g (0.018 mole) of diamine MBAA produced by Wakayama Seika Kogyo, Ltd. was added to be dissolved in 9 g of DMF and stirring was vigorously conducted for 1 hour. 7.47 g (0.009 mole) of silicone diamine KF-8010 (produced by Shin-Etsu Silicone Co., Ltd.) was added to be stirred for about 1 hour. 1.29 g (0.003 mole) of BAPS-M was finally added to be vigorously stirred for 1 hour. The polyamic acid solution thus obtained was placed in a butt coated with fluorocarbon resin and successively heated with a vacuum laminater at 200° C. for 2 hours at reduced pressure while maintaining the pressure of 660 Pa to obtain 26.40 g of soluble polyimide.

15 g of thus-synthesized polyimide was dissolved in 50 g of dioxolane to prepare a varnish of Sc=30%.

(Preparation of Photosensitive Dry Film Resist)

A photosensitive resin composition was prepared by mixing the following components (a) to (d) to prepare a photosensitive dry film resist in B-stage status on a PET film using (1) method.

A three-layer structure sheet was prepared by laminating a protective film onto this photosensitive dry film resist with PET film using (2) method.

(a) Polyimide resin synthesized by the above-mentioned method

60 parts by weight

(b) Bisphenol A EO modified (m+n≈0.30) diacrylate (NK Ester A-BPE-30 produced by Shin-Nakamura Chemicals Co., Ltd.)

20 parts by weight

(c) Bisphenol A EO modified (m+n≈0.10) diacrylate (NK Ester A-BPE-10 produced by Shin-Nakamura Chemicals Co., Ltd.)

20 parts by weight

(d) Bis(2,4,6-trimethylbenzoyl)phenylphosphine oxide (Irgacure 819 produced by Ciba Specialty Chemicals K.K.)

1 part by weight

This photosensitive dry film resist was tested in its developing properties. After development, a hole of 1001 m×100 μm square was not formed, but fine holes of 500 μm×500 μm square and 200 μm×200 μm square were formed. The residual film ratio was measured as a ratio of film thickness before and after developing. It was as good as 97.5%.

### Example 6

(Synthesis of Modified Polyimide)

20.8 g (0.020 mole) of polyimide synthesized in Example 5 was dissolved in 80 g of dioxolane, 0.030 g of 4-methoxyphenol was added to be dissolved while heating at 60° C. with an oil bath.

3.75 g (0.0264 mole) of glycidyl methacrylate was added to this solution to be dissolved in 5 g of dioxolane, and then 0.01 g of triethylamine was added as a catalyst to be stirred by heating at 60° C. for 6 hours. A modified polyimide was synthesized in such a manner.

(Preparation of Photosensitive Dry Film Resist)

A photosensitive resin composition was prepared by mixing the following components (e) to (h) to prepare a photosensitive dry film resist in B-stage on a PET film using (1) method.

A three-layer structure sheet was prepared by laminating a protective film onto this photosensitive dry film resist with PET film using (2) method.

(e) Modified polyimide synthesized in Example 5

50 parts by weight

(f) Bisphenol A EO modified (m+n≈0.30) diacrylate (NK Ester A-BPE-30 produced by Shin-Nakamura Chemicals Co., Ltd.)

50 parts by weight

(g) 4,4-diaminodiphenylmethane

1 part by weight

(h) Bis(2,4,6-trimethylbenzoyl)phenylphosphine oxide

(Irgacure 819 produced by Ciba Specialty Chemicals K.K.)

1 part by weight

This photosensitive dry film resist was tested in its developing properties. A hole of 100 μm×100 μm square was not formed, but fine holes of 500 μm×500 μm square and 200 μm×200 μm square were formed. The residual film ratio was measured as a ratio of film thickness before and after developing. It was as very good as 99.7%.

### Example 7

A photosensitive resin composition was prepared by mixing the following components (e) to (g) and (i) and (j) to prepare a photosensitive dry film resist in B-stage status on a PET film using (1) method.

(e) Polyimide resin synthesized in Example 6

50 parts by weight

(f) Bisphenol A EO modified (m+n≈0.30) diacrylate (NK Ester A-BPE-30 produced by Shin-Nakamura Chemicals Co., Ltd.)

50 parts by weight

(g) 4,4′-diaminodiphenylmethane

1 part by weight

(i) 4,4′-bis(diethylamine)benzophenone)(S-112 produced by Shinko Giken Co., Ltd.)

1 part by weight

(j) 3,3′, 4,4′-tetra(t-butyl peroxycarbonyl)benzophenone

1 part by weight

Fine holes of 500 μm×500 μm square and 200 μm×200 μm square were formed after development. The residual film ratio was measured as a ratio of film thickness before and after developing. It was as good as 97.2%.

### Example 8

A photosensitive resin composition was prepared by mixing the following components (a), (b), (d), and (k) to prepare a photosensitive dry film resist in B-stage status on a PET film using (l) method.

(a) Polyimide resin synthesized in Example 5

60 parts by weight

(b) Bisphenol A EO modified (m+n≈0.30) diacrylate (NK Ester A-BPE-30 produced by Shin-Nakamura Chemicals Co., Ltd.)

20 parts by weight

(k) Bisphenol F EO modified (n≈0.2) diacrylate (Arnonix M-208 produced by Toagosei Co., Ltd.)

20 parts by weight

(d) Bis(2,4,6-trimethylbenzoyl)phenylphosphine oxide (Irgacure 819 produced by Ciba Specialty Chemicals K.K.)

1 part by weight

This photosensitive dry film resist was tested in its developing properties. A hole of 100 μm×100 μm square was not formed, but fine holes of 500 μm×500 μm square and 200 μm×200 μm square were formed. The residual film ratio was measured as a ratio of film thickness before and after developing. It was 95.8%.

### Comparative Example 3

A photosensitive resin composition was prepared by mixing the following components (a), (d), (k), and (m) to prepare a photosensitive dry film resist in B-stage status on a PET film using (l) method.

(a) Polyimide resin synthesized in Example 5

60 parts by weight

(k) Bisphenol F EO modified (n≈0.2) diacrylate (Aronix M-208 produced by Toagosei Co., Ltd.)

20 parts by weight

(m) Polyethyleneglycoldiacrylate (n-0.4)(Aronix M-240 produced by Toagosei Co., Ltd.)

20 parts by weight

(d) Bis(2,4,6-trimethylbenzoyl)phenylphosphine oxide (Irgacure 819 produced by Ciba Specialty Chemicals K.K.)

1 part by weight

None of holes of 500 μm×500 μm square, 200 μm×200 μm square, and 100 μm×100 μm was formed after development when this photosensitive dry film resist was tested in its developing properties. The residual film ratio of the resist was 97.8%. As mentioned above, when diacrylate having four repeated units of —(CH₂—CH₂—O)— in one molecule and having no aromatic rings is used as an acrylate resin containing (B) component, it is impossible to perform development with an alkaki solution.

When a dilute solution diluted with a solution prepared by mixing water and isopropyl alcohol in the weight ratio 1:1 was used as a developer so that the concentration of potassium hydroxide might be 0.5%, holes of 500 μm×500 μm square and 200 μm×200 μm square were formed, but a hole of 100 μm×100 μm square was not formed. The residual film ratio in this case was 89.1% and a film decrease was a little great. Development is easier when using an organic solvent as a developer, but there is a tendency of a great decrease in film because of a rise in solubility of the resist.

### Comparative Example 4

A photosensitive resin composition was prepared by mixing the following components (e), (g), (i), (j), and (n) to prepare a photosensitive dry film resist in B-stage status on a PET film using (1) method. A three-layer structure sheet was prepared by laminating a protective film onto this photosensitive dry film resist with PET film using (2) method.

(e) Modified polyimide synthesized in Example 6

70 parts by weight

(n) Bisphenol A EO modified (n≈1) diacrylate (NK Ester A-BPE-100 produced by Shin-Nakamura Chemicals Co., Ltd.)

30 parts by weight

(g) 4,4′-diaminodiphenylmethane

1 part by weight

(i) 4,4′-bis(diethylamine)benzophenone)(S-112 produced by Shinko Giken Co., Ltd.)

1 part by weight

(j) 3,3′, 4,4′-tetra(t-butyl peroxycarbonyl)benzophenone

1 part by weight

A developing properties test was conducted on this photosensitive dry film resist. None of holes of 500 μm×500 μm square, 200 μm×200 μm square, and 100 μm×100 μm square was formed. The residual film ratio of the resist was 96.4%. Thus, development was impossible using an alkali solution when Bisphenol A EO modified diacrylate (n≈1) was used as acrylic resin.

In the following Examples 9 to 12 and Comparative Examples 5 to 7, a photosensitive dry film resist and a three-layer structure sheet were prepared using a photosensitive resin composition of the present invention. Evaluation of photosensitive dry film resist was performed in developing properties and incombustibility.

<Preparation of Photosensitive Dry Film Resist>

After the dissolution of a soluble polyimide resin in organic solvent to a degree that the solid content of the polyimide resin could be 30% by weight, an acrylate resin and a photoreaction initiator were mixed to prepare a varnish of a photosensitive resin composition. The varnish of this photosensitive resin composition was applied onto a PET film (with a thickness of 25 μm) so that the thickness of the film might be 25 μm after drying and the organic solvent was removed by drying at 45° C. for 5 minutes and then at 65° C. for 5 minutes to bring the photosensitive dry film resist to B-stage status. Successively, a protect film (Product No. 6221F) produced by Sekisui Chemical Co., Ltd. consisting of a copolymer of polyethylene resin and ethylene vinyl alcohol resin was laminated as a protective film so that the copolymer film surface might make contact with the surface of the photosensitive film to prepare a photosensitive dry film resist consisting of a three-layer structure sheet. The laminating conditions were: roll temperature was 40° C. and the nip pressure was 1,500 Pa·m.

<Evaluation of Photosensitive Dry Film Resist>

The obtained photosensitive dry film resist was evaluated in some properties by the following methods:

<Flame-Retardant Test>

In accordance with the flame-retardant test standards of plastic materials UL (Underwriters Laboratories Inc., USA) 94, a flame-retardant test was conducted as follows: After the protective sheet of the three-layer structure sheet was peeled off, a photosensitive dry film resist with a copper foil was laminated while screening out light by heating at 100° C. under the pressure of 20,000 Pa·m so that the surface of the dry film resist might make contact with a polyimide film with a thickness of 25 μm (25AH film produced by Kaneka Corporation). A support film was peeled off from this laminate after exposed to light with a wavelength of 400 nm at the rate of 600 mJ/cm² to be cured by heating with an oven at 180° C.

20 pieces of test specimens made by cutting the above-prepared test specimen into the size with a width of 1.27 cm, a length of 12.7 cm, a thickness of 50 μm (including the thickness of polyimide film) were prepared.

10 pieces out of these test specimens were treated by (1) drying at 23° C., 50% relative humidity for 48 hours and the remaining 10 pieces were treated by (2) heating at 70° C. for 168 hours and then were cooled down for not less than 4 hours with a desiccator containing anhydrous calcium chloride.

These test specimens were placed vertically with their upper parts fixed using clamps to ignite the lower parts of the test specimens with a burner flame by approaching it for 10 seconds. After a lapse of 10 seconds, the burner flames were moved away from the test specimens to measure how long it had taken for the flames on the test specimens or burning to extinguish. When the flames self-extinguished or the burning ceased within 5 seconds after the moving of the flames away from the test specimens on the average (average of 10 pieces) and within 10 seconds at the longest, the test was considered passed. Even if a single test specimen does not self-extinguish within 10 seconds or a single test specimen burns up to the clamp in its upper part of the test specimen, the test is considered unacceptable.

<Developing Properties>

After the protective sheet of the three-layer structure sheet was peeled off, the surface of a photosensitive dry film resist was laminated onto a dull surface with a 35 μm-electrolytic copper foil while screening out light by heating at 100° C. under the pressure of 20,000 Pa·m. Mask patterns were overlaid on the support film of this laminate to be exposed to light with a wavelength of 400 nm at the rate of 1,800 mJ/cm². This laminate was heated at 100° C. for 2 minutes after the support film of this test specimen was peeled off to be developed for 3 minutes using a solution (at liquid temperature of 40° C.) of 1% potassium hydroxide. Photo-mask patterns disposed on the cover film before exposure were fine holes of 500 μm×500 μm square, 200 μm×200 ˜m square, and 100 ˜m×100 μm square. The patterns formed by the development were cleansed with distilled water to remove the developer. The evaluation was considered passed as long as a hole of 500 μm×500 ˜m square was formed.

### Example 9

(2,2′-bis (4-hydroxyphenyl) propanedibenzoate-3,3′, 4, 4′-tetracarboxylic dianhydride (ESDA), bis[4-(3-aminophenoxy phenyl) sulfone (BAPS-M), silicone diamine, diamino benzoic acid, and [bis(4-mino-3-carboxy)phenylmethane (MBAA) were used as materials for polyimides. N,N′-dimethylformamide (DMF) and dioxolane were used as solvents.

(Synthesis of Polyimide Resin)

17.3 g (0.030 mole) of ESDA and 30 g of DMF were placed in a 500 ml-separable flask equipped with a stirrer to be dissolved by stirring. And 5.15 g (0.018 mole) of diamine MBAA produced by Wakayama Seika Kogyo, Ltd. was added to be dissolved in 9 g of DMF and stirring was vigorously conducted for 1 hour. 7.47 g (0.009 mole) of silicone diamine KF-8010 (produced by Shin-Etsu Silicone Co., Ltd.) was added to be stirred for about 1 hour. 1.29 g (0.003 mole) of BAPS-M was finally added to be vigorously stirred for 1 hour. The polyamic acid solution thus obtained was placed in a butt coated with Teflon (R) and successively heated with a vacuum laminater at 200° C. for 2 hours under reduced pressure while maintaining the pressure of 660 Pa to obtain 26.40 g of soluble polyimide.

15 g of thus-synthesized polyimide was dissolved in 50 g of dioxolane to prepare a varnish of Sc=30%.

(Preparation of Photosensitive Dry Film Resist)

A photosensitive resin composition was prepared by mixing the following components (a) to (d) to prepare a photosensitive dry film resist in B-stage status on a PET film using (1) method. A three-layer structure sheet was prepared by laminating a protective film onto this photosensitive dry film resist with a PET film.

(a) Polyimide resin synthesized by the above-mentioned method

60 parts by weight

(b) Bisphenol A EO modified (m+n≈0.30) diacrylate (NK Ester A-BPE-30 produced by Shin-Nakamura Chemicals Co., Ltd.)

5 parts by weight

(c) TPP (triphenylphosphate)

35 parts by weight

(d) Bis(2,4,6-trimethylbenzoyl)phenylphosphine oxide (Irgacure 819 produced by Ciba Specialty Chemicals K.K.)

1 part by weight

As a result of a flame-retardant test of this photosensitive dry film resist, the test specimens passed the standard UL 94V-0 because the flames extinguished in 4 seconds on the average. This photosensitive dry film resist was tested in its developing properties. A hole of 100 μm×100 μm square was not formed, but fine holes of 500 μm×500 μm square and 200 μm×200 μm square were formed, so that the test was considered passed.

### Example 10

(Synthesis of Modified Polyimide)

20.8 g (0.020 mole) of polyimide synthesized in Example 9 was dissolved in 80 g of dioxolane and 0.030 g of 4-methoxyphenol was added to be dissolved while heating at 60° C. with an oil bath. 3.75 g (0.0264 mole) of glycidyl methacrylate was added to this solution to be dissolved in 5 g of dioxolane, and then 0.01 g of triethylamine was added as a catalyst to be stirred by heating at 60° C. for 6 hours. A modified polyimide was synthesized in such a manner.

(Preparation of Photosensitive Dry Film Resist)

A photosensitive resin composition was prepared by mixing the following components to prepare a photosensitive dry film resist in B-stage status on a PET film using (1) method. A three-layer structure sheet was prepared by laminating a protective film onto this photosensitive dry film resist with a PET film.

(e) Modified polyimide synthesized as above

50 parts by weight

(b) Bisphenol A EO modified (m+n≈0.30) diacrylate (NK Ester A-BPE-30 produced by Shin-Nakamura Chemicals Co., Ltd.)

5 parts by weight

(f) Bisphenol A EO modified (m+n≈4) diacrylate (Aronix M-211B produced by Toagosei Co., Ltd.)

10 parts by weight

(g) PX-200 (produced by Daihatchi Chemical Co., Ltd.)

35 parts by weight

(h) Epoxy resin Epicote 828 (produced by Shell Oil Co., Ltd.)

3 parts by weight

(i) 4,4′-diaminodiphenylmethane

1 part by weight

(j) 4,4′-bis (diethylamino)benzophenone

1 part by weight

(k) 3,3′,4,4′-tetra (t-butyl peroxycarbonyl)benzophenone

1 part by weight

As a result of a flame-retardant test of this photosensitive dry film resist, the test specimens passed the standard UL 94V-0 because the flames extinguished in 4.5 seconds on the average.

This photosensitive dry film resist was tested in its developing properties. After development, fine holes of 500 μm×500 μm square, 200 μm×200 μm square, and 100 μm×100 μm square were formed, so that the test was considered passed.

### Example 11

A photosensitive resin composition was prepared by mixing the following components to prepare a photosensitive dry film resist in B-stage status on a PET film using (1) method. A three-layer structure sheet was prepared by laminating a protective film onto this photosensitive dry film resist with a PET film.

(e) Modified polyimide synthesized in Example 10

50 parts by weight

(f) Bisphenol A EO modified (m+n≈0.30) diacrylate (NK Ester BPE-30 produced by Shin-Nakamura Chemicals Co., Ltd.)

10 parts by weight

(1) TXP (trixylenyl phosphate)

40 parts by weight

(j) 4,4′-bis (diethylamino) benzophenone

1 part by weight

(k) 3,3′,4,4′-tetra (t-butyl peroxycarbonyl)benzophenone

1 part by weight

As a result of a flame-retardant test of this photosensitive dry film resist, the test specimens passed the standard UL 94V-0 because the flames extinguished in 3 seconds on the average.

This photosensitive dry film resist was tested in its developing properties. After development, fine holes of 500 μm×500 μm square, 200 μm×200 μm, and 100 μm×100 μm square were formed, so that the test was considered passed.

### Example 12

A photosensitive resin composition was prepared by mixing the following (a), (b), (d), and (k) components to prepare a photosensitive dry film resist in B-stage status on a PET film using (1) method.

(a) Modified polyimide resin synthesized in Example 9

50 parts by weight

(b) Bisphenol A EO modified (m+n≈0.30) diacrylate (NK Ester A-BPE-30 produced by Shin-Nakamura Chemicals Co., Ltd.)

5 parts by weight

(o) CR-733S (Trikylenylphosphate)

30 parts by weight

(m) BR-31 (produced by Daiichi Kogyo Seiyaku Co., Ltd.)

5 parts by weight

(n) Antimony pentoxide

(Sun Epoch NA-4800 produced by Nissan Chemical Co., Ltd.)

3 parts by weight

(j) 4,4′-bis (diethylamino)benzophenone

1 part by weight

(k) 3,3′, 4,4′-tetra (t-butyl peroxycarbonyl)benzophenone

1 part by weight

As a result of a flame-retardant test of this photosensitive dry film resist, the test specimens passed the standard UL 94V-0 because no flames were ignited on the test specimens and the cover lay film was carbonized.

This photosensitive dry film resist was tested in its developing properties. After development, fine holes of 500 μm×500 μm square, 200 μm×200 μm square, and 100 μm×100 μm square were formed, so that the test was considered passed.

### Comparative Example 5

A photosensitive resin composition was prepared by mixing the following components to prepare a photosensitive dry film resist in B-stage status on a PET film using (1) method.

(a) Polyimide resin synthesized in Example 9

50 parts by weight

(b) Bisphenol A EO modified (m+n≈0.30) diacrylate (NK Ester A-BPE-30 produced by Shin-Nakamura Chemicals Co., Ltd.)

10 parts by weight

(f) Bisphenol A EO modified (m+n≈0.4) diacrylate (Aronix M-211B produced by Toagosei Co., Ltd.)

40 parts by weight

(j) 4,4′-bis (diethylamino)benzophenone

1 part by weight

(k) 3,3′, 4,4′-tetra (t-butyl peroxycarbonyl)benzophenone c1 part by weight

As a result of a flame-retardant test of this photosensitive dry film resist, the test specimens did not pass the standard UL 94V-0 because the test specimens burned up to their upper parts with flame. This photosensitive dry film resist was tested in its developing properties. After development, fine holes of 500 μm×500 μm square, 200 μm×200 μm square, and 100 μm×100 μm square were formed, so that the test was considered passed.

### Comparative Example 6

A photosensitive resin composition was prepared by mixing the following components to prepare a photosensitive dry film resist in B-stage status on a PET film using (1) method.

(e) Modified polyimide synthesized in Example 10

60 parts by weight

(b) Bisphenol A EO modified (m+n≈0.30) diacrylate (NK Ester A-BPE-30 produced by Shin-Nakamura Chemicals Co., Ltd.)

5 parts by weight

(f) Bisphenol A EO modified (m+n≈0.4) diacrylate (Aronix M-211B produced by Toagosei Co., Ltd.)

35 parts by weight

(j) 4,4′-bis (diethylamino)benzophenone

1 part by weight

(k) 3,3′, 4,4′-tetra (t-butyl peroxycarbonyl)benzophenone

1 part by weight

As a result of a flame-retardant test of this photosensitive dry film resist, the test specimens did not pass the standard UL 94V-0 because the test specimens burned up to their upper parts with flame. This photosensitive dry film resist was tested in its developing properties. Fine holes of 500 μm×500 μm square and 200 μm×200 μm square were formed, so that the test was considered passed, but a hole of 100 μm×100 μm square was not formed.

As mentioned above, the photosensitive cover lay film without phosphorous compound does not satisfy the flame-retardant standards, although it shows good developing property.

### Comparative Example 7

A photosensitive dry film resist “Piralux PC-1500” (with a thickness of 50 μm) produced by Du Pont-Toray Co., Ltd. is used as a photosensitive dry film-type cover lay for a flexible printed circuit. The primary component of this film is an acrylic resin.

This “Piralux PC-1500” was laminated onto a polyimide film (AH Film produced by Kaneka Corporation, thickness μm) by heating at 100° C. at a pressure of 0.001 Pa in a vacuum laminater. Curing by heating was performed in an oven at 170° C. after the exposure to light with a wavelength of 400 nm at the rate of 300 mJ/cm².

As a result of a flame-retardant test of this photosensitive dry film resist, the test specimens did not pass the standard UL 94V-0 because the test specimens were in flames. When this photosensitive dry film resist was tested in its developing properties in the same manner as in other examples except using a solution of 1% calcium carbonate (at liquid temperature of 40° C.), fine holes of 500 μm×500 μm square, 200 μm×200 μm square, and 100 μm×100 μm square were formed, so that the test was considered passed.

Accordingly, the photosensitive dry film resist having the primary component of an acrylic resin can be developed, but is inferior in incombustibility, so that it does not satisfy the standard UL 94V-0.

In the following Examples 13 to 16 and Comparative Examples 8, 9, and 10, a photosensitive dry film resist and a three-layer structure sheet were prepared using the photosensitive resin composition of the present invention. Evaluation of photosensitive dry film resist was performed in incombustibility.

(1) Preparation of Photosensitive Dry Film Resist

After the dissolution of a soluble polyimide resin in organic solvent to a degree that the solid content of the polyimide resin could be 30% by weight, a compound containing halogen, a (meta) acrylic compound having at least one carbon-carbon double bond, and a photoreaction initiator were mixed to prepare a varnish of a photosensitive resin composition. The varnish of this photosensitive resin composition was applied onto a PET film (with a thickness of 25 μm) so that the thickness of the film after dried might be 25 μm and the organic solvent was removed by drying at 45° C. for 5 minutes and then at 65° C. for 5 minutes to bring the photosensitive dry film resist to B-stage status. Successively, a protect film (Product No. 6221F) produced by Sekisui Chemical Co., Ltd. consisting of a copolymer of a polyethylene resin and an ethylene vinyl alcohol resin was laminated as a protective film so that the copolymer film surface might make contact with the surface of the photosensitive film to prepare a photosensitive dry film resist consisting of a three-layer structure sheet. The laminating conditions were: roll temperature was 40° C. and the nip pressure was 1,500 Pa·m.

(2) Evaluation of Photosensitive Dry Film Resist

The obtained photosensitive film resist was evaluated in some properties by the following methods:

<Flame-Retardant Test of Polyimide Film Laminate>

In accordance with the flame-retardant test standard of plastic materials UL 94, a flame-retardant test was conducted as follows: After the protective sheet of the three-layer structure sheet was peeled off, the surface of a photosensitive dry film resist was laminated while screening out light using a polyimide film with a thickness of 25 μm (25AH film produced by Kaneka Corporation) by heating at 100° C. under the pressure of 20,000 Pa·m. A support film was peeled off from this laminate after exposed to light with a wavelength of 400 nm at the rate of 600 mJ/cm² to be cured by heating with an oven at 180° C. for 2 hours.

20 pieces of test specimens made by cutting the above-prepared test specimen into the size with a width of 1.27 cm, a length of 12.7 cm, a thickness of 50 μm (including the thickness of polyimide film) were prepared.

10 pieces out of these test specimens were treated by (1) drying at 23° C., 50% relative humidity for 48 hours and the remaining 10 pieces were treated by (2) heating at 70° C. for 168 hours and then were cooled down for not less than 4 hours with a desiccator containing anhydrous calcium chloride.

These test specimens were placed vertically with their upper parts fixed using clamps to ignite the lower parts of the test specimens with a burner flame by approaching it for 10 seconds. After a lapse of 10 seconds, the burner flames were moved away from the test specimens to measure how long it had taken for the flames of the test specimens or burning to extinguish. When the flames self-extinguished or burning ceased within 5 seconds after the moving of the flames away from the test specimens on the average (average of 10 pieces) and within 10 seconds at the longest, the test was considered passed. Even if a single test specimen does not self-extinguish within 10 seconds or a single test specimen burns up to the clamp in its upper part of the test specimen, the test is considered unacceptable. V-O passes the test.

<Flame-Retardant Test of a Single Layer of Photosensitive Dry Film Resist after Cured>

After the protective sheet of the three-layer structure sheet was peeled off, the surface of a photosensitive dry film resist was laminated onto a rolled copper foil while screening out light by heating at 100° C. under the pressure of 20,000 Pa·m. A support film was peeled off after exposed to light with a wavelength of 400 nm at the rate of 600 mJ/cm² to be cured by heating for 2 hours at 180° C. in an oven. Subsequently, the copper foil was peeled off by etching to obtain a photosensitive dry film resist in a single layer state after cured. This film was fixed to a pin frame of 20 cm×20 cm square and was dried by an oven at 90° C. by ventilation.

Thus, 20 pieces of test specimens made by cutting the above test specimens into the size with a width of 1.27 cm, a length of 12.7 cm, and a thickness of 25 μm were prepared to perform a test in the same manner as in the flame-retardant test of the above-mentioned polyimide film laminate. Criteria and acceptance criteria are just the same as in the above-mentioned test.

<Developing Properties>

After the protective sheet of the three-layer structure sheet was peeled off, the surface of a photosensitive dry film resist was laminated onto a dull surface with a 35 μm-electrolytic copper foil while screening out light by heating at 100° C. under the pressure of 20,000 Pa·m. Mask patterns were overlaid on the support film of this laminate to be exposed to light with a wavelength of 400 nm at the rate of 1,800 mJ/cm². This laminate was heated at 100° C. for 2 minutes after the PET film of this test specimen was peeled off to be developed for 3 minutes using a solution (at liquid temperature of 40° C.) of 1% potassium hydroxide. Photo-mask patterns disposed on the cover film before exposure were fine holes of 500 μm×500 μm square, 200 μm×200 μm square, and 100 μm×100 μm square. The patterns formed by the development was cleansed with distilled water to remove the developer. The evaluation was considered passed as long as a hole of 500 μm×500 μm square was formed.

### Example 13

(2,2′-bis (4-hydroxyphenyl) propanedibenzoate-3,3′, 4, 4′-tetracarboxylic dianhydride (ESDA), bis[4-(3-aminophenoxy phenyl)sulfone (BAPS-M), silicone diamine, diamino benzoic acid, and [bis(4-mino-3-carboxy)phenylmethane (MBAA) were used as materials for polyimides. N,N′-dimethylformamide (DMF) and dioxolane were used as solvents.

(Synthesis of Polyimide Resin)

17.3 g (0.030 mole) of ESDA and 30 g of DMF were placed in a 500 ml-separable flask equipped with a stirrer to be dissolved by stirring. And 5.15 g (0.018 mole) of diamine MBAA produced by Wakayama Seika Kogyo, Ltd. was added to be dissolved in 9 g of DMF and stirring was vigorously conducted for 1 hour. 7.47 g (0.009 mole) of silicone diamine KF-8010 (produced by Shin-Etsu Silicone Co., Ltd.) was added to be stirred for about 1 hour. 1.29 g (0.003 mole) of BAPS-M was finally added to be vigorously stirred for 1 hour. The polyamic acid solution thus obtained was placed in a butt coated with Teflon (R) and successively heated with a vacuum laminater at 200° C. for 2 hours under reduced pressure while maintaining the pressure of 660 Pa to obtain 26.40 g of soluble polyimide.

15 g of thus-synthesized polyimide was dissolved in 50 g of dioxolane to prepare a varnish of Sc=30%.

(Preparation of Photosensitive Dry Film Resist)

A photosensitive resin composition was prepared by mixing the following components (a) to (f) to prepare a photosensitive dry film resist in B-stage status on a PET film using (1) method. A three-layer structure sheet was prepared by laminating a protective film onto this photosensitive dry film resist with a PET film.

(a) Polyimide resin synthesized by the above-mentioned method

65 parts by weight

(b) Bisphenol A EO modified (m+n≈0.30) diacrylate (NK Ester A-BPE-30 produced by Shin-Nakamura Chemicals Co., Ltd.)

10 parts by weight

(c) TPP (triphenylphosphate)

20 parts by weight

(d) EO modified tribromophenyl acrylate (BR-31 produced by Dai-ichi Kogyo Seiyaku Co., Ltd.)

5 parts by weight

(e) 4,4′-bis(diethylamino)benzophenone

1 part by weight

(f) 3,3′, 4,4′-tetra(t-butyl peroxycarbonyl)benzophenone

1 part by weight

As a result of a flame-retardant test of this photosensitive film resist, the test specimens passed the standard UL 94V-0 because the flames extinguished in 3.0 seconds on the average regarding a laminate with a polyimide film, and the flames extinguished in 4.5 seconds on the average regarding a single layer. This photosensitive dry film resist was tested in its developing properties. After development, a hole of 100 μm×100 μm square was not formed, but fine holes of 500 μm×500 μm square and 200 μm×200 μm square were formed, so that the test was considered passed.

### Example 14

(Synthesis of Modified Polyimide)

20.8 g (0.020 mole) of polyimide synthesized in Example 13 was dissolved in 80 g of dioxolane, 0.030 g of 4-methoxyphenol was added to be dissolved while heating at 60° C. with an oil bath. 3.75 g (0.0264 mole) of glycidyl methacrylate was added to this solution to be dissolved in 5 g of dioxolane, and then 0.01 g of triethylamine was added as a catalyst to be stirred by heating at 60° C. for 6 hours. A modified polyimide was synthesized in such a manner.

(Preparation of Photosensitive Dry Film Resist)

A photosensitive resin composition was prepared by mixing the following components to prepare a photosensitive dry film resist in B-stage status on a PET film using (1) method. A three-layer structure sheet was prepared by laminating a protective film onto this photosensitive dry film resist with a PET film.

(g) Modified polyimide synthesized as above

50 parts by weight

(b) Bisphenol A EO modified (m+n≈0.30) diacrylate (NK Ester A-BPE-30 produced by Shin-Nakamura Chemicals Co., Ltd.)

5 parts by weight

(h) Bisphenol A EO modified (m+n≈0.4) diacrylate (Aronix M-211B produced by Toagosei Co., Ltd.)

40 parts by weight

(d) EO modified tribrophenyl acrylate (BR-31 produced by Dai-ichi Kogyo Seiyaku Co., Ltd.)

5 parts by weight

(i) Antimony pentoxide (NA-4800 produced by Nissan Chemical Industries, Ltd.)

5 parts by weight

(e) 4,4′-bis(diethylamino)benzophenone

0.5 part by weight

(f) 3,3′, 4,4′-tetra (t-butyl peroxycarbonyl)benzophenone

0.5 part by weight

As a result of a flame-retardant test of this photosensitive dry film resist, both of the test specimens passed the standard UL 94V-0 because a laminate with a polyimide film was not ignited, even when the flames approached to the test specimen, and the flames extinguished in 2.0 seconds on the average in a single layer.

This photosensitive dry film resist was tested in its developing properties. After development, fine holes of 500 μm×500 μm square, 200 μm×200 μm square, and 100 μm×100 μm square were formed, so that the test was considered passed.

### Example 15

A photosensitive resin composition was prepared by mixing the following components to prepare a photosensitive dry film resist in B-stage status on a PET film using (1) method. A three-layer structure sheet was prepared by laminating a protective film onto this photosensitive dry film resist with a PET film.

(g) Modified polyimide similar to Example 14

60 parts by weight

(b) Bisphenol A EO modified (m+n≈0.30) diacrylate (NK Ester A-BPE-30 produced by Shin-Nakamura Chemicals Co., Ltd.)

10 parts by weight

(1) TXP (trixylenylphosphate)

30 parts by weight

(i) Antimony pentoxide (NA-4800 produced by Nissan Chemical Industries, Ltd.)

5 parts by weight

(j) Epoxy resin Epicote 828 (produced by Shell International Chemicals Corporation)

3 parts by weight

(k) 4,4′-diaminodipheny methane

1 part by weight

(e) 4,4′-bis (diethylamino)benzophenone

1 part by weight

(f) 3,3′, 4,4′-tetra (t-butyl peroxycarbonyl)benzophenone

1 part by weight

As a result of a flame-retardant test of this photosensitive dry film resist, both of the test specimens passed the standard UL 94V-0 because the flames extinguished in 2.5 seconds on the average regarding a laminate with a polyimide film and in 4.4 seconds on the average regarding a single layer.

Although fine holes of 500 μm×500 μm square and 200 μm×200 μm square were formed, but a hole of 100 μm×100 μm square was not formed, so that the test was considered passed.

### Example 16

A photosensitive resin composition was prepared by mixing the following components to prepare a photosensitive dry film resist in B-stage status on a PET film using (1) method.

(a) Polyimide resin synthesized in Example 13

40 parts by weight

(b) Bisphenol A EO modified (m+n≈0.30) diacrylate (NK Ester A-BPE-30 produced by Shin-Nakamura Chemicals Co., Ltd.)

5 parts by weight

(h) Bisphenol A EO modified (m+n≈4) diacrylate (Aronix M-211B produced by Toagosei Co., Ltd.)

40 parts by weight

(m) Tris(Tribromoneo pentyl)phosphate (CR-900 produced by Daihachi Chemical Co., Ltd.)

10 parts by weight

(n) EO modified tetrabrophenyl bisphenol A dimetacrylate (BR-42M produced by Dai-ichi Kogyo Seiyaku Co., Ltd.)

5 parts by weight

(i) Antimony pentoxide (Sun Epoch NA-4800 produced by Nissan Chemical Co., Ltd.)

3 parts by weight

(e) 4,4′-bis (diethylamino)benzophenone

1 part by weight

(f) 3,3′, 4,4′-tetra (t-butyl peroxycarbonyl)benzophenone

1 part by weight

As a result of a flame-retardant test of this photosensitive dry film resist, both of the test specimens passed the standard UL 94V-0 because no flames were ignited on even a laminate with a polyimide and a single layer.

This photosensitive dry film resist was tested in its developing properties. After development, fine holes of 500 μm×500 μm square, 200 μm×200 μm square, and 100 μm×100 μm square were formed, so that the test was considered passed.

### Comparative Example 8

A photosensitive resin composition was prepared by mixing the following components to prepare a photosensitive dry film resist in B-stage status on a PET film using (1) method.

(a) Polyimide resin synthesized in Example 13

50 parts by weight

(b) Bisphenol A EO modified (m+n≈0.30) diacrylate (NK Ester A-BPE-30 produced by Shin-Nakamura Chemicals Co., Ltd.)

10 parts by weight

(f) Bisphenol A EO modified (m+n≈0.4) diacrylate (Aronix M-211B produced by Toagosei Co., Ltd.)

40 parts by weight

(j) 4,4′-bis (diethylamino)benzophenone

1 part by weight

(k) 3,3′, 4,4′-tetra (t-butyl peroxycarbonyl)benzophenone

1 part by weight

As a result of a flame-retardant test of this photosensitive dry film resist, none of the test specimens of a laminate with a polyimide film and a single-layer film passed the standard UL 94V-0 because the test specimens burned up to their upper parts with flame. This photosensitive dry film resist was tested in its developing properties. Fine holes of 500 μm×500 μm square, 200 μm×200 μm square, and 100 μm×100 μm square were formed, so that the test was considered passed.

As mentioned above, photosensitive cover lay films prepared without any compounds containing halogen or any phosphate compounds show good developing properties, but do not satisfy the flame-retardant standards.

### Comparative Example 9

A photosensitive resin composition was prepared by mixing the following components to prepare a photosensitive dry film resist in B-stage status on a PET film using (1) method.

(e) Modified polyimide synthesized in Example 14

60 parts by weight

(b) Bisphenol A EO modified (m+n≈0.30) diacrylate (NK Ester A-BPE-30 produced by Shin-Nakamura Chemicals Co., Ltd.)

5 parts by weight

(d) EO modified tribromophenylacrylate (BR-31 produced by Daihachi Chemical Co., Ltd.)

35 parts by weight

(j) 4,4′-bis (diethylamino)benzophenone

1 part by weight

(k) 3,3′, 4,4′-tetra (t-butyl peroxycarbonyl)benzophenone

1 part by weight

As a result of a flame-retardant test of this photosensitive dry film resist, the test specimens passed the standard UL 94V-0 because the flame ignited on a laminate with a polyimide film extinguished in 1.3 seconds on the average and the flame ignited on the single layer extinguished in 3.5 seconds on the average.

This photosensitive dry film resist was tested in its developing properties. After development, none of holes of 500 μm×500 μm square, 200 μm×200 μm square, or 100 μm×100 μm square was formed.

As mentioned above, a photosensitive cover lay film prepared without any acrylic compounds shows good incombustibility, but has poor developing properties.

### Comparative Example 10

A photosensitive resin composition was prepared by mixing the following components to prepare a photosensitive dry film resist in B-stage status on a PET film using (1) method.

(b) Bisphenol A EO modified (m+n≈0.30) diacrylate (NK Ester A-BPE-30 produced by Shin-Nakamura Chemicals Co., Ltd.)

30 parts by weight

(h) Bisphenol A EO modified (m+n≈0.4) diacrylate (Aronix M-211B produced by Toagosei Co., Ltd.)

40 parts by weight

(n) EO modified tetrabromophenyl Bisphenol A dimetacrylate (BR-42M produced by Daihachi Chemical Co., Ltd.)

30 parts by weight

(j) 4,4′-bis (diethylamino)benzophenone

1 part by weight

(k) 3,3′, 4,4′-tetra (t-butyl peroxycarbonyl)benzophenone

1 part by weight

As a result of a flame-retardant test of this photosensitive dry film resist after cured, both test specimens of a laminate with a polyimide film and a single-layer film were in flames. Accordingly, the test specimens did not pass the standard UL 94V-0.

In a developing properties test, after development, fine holes of 500 μm×500 μm square, 200 μm×200 μm square, and 100 μm×100 μm square were formed, so that the test was considered passed.

Thus, a photosensitive dry film resist mainly containing an acrylic resin can be developed, but shows poor incombustibility, so that it does not satisfy the standard UL 94V-0.

In the following Examples 17 and 18, and Comparative Examples 11, 12, and 13, a photosensitive dry film resist and a three-layer structure sheet were prepared using a photosensitive resin composition of the present invention. Evaluation of photosensitive dry film resist was performed in incombustibility, developing properties, and adhesive strength.

(1) Preparation of Photosensitive Dry Film Resist

After the dissolution of a soluble polyimide resin in organic solvent to a degree that the solid content of the polyimide resin could be 30% by weight and then an acrylate resin and a photoreaction initiator were mixed to prepare a varnish of a photosensitive resin composition. This varnish was applied onto a PET film (with a thickness of 25 μm) so that the thickness of the film after dried might be 25 μm and the organic solvent was removed by drying at 45° C. for 5 minutes and then at 65° C. for 5 minutes to bring the photosensitive dry film resist to B-stage status. Successively, a protect film (Product No. 6221F) produced by Sekisui Chemical Co., Ltd. consisting of a copolymer of polyethylene resin and an ethylene vinyl alcohol resin was laminated as a protective film so that the copolymer film surface might make contact with the surface of the photosensitive film to prepare a photosensitive dry film resist consisting of a three-layer structure sheet. The laminating conditions were: roll temperature was 40° C. and the nip pressure was 1,500 Pa·m.

(2) Evaluation of Photosensitive Dry Film Resist

The obtained photosensitive film resist was evaluated in some properties by the following methods:

<Flame-Retardant Test>

In accordance with the flame-retardant test standard of plastic materials UL 94, a flame-retardant test was conducted as follows: After the protective sheet of the three-layer structure sheet was peeled off, the surface of a photosensitive dry film resist was laminated while screening out light using a polyimide film with a thickness of 25 μm (25AH film produced by Kaneka Corporation) by heating at 100° C. under the pressure of 20,000 Pain. A support film was peeled off from this laminate after exposed to the light with a wavelength of 400 nm at the rate of 600 mJ/cm² and heated at 180° C. with an oven to be cured.

20 pieces of test specimens made by cutting the above-prepared test specimen into the size with a width of 1.27 cm, a length of 12.7 cm, a thickness of 50 μm (including the thickness of polyimide film) were prepared.

10 pieces out of these test specimens were treated by (1) drying at 23° C., 50% relative humidity for 48 hours and the remaining 10 pieces were treated by (2) heating at 70° C. for 168 hours and then were cooled down for not less than 4 hours with a desiccator containing anhydrous calcium chloride.

These test specimens were placed vertically with their upper parts fixed using clamps to ignite the lower parts of the test specimens with a burner flame by approaching it for 10 seconds. After a lapse of 10 seconds, the burner flames were moved away from the test specimens to measure how long it had taken for the flames of the test specimens or burning to extinguish. When the flames self-extinguished or burning ceased within 5 seconds after the moving of the flames away from the test specimens on the average (average of 10 pieces) and within 10 seconds at the longest, the test was considered passed. Even if a single test specimen does not self-extinguish within 10 seconds or a single test specimen burns up to the clamp in its upper part, the test is considered unacceptable.

<Developing Properties>

After the protective sheet of the three-layer structure sheet was peeled off, the surface of a photosensitive dry film resist was laminated onto a dull surface with an electrolytic copper foil (3EC-VLP 1 once produced by Mitsui Mining and Smelting Co., Ltd.) while screening out light by heating at 100° C. under the pressure of 20,000 Pa·m. Mask patterns were overlaid on the support film of this laminate to be exposed to light with a wavelength of 400 nm at the rate of 1,800 mJ/cm². This laminate was heated at 100° C. for 2 minutes after the PET film of this test specimen was peeled off to be developed for 3 minutes using a solution of 1% potassium hydroxide (at liquid temperature of 40° C.). Photo-mask patterns disposed on the cover film before exposure were fine holes of 500 μm×500 μm square, 200 μm×200 μm square, and 100 μm×100 μm square. The patterns formed by the development were cleansed with distilled water to remove the developer. The evaluation was considered passed as long as a hole of 500 μn×500 μm square was formed.

<Adhesive Strength>

After the protective film of the three-layer structure sheet was peeled off, the surface of the photosensitive dry film resist was overlaid onto the smooth surface of an electrolytic copper foil (3EC-VLP 1 once produced by Mitsui Mining and smelting Co., Ltd.) to be laminated by heating at 100° C. under the pressure of 20,000 Pa·m.

The peel adhesive strength was measured in accordance with the peeling off strength (180 degrees) of the JIS C 6481. Note that the width was measured on 1 cm width and the adhesive strength was measured on the copper foil and the photosensitive dry film resist.

### Example 17

(2,2′-bis (4-hydroxyphenyl) propanedibenzoate-3,3′, 4, 4′-tetracarboxylic dianhydride (ESDA), bis[4-(3-aminophenoxy phenyl)sulfone (BAPS-M), silicone diamine, diamino benzoic acid, and [bis(4-mino-3-carboxy)phenyl]methane (MBAA) were used as materials for polyimides. N,N′-dimethylformamide (DMF) and dioxolane were used as solvents.

(Synthesis of Polyimide Resin)

17.3 g (0.030 mole) of ESDA and 30 g of DMF were placed in a 500 ml-separable flask equipped with a stirrer to be dissolved by stirring. And 5.15 g (0.018 mole) of diamine MBAA produced by Wakayama Seika Kogyo, Ltd. was added to be dissolved in 9 g of DMF and stirring was vigorously conducted for 1 hour. 7.47 g (0.009 mole) of silicone diamine KF-8010 (produced by Shin-Etsu Silicone Co., Ltd.) was added to be stirred for about 1 hour. 1.29 g (0.003 mole) of BAPS-M was finally added to be vigorously stirred for 1 hour. The polyamic acid solution thus obtained was placed in a butt coated with Teflon (R) and subsequently heated with a vacuum laminater at 200° C. for 2 hours under reduced pressure while maintaining the pressure of 660 Pa. 26.40 g of soluble polyimide was obtained.

15 g of thus-synthesized polyimide was dissolved in 50 g of dioxolane to prepare a varnish of Sc (concentration of the solid content)=30%.

(Preparation of Photosensitive Dry Film Resist)

A photosensitive resin composition was prepared by mixing the following components (a) to (d) to prepare a photosensitive dry film resist in B-stage status on a PET film using (1) method. A three-layer structure sheet was prepared by laminating a protective film onto this photosensitive dry film resist with PET film.

(a) Phenylsiloxane

Products of Shin-Etsu Chemical Co., Ltd.

KF-56

25 parts by weight

KR211

5 parts by weight

(b) Compound having a carbon-carbon double bond

Bisphenol A EO modified (m+n≈0.30) diacrylate (NK Ester A-BPE-30 produced by Shin-Nakamura Chemicals Co., Ltd.)

10 parts by weight

Aronix M-215 produced by Toagosei Co., Ltd.

10 parts by weight

(c) Photoreaction initiator

3,3′,4,4′-tetra (t-butyl peroxycarbonyl)benzophenone

1 part by weight

4,4′-diethylaminobenzophenone

1 part by weight

(d) Polyimide resin synthesized by the above-mentioned method

50 parts by weight

As a result of a flame-retardant test of this photosensitive dry film resist, it passed the standard UL 94V-0 because the flames extinguished in 4 seconds on the average.

This photosensitive dry film resist was tested in developing properties. After development, a fine hole of 100 μm×100 μm square was formed, so that the test was considered passed. Its adhesive strength was 15 Pa·m.

### Example 18

(Synthesis of Modified Polyimide)

20.8 g (0.020 mole) of polyimide synthesized in Example 17 was dissolved in 80 g of dioxolane, 0.030 g of 4-methoxyphenol was added to be dissolved while heating at 60° C. with an oil bath. 3.75 g (0.0264 mole) of glycidyl methacrylate was added to this solution to be dissolved in 5 g of dioxolane, and then 0.01 g of triethylamine was added as a catalyst to be stirred by heating at 60° C. for 6 hours. A modified polyimide was synthesized in such a manner.

(Preparation of Photosensitive Dry Film Resist)

A photosensitive resin composition was prepared by mixing the following components to prepare a photosensitive dry film resist in B-stage status on a PET film using (1) method. A three-layer structure sheet was prepared by laminating a protective film onto this photosensitive dry film resist with PET film.

(a) Phenylsiloxane

Products of Shin-Etsu Chemical Co., Ltd.

KF-56

25 parts by weight

KR211

5 parts by weight

(b) Compound having a carbon-carbon double bond

Bisphenol A EO modified (m+n≈0.30) diacrylate (NK Ester A-BPE-30 produced by Shin-Nakamura Chemicals Co., Ltd.)

10 parts by weight

Aronix M-215 produced by Toagosei Co., Ltd.

10 parts by weight

(c) Photoreaction initiator

3,3′,4,4′-tetra (t-butyl peroxycarbonyl)benzophenone

1 part by weight

4,4′-diethylaminobenzophenone

1 part by weight

(d) Polyimide resin synthesized by the above-mentioned method

5.0 parts by weight

As a result of a flame-retardant test of this photosensitive dry film resist, it passed the standard UL 94V-0 because the flames extinguished in four seconds on the average.

This photosensitive dry film resist was tested in developing properties. After development, fine hole of 100 μm×100 μm square was formed, so that the test was considered passed. Its adhesive strength was 30 Pa·m.

### Comparative Example 11

A photosensitive resin composition was prepared by mixing the following components to prepare a photosensitive dry film resist in B-stage status on a PET film using (1) method.

(b) Compound having a carbon-carbon double bond

Bisphenol A EO modified (m+n≈0.30) diacrylate (NK Ester A-BPE-30 produced by Shin-Nakamura Chemicals Co., Ltd.)

10 parts by weight

Bisphenol A EO modified (m+n≈0.4) diacrylate (Aronix M-211B produced by Toagosei Co., Ltd.)

40 parts by weight

(c) Photoreaction initiator

4,4′-bis (diethylamino)benzophenone

1 part by weight

3,3′, 4,4′-tetra (t-butyl peroxycarbonyl)benzophenone

1 part by weight

(d) Polyimide resin synthesized in Example 17

50 parts by weight

As a result of a flame-retardant test of this photosensitive dry film resist, the test specimens did not pass the standard UL 94V-0 because the test specimens burned up to their upper parts with flame.

This photosensitive dry film resist was tested in its developing properties. After development, a fine hole of 100 μm×100 μm square was formed, so that the test was considered passed. Its adhesive strength was 15 Pa·m.

### Comparative Example 12

A photosensitive resin composition was prepared by mixing the following components to prepare a photosensitive dry film resist in B-stage status on a PET film using (1) method.

(b) Compound having a carbon-carbon double bond

Bisphenol A EO modified (m+n≈0.30) diacrylate (NK Ester A-BPE-30 produced by Shin-Nakamura Chemicals Co., Ltd.)

5 parts by weight

Bisphenol A EO modified (m+n≈0.4) diacrylate (Aronix M-211B produced by Toagosei Co., Ltd.)

35 parts by weight

(c) Photoreaction initiator

4,4′-bis (diethylamino)benzophenone

1 part by weight

3,3′, 4,4′-tetra (t-butyl peroxycarbonyl)benzophenone

1 part by weight

(d) Polyimide resin synthesized in Example 18

60 parts by weight

As a result of a flame-retardant test of this photosensitive dry film resist, the test specimens did not pass the standard UL 94V-0 because the test specimens burned up to their upper parts with flame.

This photosensitive dry film resist was tested in its developing properties. A fine hole of 100 μm×100 μm square was not formed, but holes of 500 μm×500 μm square and 200 μm×200 μm square were formed, so that the test was considered passed.

Thus, a photosensitive cover lay film without containing any phenylsiloxane compound can be developed, but it does not satisfy the flame-retardant standards. Its adhesive strength was 5 Pa·m.

### Comparative Example 13

A photosensitive dry film resist “Piralux PC-1500” (with a thickness of 50 μm) produced by Du Pont Kabushiki Kaisha is used as a photosensitive dry film-type cover lay for a flexible printed circuit. The primary component of this film is an acrylic resin.

This “Piralux PC-1500 was laminated onto a polyimide film (AH Film produced by Kaneka Corporation, thickness: 25 μm) by heating at 100° C. at a pressure of 0.001 Pa in a vacuum laminater. Curing by heating was performed in an oven at 170° C. after exposed to light of 400 nm at the rate of 300 mJ/cm². As a result of a flame-retardant test of this photosensitive dry film resist, the test specimens did not pass the standard UL 94V-0 because the test specimens burned up to their upper parts with flame. This photosensitive dry film resist was tested in its developing properties in the same manner as in other examples except using a water solution of 1% calcium carbonate (at liquid temperature of 40° C.). After development, fine holes of 500 μm×500 μm square, 200 μm×200 μm square, and 100 μm×100 μm square were formed, so that the test was considered passed.

Accordingly, the photosensitive dry film resist having the primary component of an acrylic resin can be developed, but is inferior in incombustibility, so that it does not satisfy the standard UL 94V-0. Its adhesive strength was 30 pa·m.

### INDUSTRIAL APPLICABILITY

A photosensitive resin composition and a photosensitive dry film resist employing the resin composition of the present invention are particularly applicable to a printed circuit board used in the field of an electronic material or a suspension for hard disk unit and can be laminated directly on a flexible printed circuit board.

More particularly, the present invention can provide a photosensitive dry film resist having excellent properties such as heat resistance that can be developed using alkali.

In the photosensitive dry film resist, a soluble polyimide and a compound having a carbon-carbon double bond are particularly used as primary components, in which a photoreaction initiator and/or a sensitizer are used as essential ingredients. This enables to form fine patterns, so that the photosensitive dry film resist may be favorably used for a photosensitive cover lay film used as a film-like photoresist and a permanent photoresist for insulation protection film in a flexible printed circuit board and the head portion of a hard disk device for a personal computer because of its excellent electrical insulation, heat resistance, and mechanical characteristics.

An acrylate compound with a repeated unit (where R¹ is hydrogen or a methyl group, or ethyl group) expressing —(CHR¹—CH₂—O—)— is particularly favorable as a compound having a carbon-carbon double bond.

Since the dry film resist employing the photosensitive resin composition of the present invention is easy to handle due to a dry film, a dry process required for preparing a photosensitive cover lay in the manufacturing process of a flexible printed circuit board is not needed. That is, desired patterns are exposed to light after a photosensitive cover lay film is laminated onto a substrate where a circuit has been formed to form a cured film by curing the exposed part. And then desired patterns are formed by removing the unexposed part by development and heating at a temperature in which the cured film is not decomposed and an organic solvent can be evaporated. A comparatively low laminating temperature enables to form a cover lay film having superior heat resistance and mechanical characteristics without damages on the substrate.

The photosensitive dry film resist of the present invention is, therefore, suitable for a protective film for an electronic circuit such as a flexible printed board and the head part of a hard disk device for a personal computer.

As mentioned above, the photosensitive resin composition can be used for a dry film resist and may have incombustibility that satisfies the flame-retardant standard for plastic materials UL 94V-0. Particularly, the composition contains a soluble polyimide and an acrylic compound as primary components and a photoreaction initiator and/or a sensitizer as essential ingredients. In addition, the composition contains a phosphorous compound, a compound containing halogen, and a compound to add incombustibility of phenylsiloxane.

The photosensitive dry film resist according to the present invention has incombustibility to satisfy the flame-retardant standard for plastic materials UL 94V-0, even if the photosensitive dry film resist is in a laminated state onto a polyimide film and the resist is a single layer.

Accordingly, the photosensitive dry film resist may be favorably used for a flexible printed circuit board and a photosensitive cover lay film used for the head portion of a hard disk device for a personal computer as a film-like photoresist and an insulation protective film permanent photoresist.

There have thus been shown and described a novel photosensitive resin composition, a novel photosensitive dry film resin and a novel photosensitive cover lay film produced from the same, which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A photosensitive resin composition comprising, as essential components:
a soluble polyimide;
a compound having a carbon-carbon double bond; and
a photoreaction initiator and/or a sensitizer.

2. A photosensitive resin composition comprising, as essential components:
a soluble polyimide;
a compound having a carbon-carbon double bond;
a photoreaction initiator and/or a sensitizer; and
a phosphorus compound.

3. A photosensitive resin composition comprising, as essential components:
a soluble polyimide;
a compound having a carbon-carbon double bond;
a photoreaction initiator and/or a sensitizer; and
a halogen-containing compound.

4. A photosensitive resin composition comprising, as essential components;
a soluble polyimide;
a compound having a carbon-carbon double bond;
a photoreaction initiator and/or a sensitizer; and
phenylsiloxane having a structural unit represented by:
R²²SiO_{3/2} and/or R²³SiO_{2/2}
wherein R²² and R²³ are selected from a phenyl group, an alkyl group having a carbon number of 1 to 4, and an alkoxy group.

5. The photosensitive resin composition according to any one of claims 1 to 4, wherein said soluble polyimide has 1 wt % or more of a structural unit represented by the general formula (1): 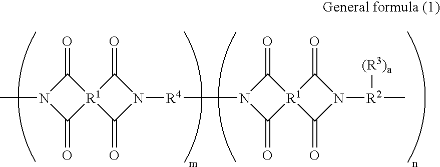
wherein R¹ is a tetravalent organic group, R² is (a+2) valence organic group, R³ is a monovalent organic group, R⁴ is a divalent organic group, a is an integer of 1 to 4, m is an integer of 0 or more, and n is an integer of 1 or more.

6. The photosensitive resin composition according to claim 5, wherein said soluble polyimide is an epoxy-modified polyimide that is modified by a compound having an epoxy group.

7. The photosensitive resin composition according to claim 5, wherein R¹ in the general formula (1) representing said soluble polyimide is one or more kinds of tetravalent organic groups having 1 to 3 aromatic rings or one or more kinds of alicyclic tetravalent organic groups.

8. The photosensitive resin composition according to claim 7, wherein at least 10 mol % or more of acid dianhydride residue represented by R¹ in the general formula (1) is selected from the general formula (2): 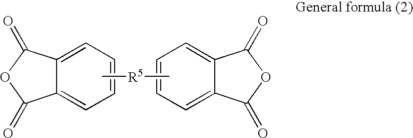
wherein R⁵ represents a single bond, —O—, —CH₂—, C₆H₄—, —C(═O)—, —C(CH₃)₂—, —C(CF₃)₂—, —O—R⁶—O—, and —(C—O)—O—R⁶—O(C═O)—.

9. The photosensitive resin composition according to claim 8, wherein at least 10 mol % or more of acid dianhydride residue represented by R¹ in the general formula (1) is selected from the Group (I): 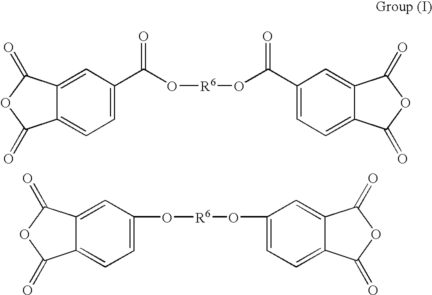
wherein R⁶ represents a divalent organic group selected from the Group (II): 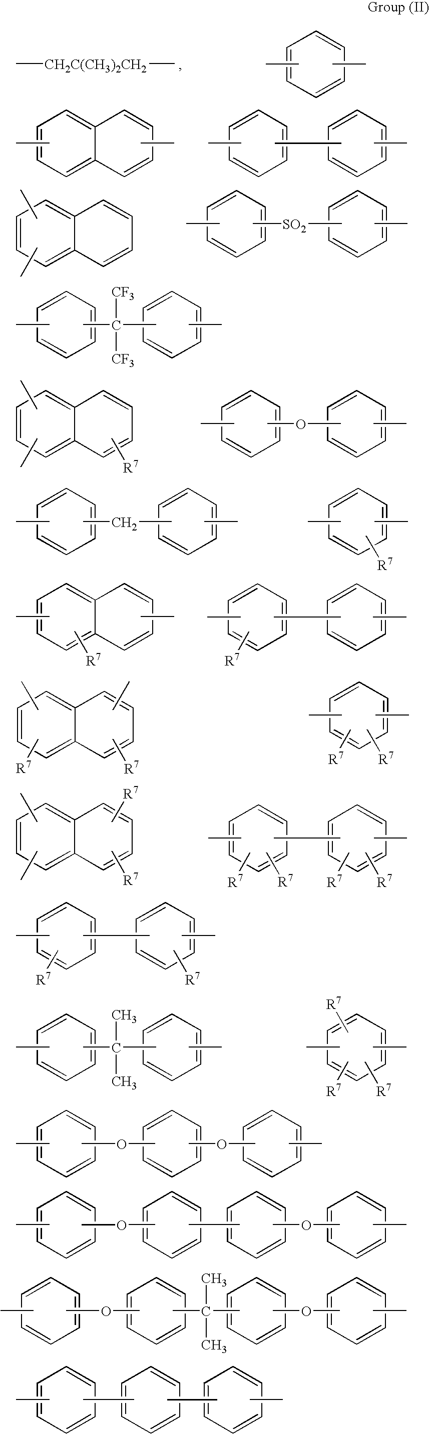 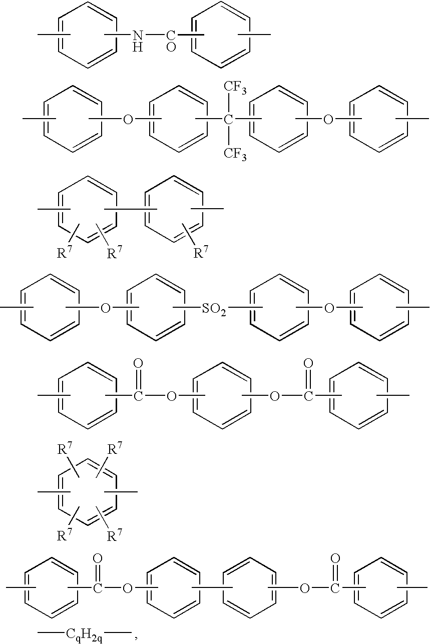
(wherein q is an integer of 1 to 20) and R⁷ represents hydrogen, halogen, methoxy, or C1 to C16 alkyl group, and p represents an integer of 1 to 20.

10. The photosensitive resin composition according to claim 5, wherein R² in the general formula (1) comprises a diamine residue selected from the Group (III): 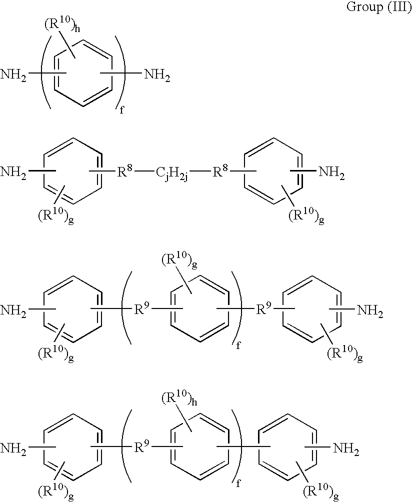
wherein R⁸s may be the same or different and represent a single bond, —O—, —C(˜0)O—, —O(O═)C—, —SO₂—, —C(═O)—, —S—, or —C(CH₃)₂—, R⁹s may be the same or different and represent a single bond, —CO—, —O—, —S—, —(CH₂)ᵣ— (wherein r is an integer of 1 to 20), —NHCO—, —C(CH₃)₂—, —C(CF₃)₂—, _COO—, —SO₂—, or —O—CH₂—C(CH₃)₂—CH₂—O—, R¹⁰s may be the same or different and represent hydrogen, hydroxy group, carboxy group, halogen, methoxy group, or C1 to C5 alkyl group, f is an integer of 0, 1, 2, 3, and 4, g is an integer of 0, 1, 2, 3, and 4, and j is an integer of 1 to 20.

11. The photosensitive resin composition according to claim 10, wherein said soluble polyimide is obtained using 5 to 96 mol % of diamine represented by the Group (III) in all the diamine components.

12. The photosensitive resin composition according to claim 5, wherein R⁴ in the general formula (1) contains a siloxane diamine residue represented by the general formula (3): 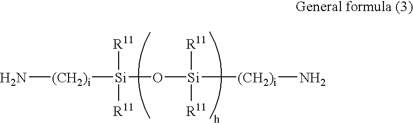
wherein R¹¹ represents a C1to C12 alkyl group or phenyl group, i represents an integer of 1 to 20, and h represents an integer of 1 to 40.

13. The photosensitive resin composition according to claim 12, wherein said soluble polyimide contains 5 to 70 mol % of siloxane diamine residue represented by the general formula (3) in all the diamine residues.

14. The photosensitive resin composition according to claim 10, wherein R³ in the general formula (1) contains a hydroxy group or a carboxy group.

15. The photosensitive resin composition according to claim 14, wherein R² in the general formula (1) is a diamine residue selected from the Group (IV): 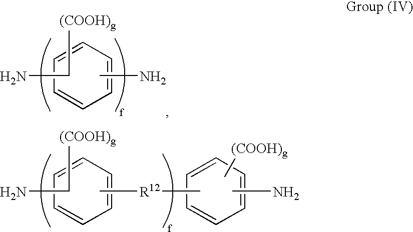
wherein f is an integer of 1 to 3, g is an integer of 1 to 4, and R¹² represents a divalent organic group selected from —O—, —S—, —CO—, —CH₂—, SO₂—, —C(CH₃)₂—, —C(CF₃)₂—, and —O—CH₂—C(CH₃)₂—CH₂—O—.

16. The photosensitive resin composition according to claim 15, wherein said soluble polyimide has a COOH equivalent weight of 300 to 3000.

17. The photosensitive resin composition according to claim 5, wherein R³ in the general formula (1) is an epoxy compound residue having two or more epoxy groups.

18. The photosensitive resin composition according to claim 17, wherein R³ in the general formula (1) is a residue of a compound having an epoxy group and a carbon-carbon double bond or a residue of a compound having an epoxy group and a carbon-carbon triple bond.

19. The photosensitive resin composition according to claim 6, wherein R³ in the general formula (1) has 1 wt % or more soluble polyimide having a structural unit containing an organic group selected from the group consisting of the Group (V): 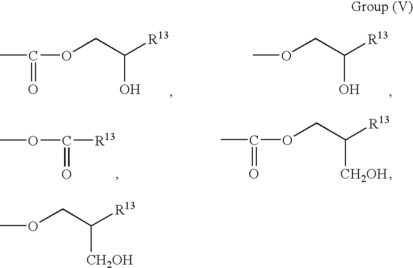
wherein R¹³ represents a monovalent organic group having at least one functional group selected from the group consisting of an epoxy group, carbon-carbon triple bond, or carbon-carbon double bond.

20. The photosensitive resin composition according to claim 19, wherein said soluble polyimide is an epoxy modified soluble polyimide having a COOH equivalent weight of 300 to 3000.

21. The photosensitive resin composition according to claim 5, wherein said compound having a carbon-carbon double bond is a compound having at least one aromatic ring and two or more carbon-carbon double bonds in one molecule.

22. The photosensitive resin composition according to claim 21, wherein said compound having a carbon-carbon double bond is an acrylic compound having at least one kind selected from the group consisting of an aromatic ring and heterocyclic ring in one molecule.

23. The photosensitive resin composition according to claim 22, wherein said compound having at least one aromatic group and two or more carbon-carbon double bonds in one molecule contains a compound having 6 or more and 40 or less of repeating units represented by:
—(CHR¹⁴—CH₂—O)—
wherein R¹⁴ represents hydrogen, methyl group, or ethyl group.

24. The photosensitive resin composition according to claim 23, wherein said compound having at least one aromatic ring and tow or more carbon-carbon double bonds in one molecule has at least one compound selected from the group consisting of the group (VI): 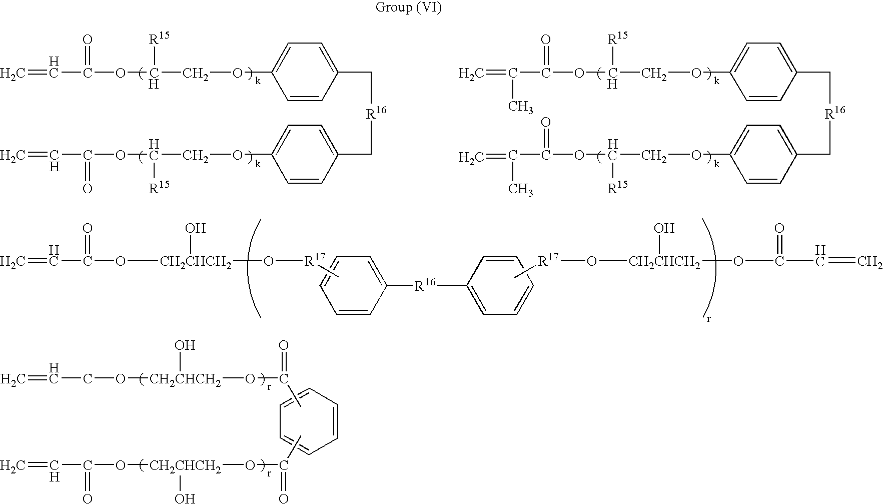
wherein R¹⁵ represents hydrogen, methyl group, or ethyl group, R¹⁶ represents a divalent organic group, R¹⁷ represents a single bond or a divalent organic group, k may be the same or different and represents an integer of 2 to 20, and r may be the same or different and represents an integer of 1 to 10.

25. The photosensitive resin composition according to claim 5, wherein said phosphorous compound is a compound having an alcohol content of 5.0 wt % or more.

26. The photosensitive resin composition according to claim 25, wherein said phosphorous compound is phosphate, condensed phosphate, phosphite, phosphine oxide, or phosphine.

27. The photosensitive resin composition according to claim 26, wherein said phosphorous compound is phosphate having two or more aromatic rings represented by the group (VII); 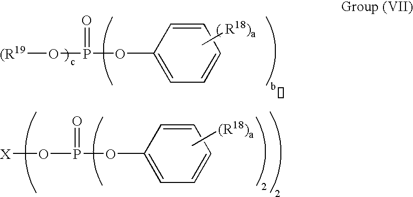
wherein R¹⁸ represents a methyl group, R¹⁹ represents an alkyl group, X represents a divalent organic group, a is an integer of 0 to 3, b plus c equals 3, and b is an integer of 2 or 3.

28. The photosensitive resin composition according to claim 5, wherein said compound containing halogen is a halogen-containing compound content of 15 wt % or more.

29. The photosensitive resin composition according to claim 28, wherein said halogen-containing compound is at least one kind selected from the group consisting of halogen-containing (meta)acrylic compound, halogen-containing phosphate, and halogen-containing condensed phosphate.

30. The photosensitive resin composition according to claim 29, wherein said halogen-containing compound is a (meta)acrylic compound represented by the group (VIII): 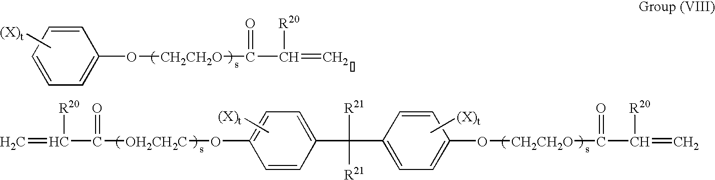
wherein X represents a halogen group, R²⁰ and R²¹ represent hydrogen or methyl group, s is an integer of 0 to 10, and t may be the same or different and represents an integer of 1 to 5.

31. The photosensitive resin composition according to claim 5, wherein said photoreactive initiator generates radical at g or i rays.

32. The photosensitive resin composition according to claim 5, which is developed in an alkaline solution after exposure.

33. The photosensitive resin composition according to claim 5, wherein said soluble polyimide, said compound having a carbon-carbon double bond, and said photoreactive initiator and/or sensitizer constitute 5 to 90 wt %, 5 to 90 wt %, and 0.001 to 10 wt % of the total amount of said soluble polyimide, said compound having a carbon-carbon double bond, and said photoreactive initiator and/or sensitizer, respectively.

34. The photosensitive resin composition according to claim 26, wherein said soluble polyimide, said phosphorous compound, said compound having a carbon-carbon double bond, and said photoreactive initiator and/or sensitizer constitute 5 to 90 wt %, 5 to 90 wt %, 5 to 90 wt %, and 0.001 to 10 wt % of the total amount of said soluble polyimide, said phosphorous compound, said compound having a carbon-carbon double bond, and said photoreactive initiator and/or sensitizer, respectively.

35. The photosensitive resin composition according to claim 29, wherein said soluble polyimide, said halogen-containing compound, said compound having a carbon-carbon double bond, and said photoreactive initiator and/or sensitizer constitute 5 to 90 wt %, 5 to 90 wt %, 5 to 90 wt %, and 0.001 to 10 wt % of the total amount of said soluble polyimide, said compound containing halogen, said compound having a carbon-carbon double bond, and said photoreactive initiator and/or sensitizer, respectively.

36. The photosensitive resin composition according to claim 35, further comprising 0.1 to 10 wt % of antimony trioxide and/or antimony pentoxide.

37. The photosensitive resin composition according to claim 4, wherein said soluble polyimide, said compound having a carbon-carbon double bond, said photoreactive initiator and/or sensitizer, and said compound containing phenyl siloxane constitute 5 to 90 wt %, 5 to 90 wt %, 0.001 to 10 wt %, and 5 to 90 wt % of the total amount of said soluble polyimide, said compound having a carbon-carbon double bond, said photoreactive initiator and/or sensitizer, and said compound containing phenyl siloxane, respectively.

38. A photosensitive dry film resist obtained from the photosensitive resin composition according to claim 5.

39. The photosensitive dry film resist according to claim 38, wherein said photosensitive dry film resist is pressed at a temperature of 20 to 150° C. under B stage.

40. The photosensitive dry film resist according to claim 38, wherein a thermal decomposition staring temperature after curing is 300° C. or more.

41. The photosensitive dry film resist according to claim 38, wherein an adhesive strength of a photosensitive resin composition contained in the photosensitive dry film resist to copper is 5 Pa·m at 20° C. or more.

42. The photosensitive dry film resist according to claim 41, wherein a cure temperature is 200° C. or less.

43. A photosensitive dry film resist comprising a laminate composed of the photosensitive resin composition and polyimide film, wherein said photosensitive dry film resist meets the standard for tests for flammability of plastic materials known as UL94V-0.

44. A photosensitive dry film resist comprising the photosensitive resin composition according to claim 5, wherein said photosensitive dry film resist can be developed in an alkaline solution.

45. A photosensitive dry film resist comprising a two-layer sheet composed of the photosensitive dry film resist according to claim 38 and a base film.

46. A photosensitive dry film resist comprising a three-layer sheet composed of the photosensitive dry film resist consisting of the two-layer sheet according to claim 45 and a protective film.

47. A photosensitive coverlay film for a flexible printed wiring board, comprising the photosensitive dry film resist according to claim 45.

48. The photosensitive dry film resist according to claim 45, wherein said photosensitive dry film resist is used as a photosensitive coverlay film for a flexible printed wiring board.

49. A photosensitive coverlay film for a head of a hard disk of a personal computer, comprising the photosensitive dry film resist according to claim 45.

50. The photosensitive dry film resist according to claim 45, wherein said photosensitive dry film resist is used as a photosensitive coverlay film for a head of a hard disk of a personal computer.

51. A printed wiring board on which the photosensitive dry film resist according to claim 45 is laminated without using adhesive.
